(19) United States
(12) Patent Application Publication
(10) Pub. No.: US 2016/0370625 A1
(43) Pub. Date: Dec. 22, 2016

(54) HOLOGRAPHIC POLYMER DISPERSED LIQUID CRYSTALS

(71) Applicant: DREXEL UNIVERSITY, Philadelphia, PA (US)

(72) Inventors: Adam K. Fontecchio, Downingtown, PA (US); Kashma Rai, Malden, MA (US)

(21) Appl. No.: 15/254,471

(22) Filed: Sep. 1, 2016

Related U.S. Application Data
(63) Continuation-in-part of application No. 13/828,520, filed on Mar. 14, 2013, now abandoned.
Application No. 13/828,520 is a continuation-in-part of application No. 12/721,161, filed on Mar. 10, 2010.
Application No. 13/828,520 is a continuation-in-part of application No. PCT/US2011/051903, filed on Sep. 16, 2011.
Application No. 13/828,520 is a continuation-in-part of application No. PCT/US2011/058483, filed on Oct. 29, 2011.
(60) Provisional application No. 61/158,905, filed on Mar. 10, 2009.
(60) Provisional application No. 61/383,951, filed on Sep. 17, 2010.
(60) Provisional application No. 61/387,156, filed on Sep. 28, 2010.
(60) Provisional application No. 61/408,184, filed on Oct. 29, 2010.
(60) Provisional application No. 61/719,565, filed on Oct. 29, 2012.

(51) Int. Cl. G02F 1/1334; G03H 1/02; G03H 1/04; G02F 1/137

(52) U.S. Cl. CPC G02F 1/13342; G02F 1/137; G03H 1/024; G03H 1/0465; G02F 2203/01; G02F 2203/02

(57) ABSTRACT

A hyperspectral holographic polymer dispersed liquid crystal (HPDLC) medium comprising broadband reflective properties may comprise dopants that result in a hyperspectral HPDLC with fast transitional switching speeds. Dopants may include alliform carbon particles, carbon nanoparticles, piezoelectric nanoparticles, multiwalled carbon nanotubes, a high dielectric anisotropy compound, semiconductor nanoparticles, electrically conductive nanoparticles, metallic nanoparticles, or the like. A technique for fabrication of hyperspectral broadband HPDLC mediums may involve dynamic variation of the holography setup during HPDLC formation and spatial multiplexing that may enable broadening of the HPDLC medium's wavelength response. Fabrication may include concurrently running multiple exposures and exploiting superpositioning of the resultant gratings. The hyperspectral HPDLC may be capable of blocking and/or filtering wavelengths in the range of approximately 390 nm to approximately 12 μm.

### CROSS-REFERENCE TO RELATED APPLICATIONS

This application is a continuation of U.S. patent application Ser. No. 13/828,520, filed Mar. 14, 2013, which is a continuation-in-part of, and claims priority to, U.S. patent application Ser. No. 12/721,161, filed Mar. 10, 2010, which itself claims the benefit of priority to U.S. Provisional Patent Application Ser. No. 61/158,905, filed Mar. 10, 2009. U.S. patent application Ser. No. 13/828,520 is also a continuation-in-part of, and claims priority to, Patent Cooperation Treaty patent application number PCT/US2011/051903, filed Sep. 16, 2011, which itself claims the benefit of priority to U.S. Provisional Patent Application Ser. No. 61/383,951 filed Sep. 17, 2010 and U.S. Provisional Patent Application Ser. No. 61/387,156, filed Sep. 28, 2010. U.S. patent application Ser. No. 13/828,520 is also a continuation-in-part of, and claims priority to, Patent Cooperation Treaty Patent Application No. PCT/US2011/058483, filed Oct. 29, 2011, which claims the benefit of priority to U.S. Provisional Patent Application Ser. No. 61/408,184, filed Oct. 29, 2010. U.S. patent application Ser. No. 13/828,520 also claims priority to U.S. provisional patent application No. 61/719,565, filed Oct. 29, 2012. Each of these references is incorporated in its entirety for all purposes.

### GOVERNMENT RIGHTS

This invention was made in part with government support under Grant No. NNG04G042G awarded by the National Aeronautics and Space Administration (NASA), Grant No. DE-FG02-08ER86355 awarded by the Department of Energy (DOE), and grant number DEAC05-000R22725 awarded by the U.S. Department of Energy, Fluid Interface Reactions, Structures and Transport (FIRST) Center. The government has certain rights in the invention.

### TECHNICAL FIELD

The technical field generally relates to holographic polymer dispersed liquid crystals (HPDLCs). More specifically, the technical field relates to techniques for fabricating a HPDLC medium, development of infrared wavelength capabilities of a HPDLC medium, carbon nanostructure doping of a HPDLC medium, and HPDLC mediums having fast switching speeds.

### BACKGROUND

To fabricate holographic polymer dispersed liquid crystal (HPDLC) mediums, multiple HPDLC mediums, each reflecting a specific wavelength, may be bonded together in a stacked configuration. However, each subsequent HPDLC layer increases the attenuation of light as it passes through stacked HPDLC mediums. The increased attenuation characteristics of stacked HPDLC mediums, combined with the narrow peak reflections of each HPDLC layer, make the manufacture of stacked HPDLC mediums capable of reflecting a broad spectrum of wavelengths difficult and impractical.

Another fabrication technique may involve the generation of multiple HPDLC Bragg gratings in a single layer through the use of simultaneous, coherent multiple laser beam exposure. At least two pairs of laser beams may be used, with each beam incident on the mixture at a different angle, in order to form an optical interference pattern associated with reflection of a different wavelength of light. This technique may result in a HPDLC medium lacking a uniform reflective behavior across a broad range of wavelengths. Additionally, increasing the number of Bragg gratings in a single layer may increase the complexity of the hologram fabrication setup and may require additional lasers to maintain a reasonable range of beam irradiance.

Known devices using holographic polymer dispersed liquid crystal (HPDLC) mediums lack the switching speed required to effectively acquire and spectrally multiplex hyperspectral imaging data.

### SUMMARY

Described herein is a holographic polymer dispersed liquid crystal (HPDLC) medium with broadband reflective properties and a techniques for fabrication of broadband HPDLC mediums including spin coating overlapping reflection gratings. Further described are mechanisms for developing a HPDLC medium capable of processing long infrared wavelengths (e.g., 8 to 12 micron wavelengths). Also described are mechanisms for increasing switching speed of a HPDLC medium by utilizing dopants including alliform carbon particles.

In an example embodiment, a holographic polymer dispersed liquid crystal (HPDLC) medium with broadband reflective properties, and a technique for fabrication of broadband HPDLC mediums may include dynamic variation of a holography setup during HPDLC formation, enabling the broadening of the HPDLC medium's wavelength response. Dynamic variation of the holography setup may include the rotation and/or translation of one or more motorized stages, allowing for time and spatial, or angular, multiplexing through variation of the incident angles of one or more laser beams on a pre-polymer mixture during manufacture. An HPDLC medium manufactured using these techniques may exhibit improved optical response by reflecting a broadband spectrum of wavelengths. A new broadband holographic polymer dispersed liquid crystal thin film polymeric mirror stack with electrically switchable beam steering capability is disclosed. In an example embodiment, fabrication of the HPDLC mediums may comprise concurrent multiple holographic exposures and exploiting the superposition of the overlapping reflection gratings.

In an example embodiment, a method may include applying a layer of a conductive material to a surface of a substrate. The method may further include dispersing the conductive material along the surface of the substrate by applying a first rotational force to the substrate. The method further may include applying a mixture comprising a liquid crystal and a polymer to the dispersed first layer of conductive material. The method further may include dispersing the mixture along the first layer of conductive material by applying a second rotational force to the substrate. The method further may include exposing the mixture to an interference pattern that causes the formation of at least one grating structure within the mixture.

In an example embodiment, a hyperspectral imaging system may include a hyperspectral imager having a holographic polymer dispersed liquid crystal tunable filter. The hyperspectral imager may be configured to spectrally multiplex hyperspectral imaging data acquired by the hyperspectral imager. The hyperspectral imaging system further may include a platform configured to carry the hyperspectral imager. The platform may be configured to facilitate airborne collection of the hyperspectral imaging data.

In an example embodiment, a switchable optical shielding system may include a visor integrated with a holographic polymer dispersed liquid crystal tunable filter. The holographic polymer dispersed liquid crystal tunable filter may be capable of switching between respective transparent and reflective states in no more than 20 microseconds.

In an example embodiment, a switchable optical shielding system may include a canopy mounted to an aircraft. At least a portion of the canopy may be integrated with a holographic polymer dispersed liquid crystal tunable filter. The holographic polymer dispersed liquid crystal tunable filter may be capable of switching between respective transparent and reflective states in no more than 20 microseconds.

In an example embodiment, HPDLC medium may be fabricated to possess the capability to selectively block and/or selectively allow transmission of long wavelength infrared energy, such as, for example, wavelengths in the range of 8 to 12 microns.

In an example embodiment, high speed switching of optical states of holographic polymer dispersed liquid crystals (HPDLCs) may be achieved by using dielectric dopants. Example dielectric dopants may include carbon nanoparticles, alliform carbon particle, carbon onions, piezoelectric nanoparticles, multiwalled carbon nanotubes, a high dielectric anisotropy compound, semiconductor nanoparticles, electrically conductive nanoparticles, metallic nanoparticles, or the like, or any appropriate combination thereof. Improved switching speeds on the order of 10 to 100 times faster than currently known switching speeds may be obtainable. Applications of the herein described high speed HPDLCs may include laser switching for light detection and ranging (LIDAR), active band blocking filters, active bandpass filters, or the like, or any appropriate combination thereof.

### BRIEF DESCRIPTION OF THE DRAWINGS

In the drawings, like reference numerals designate corresponding parts throughout the several views.

FIG. 1 and FIG. 2 illustrate an example holographic polymer dispersed liquid crystal (HPDLC) thin film (not to scale) containing phase separated compositions formed under holographic conditions.

FIG. 3 depicts an example holography apparatus used in the formation of hyperspectral broadband HPDLC mediums as disclosed herein.

FIG. 4 which includes FIG. 4A and FIG. 4B depict an example technique for dynamically varying a holography apparatus during formation to broaden the interaction wavelength of an HPDLC medium via simultaneous time and spatial, or angular, multiplexing.

FIG. 5, which includes FIG. 5A and FIG. 5B, illustrates an example of broadened peak reflective characteristics achievable in an HPDLC medium through the creation of multiple reflections gratings using the techniques disclosed herein, in comparison to peak reflective characteristics of a typical single grating HPDLC medium.

FIG. 6, which includes FIG. 6A and FIG. 6B, depicts SEM micrograph images of a single wavelength reflecting and broadband wavelength reflecting HPDLC mediums respectively.

FIG. 7, which includes FIG. 7A and FIG. 7B, depicts an example of theoretical modeling of a broadband HPDLC medium using Berreman's 4×4 matrix technique.

FIG. 8 depicts an example method and system for creating spherically expanded laser beams.

FIG. 9 depicts another example method and system for creating spherically expanded laser beams.

FIG. 10 depicts an example apparatus 800 comprising an electrically-switched thin-film polymeric stack.

FIG. 11 depicts an example fabrication setup for fabricating three arrayed reflection volume holograms.

FIG. 12 depicts an example spectrometer detection system and process.

FIG. 13 depict another example spectrometer detection system and process.

FIG. 14 illustrates example response curves for the three individual HPDLCs, fabricated by the herein described fabrication technique.

FIG. 15, which includes FIG. 15A, FIG. 15B, FIG. 15C, and FIG. 15D, illustrates example results as shown on an oscilloscope for two different incident wavelengths.

FIG. 16 depicts an example HPDLC tunable filter system.

FIG. 17, which depicts an example HPDLC tunable filter in conjunction with a grating spectrometer.

FIG. 18 depicts another example HPDLC tunable filter in conjunction with a photo detector and control electronics.

FIG. 19 illustrates an example holographic formation of a diffraction grating.

FIG. 20 illustrates an example fabrication by spin coating. Another example embodiment comprises fabricating HPDLCs by spin coating.

FIG. 21, which includes FIG. 21A and FIG. 21B, depicts example spectral characteristics of an example HPDLC tunable filter.

FIG. 22 depicts an example HPDLC tunable filter stack in an unswitched, reflective state.

FIG. 23 depicts the example HPDLC tunable filter stack illustrated in FIG. 22 in a switched, transparent state.

FIG. 24 depicts an example system and process for generating HPDLC films.

FIG. 25 depicts an example HPDLC tunable filter stack.

FIG. 26 illustrates an example flow diagram for fabricating an HPDLC element stack.

FIG. 27 illustrates an example spin coating apparatus that can be utilized to fabricate an HPDLC element stack.

FIG. 28 depicts fabricating an HPDLC tunable filter stack using a Langmuir trough.

FIG. 29 depicts an alternative example of fabricating an HPDLC tunable filter stack using a Langmuir trough.

FIG. 30 depicts example techniques for enhancing the viewing angle of HPDLC elements during fabrication.

FIG. 31 illustrates and example system and process for measuring HPDLC filter response time.

FIG. 32 illustrates an example system and method for obtaining filter wavelength range and resolution.

FIG. 33 is a block diagram of an example optical filter system into which an HPDLC tunable filter stack can be incorporated.

FIG. 34 is an example diagram of a TMS320F2812 microController.

FIG. 35 is an diagram of an example system comprising a TMS320F2812 microController.

FIG. 36 is a table depicting performance characteristics of an example HPDLC tunable filter stack.

FIG. 37 depicts a breadboard system that can be used to evaluate the HPDLC tunable filter stack.

FIG. 38 is a table containing parameters and metrics associated with a plurality of example acrylate based HPDLC filter elements.

FIG. 39 illustrates a graph depicting a resulting filter response time of about 20 microseconds for an example of the plurality of acrylate based HPDLC filter elements.

FIG. 40 illustrates a graph depicting resulting dynamic reflection efficiency.

FIG. 41 is a table containing parameters and metrics of an example acrylate based HPDLC tunable filter stack.

FIG. 42 illustrates a graph depicting the filter reflection efficiency of the example acrylate based HPDLC tunable filter stack as a function of switching voltage.

FIG. 43 illustrates a graph depicting the transmission curves for the example acrylate based HPDLC tunable filter stack in unbiased and biased states.

FIG. 44 is a table containing parameters and metrics associated with an example thiolene based HPDLC tunable filter stack.

FIG. 45 illustrates a graph depicting a comparison of reflection efficiency as a function of switching voltage for an example thiolene based HPDLC tunable filter stack.

FIG. 46 is a table containing parameters and metrics associated with an example thiolene based HPDLC tunable filter stack comprising HPDLC filter elements having filter lengths of 20 microns;

FIG. 47 illustrates a graph depicting the response of an example HPDLC tunable filter stack as a function of switching voltage;

FIG. 48 is a table illustrating the performance of an example thiolene based HPDLC tunable filter stack operating in the near-IR portion of the spectrum;

FIG. 49 illustrates a graph depicting the response of the thiolene based HPDLC filter stack as a function of switching voltage;

FIG. 50 depicts demodulated signals for an example HPDLC tunable filter stack comprising ten filters when the HPDLC tunable filter stack is subjected to a monochromatic light source;

FIG. 51 depicts demodulated signals for an example HPDLC tunable filter stack comprising ten filters when the HPDLC tunable filter stack is subjected to a He:Ne gas laser;

FIG. 52 depicts example techniques that can be used to assemble the HPDLC elements of an example HPDLC tunable filter stack;

FIG. 53 illustrates an example apparatus that can be used to fabricate an HPDLC tunable filter stack in accordance with one of the techniques illustrated in FIG. 33;

FIG. 54 is a table containing parameters and metrics associated with individual example thiolene based HPDLC filter elements in the 600-700 nm wavelength range;

FIG. 55 is a table containing parameters and metrics associated with individual example thiolene based HPDLC filter elements in the 700-800 nm wavelength range;

FIG. 56A depicts plots a-f which illustrate respective transmission spectra of example thiolene based HPDLC filter elements from the table illustrated in FIG. 35;

FIG. 56B depicts plots g-j which illustrate respective transmission spectra of example thiolene based HPDLC filter elements from the table illustrated in FIG. 35;

FIG. 57A depicts plots a-f which illustrate respective transmission spectra of example thiolene based HPDLC filter elements from the table illustrated in FIG. 36;

FIG. 57B depicts plots g-j which illustrate respective transmission spectra of example thiolene based HPDLC filter elements from the table illustrated in FIG. 36;

FIG. 58 depicts plots a-b which illustrate the spectra, both switched and unswitched of a pair of thiolene based HPDLC tunable filter stacks in the 600-700 nm range and 700-800 nm range, respectively;

FIG. 59 depicts illustrations a, b, and c. Illustration a shows an apparatus, including a diffusing film, that can be used to fabricate a diffused HPDLC filter element. Illustration b and illustration c depict respective morphologies of example non-diffuse and diffuse HPDLC filter elements, respectively;

FIG. 60 depicts plot a and plot b. Plot a illustrates a graph depicting performance characteristics of an example HPDLC filter element with a viewing angle expanded by 10° using a 5° diffusing film. Plot b illustrates a graph depicting performance characteristics of an example HPDLC filter element with a 20° viewing angle;

FIG. 61 illustrates demodulated signals for ten HPDLC element filters when subjected to a monochromatic light source;

FIG. 62 illustrates an hyperspectral imaging system using an example HPDLC tunable filter stack in conjunction with a McBeth color chart and short pass and long pass filters;

FIG. 63 illustrates a graph depicting composite transmission spectra of an example HPDLC tunable filter stack comprising five HPDLC filter elements, in conjunction with short and long pass filters;

FIG. 64 depicts plots a-f which illustrate images of the McBeth color chart acquired at different wavelengths;

FIG. 65 illustrates a hyperspectral cube formed from hyperspectral imaging data acquired through an example HPDLC tunable filter stack via sequential switching;

FIG. 66 depicts reflectance extracted from the hyperspectral cube for three different colors pink, red and yellow at varying wavelengths;

FIG. 67 depicts a hyperspectral imaging system that includes a hyper spectral imager comprising an HPDLC tunable filter stack, the hyper spectral imager mounted to a moving platform;

FIG. 68 depicts a switchable optical shielding system comprising an aviator helmet and a visor that utilizes at least one HPDLC tunable filter stack, in accordance with an embodiment; and

FIG. 69 depicts a switchable optical shielding system comprising an aircraft canopy that utilizes at least one HPDLC tunable filter stack, in accordance with another embodiment.

FIG. 70 is a graph of example estimated rise and fall times of a HPDLC at different applied voltages and for various droplet sizes.

FIG. 71 illustrates an example transmission spectra of HPDLC reflection gratings with various concentrations of MWNT.

FIG. 72 illustrates plots depicting example changes in capacitance and resistivity of the HPDLC reflection gratings with MWNT at a driving frequency of 1 kHz.

FIG. 73 is a schematic depicting an example applied electric field across an isolated LC droplet in a polymer matrix.

FIG. 74 is a schematic depicting an example applied electric field across an isolated LC droplet in a polymer matrix in the presence of MWNT enhancing the local electric field across the LC droplet.

FIG. 75 illustrates example transmission as a function of applied voltage plots for various concentrations of MWNT.

FIG. 76 illustrates example rise and fall time measurements of HPDLC reflection gratings with various concentrations of MWNT.

FIG. 77 is a chart depicting various example characteristics of a Holographic Optical Element (HOE) comprising a high switching speed HPDLC as described herein.

### DETAILED DESCRIPTION

Holographically-formed polymer dispersed liquid crystals (HPDLCs) may comprise stratified layers of liquid crystal droplets contained in a polymer binder. They may be formed holographically, and therefore may be capable of forming a wavelength-specific reflective Bragg grating. The reflection from this grating may be electrically controlled by applying an electric field across the film and thereby rotating the liquid crystal droplets to essentially ‘wipe out’ the grating structure, causing the film to become transparent. The process may be fully reversible. Thus, the HPDLC may revert to its reflecting state once the electric field is removed. The speed at which the HPDLC can switch between states is referred to herein as the switching speed.

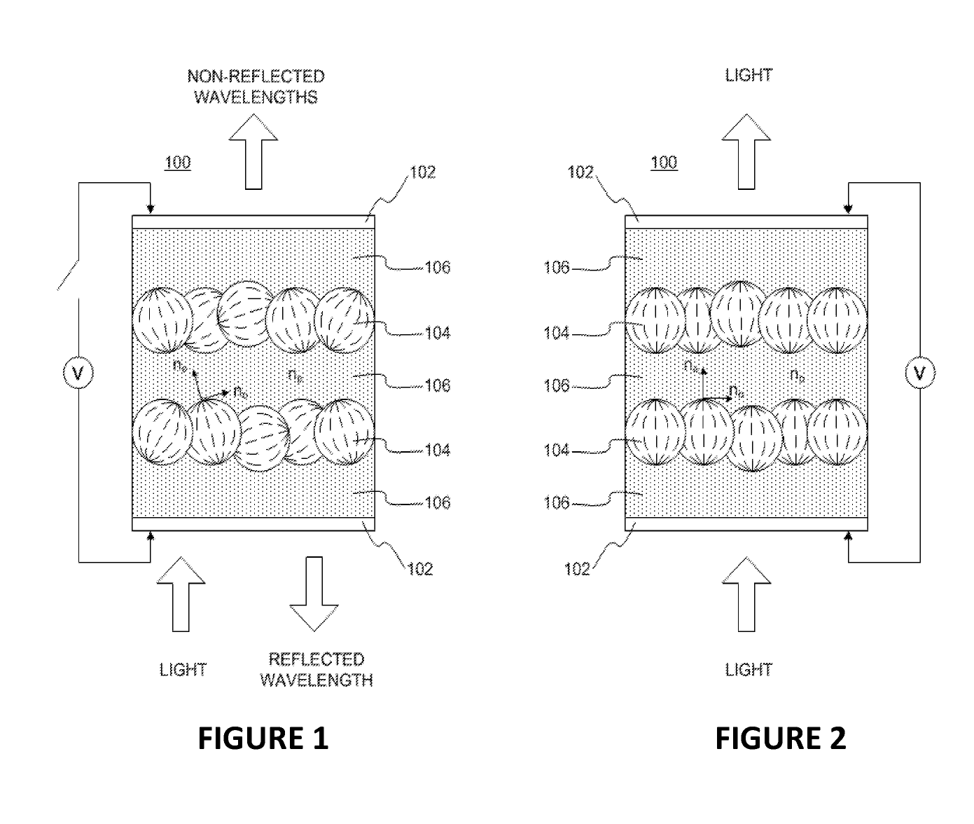

FIG. 1 and FIG. 2 illustrate an example holographic polymer dispersed liquid crystal (HPDLC) thin film 100 (not to scale) containing phase separated compositions formed under holographic conditions. The film may comprise a pre-polymer mixture made up of low molecular weight liquid crystals and a photo-curable monomer. An initiator(s) may be added to sensitize the pre-polymer mixture to a particular wavelength of laser light that will be used during the formation process. A layer of the pre-polymer mixture may be placed between AR-ITO coated glass substrates 102 spaced, for example, 5 μm apart.

In an example formation process the pre-polymer mixture may be irradiated with one or more holographic interference patterns generated by one or more laser light beams. The holographic interference patterns produce high-light-intensity, or bright, regions and dark regions in the pre-polymer mixture. Irradiation of the pre-polymer mixture initiates polymerization of the monomer, which in turn induces a phase separation between the polymer and liquid crystals. The rate of polymerization may be approximately proportional to the square root of the light intensity for one-photon polymerization. Therefore, the rate of polymerization may be spatially dependent. During irradiation the monomer diffuses to the bright regions where it polymerizes. The liquid crystal remains in the dark regions and phase separates into small droplets in ordered, stratified layers. Polymer gelation locks the modulated structure indefinitely, resulting in liquid crystal droplet-rich areas where the dark fringes were, and essentially pure polymer regions where the light fringes were. As a result, a periodic array of liquid crystal droplets 104 and matrix polymer planes 106 may be produced, as shown in FIG. 1 and FIG. 2. The index modulation between the liquid crystal and polymer planes may be estimated from the index of refraction of the individual components. It should be noted that FIG. 1 and FIG. 2 are not to scale, that the number of layers of liquid crystal droplets and polymer depicted therein are merely examples, and that the scope of the instant disclosure should not be limited thereto. The reflection gratings formed may be post-cured with a UV blanket for an interval, for example 10 minutes, to react to any unreacted monomers in the HPDLC medium.

The repeating layers of polymer and liquid crystals may comprise Bragg gratings. A Bragg grating typically reflects a narrow peak wavelength of light. The grating pitch, which is the width of one adjacent polymer and liquid crystal layer, may be determined by the following equation

$$Λ = \frac{λ}{2 n Sin θ} ,$$

where λ is the wavelength of the incident laser light, n is the effective refractive index of the polymer and liquid crystal composite, and θ is the angle with respect to the grating at which each of the laser beams is made incident on the pre-polymer mixture. The reflected Bragg peak wavelength, which can also be determined from the above equation, is directly proportional to the grating pitch. Accordingly, to create broadband reflecting gratings, the angle of incidence of the counter propagating beams may be taken into consideration in deciding the reflected wavelength of the HPDLC.

An electric field may be applied across a HPDLC medium to control the intensity of the wavelength of light reflected from the HPDLC. An electric field may transform the HPDLC from a wavelength selective device to an optically transparent state, as depicted in FIG. 2. Thus, if no field is applied, as depicted in FIG. 1, the HPDLC will reflect light at specific wavelengths corresponding to the Bragg grating(s) present in the HPDLC. When an electric field is applied, the liquid crystals in the HPDLC may align with the direction of the field, making the HPDLC effectively transparent and allowing light to travel through the HPDLC medium. HPDLC mediums have a narrow peak reflection wavelength with a full width at half maximum (FWHM) varying typically from 5 to 20 nm and based on the thickness of the Bragg grating.

In an example embodiment, the liquid crystals may be made of dielectric nematic liquid crystals, which orient in the direction of an external electric field applied to the HPDLC. The refractive index of nematic liquid crystal along the optic axis is called the extraordinary refractive index, represented as nₑ, and the refractive index perpendicular to it is called the ordinary refractive index, represented as nₒ.

In an example HPDLC medium, in which the liquid crystal and polymer planes are oriented approximately parallel to the substrates, the operation of the Bragg gratings, serving as reflection gratings, may be governed by the Bragg condition

λ=2<n>d

for normal incidence. Here, d is the layer thickness and <n> is the average refractive index of the grating which can be approximated by

<n>≈φ_{P}n_{P}+φ_{LC}n_{LC}

where φ_{P} and φ_{LC} are the volume fraction of the polymer and liquid crystal, respectively, and the average index of the liquid crystal may be given by

$${n}_{LC} = \sqrt{\frac{2 {n}_{o}^{2} + {n}_{e}^{2}}{3}} .$$

A large refractive index modulation between the liquid crystal rich planes and the surrounding polymer planes may likely yield high diffraction/reflection efficiency and low residual scattering when no field is applied. If the ordinary refractive index of the liquid crystal, nₒ, matches the refractive index of the polymer, nₚ, the HPDLC medium may revert to a transparent state (with the material optically homogeneous) upon the application of an electric field, as depicted in FIG. 2.

Holographic polymer dispersed liquid crystals (HPDLCs) may be characterized as electro-optic thin film devices which, upon application of an electric field, may be switched between a diffracting and a transmissive state. The grating pitch may be determined by the interference pattern generated by the recording laser beams. Applying a higher voltage to an HPDLC may increase switching speed, but the HPDLC may suffer damage due to the higher voltage.

As described herein, switching speed may be increased without necessarily increasing applied voltages. A fabrication method which may reduce the switching voltage needed to be applied to an HPDLC and further may improve switching speed of an HPDLC may include doping the HPDLC with a material that may reduce the in liquid crystal droplet size. The reduced droplet size may result in a change in the dielectric properties of the HPDLC. The liquid crystal droplet size may be in a range of 300 nanometers to 5 micrometers. In an example configuration, applying voltage of less than or equal to 400 volts on the hyperspectral holographic polymer dispersed liquid crystal medium may exhibit a switching speed from a reflective state to a transparent state of about 15 microseconds and a switching speed from a transparent state to a reflective state of 100 nanoseconds.

As described herein, depending upon the material composition and the applied voltage, HPDLCs may exhibit faster on time (the time it takes the HPDLC film to switch optical characteristics of the no-filed applied state to the field applied state) on the order of nanoseconds, and may exhibit faster off time (the time it takes the HPDLC film to switch optical characteristics of the field-applied state to the no-field-applied state) on the order of nanoseconds. In an example embodiment, the on time may be controlled and made faster to reach nanosecond switching times by controlling the size of the LC droplets formed, applied voltage, and the dielectric anisotropy of the liquid crystal (LC) and/or liquid crystal droplets. This also may lead to microsecond off times.

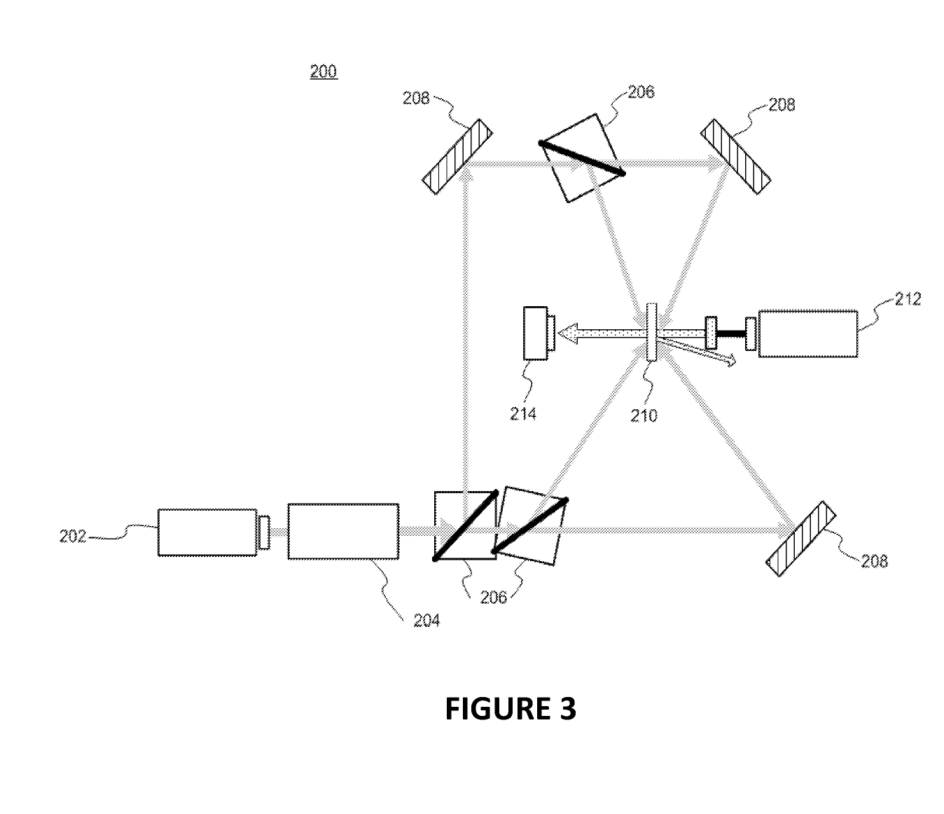

FIG. 3 depicts an example holography apparatus 200 used in the formation of hyperspectral broadband HPDLC mediums as disclosed herein. It should be noted that the apparatus depicted in FIG. 3 is an example embodiment, and that the number and positioning of individual elements of the apparatus may be varied without changing the scope of the claimed subject matter disclosed herein.

In the example apparatus depicted in FIG. 3, a fixed laser light source 202 may be focused on a beam expander 204. A laser light source used in the example embodiments was a Verdi Nd:YAG 5 W green laser operating at 532 nm, but laser light sources emitting other wavelengths may be used. The beam expander may also comprise a spatial filter.

After laser light emitted from the laser light source passes through the beam expander and optional spatial filter, the beam may pass through one of more beam splitter plates 206, which may divide a single beam into two beams, and may also redirect the beams in separate directions. The beam splitters may be mounted on fixed stages (not shown), or alternatively may be mounted on motorized translation and/or rotation stages (not shown) that allow the beam splitter to be dynamically rotated and positioned in order to vary how an incident beam is split and/or its intensity varied. A motorized stage may be configured to rotate and/or translate an element mounted thereto in any of an x, y, or z axis. The use of variable beam splitter plates allows the relative intensity of individual beam pairs to be controlled. For example, variable beam splitter plates may be used to divert extra power into a specific beam pair, which in turn may result in more rapid phase separation thereby producing a reflection grating with higher reflection intensity. Conversely, the other beam pair may have a reduced power resulting in slower phase separation thereby producing a reflection grating with lower reflection efficiency. This method may permit wavelength mixing in a single film with controlled relative intensity of the individual gratings. In another example embodiment, laser output power may be controlled to enable the formation of notch and bandpass filters in an HPDLC medium.

In another example embodiment, using a series of beam splitters may result in many (e.g., 10) simultaneous interference spacings spread evenly across a grating pitch range. This configuration may be advantageous in the event that the formation of multiple grating pitches in a single volume of pre-polymer mixture requires each individual interference fringe spacing to be persistent during the entire exposure.

Beams of laser light may also be directed through the use of mirrors 208. The mirrors may be mounted on fixed stages (not shown), or alternatively may be mounted on motorized translation and/or rotation stages (not shown) that allow a mirror's surface to be dynamically rotated and positioned in order to vary the angle at which the mirror reflects light. A motorized stage may be configured to rotate and/or translate an element mounted thereto in any of an x, y, or z axis. The beams of laser light may ultimately be focused, for example through the use of beam splitters, mirrors, or the like, on a pre-polymer mixture sample 210 mounted on a sample stage (not shown). The sample stage may be fixed or may be a motorized translation and/or rotation stage.

An optional fixed white light source 212, for example a white light interferometer, may be operated during formation and focused so that it passes through the prepolymer mixture as the HPDLC is formed. Light that passes through the HPDLC may be detected by detector 214. Use of a white light interferometer and an associated detector during HPDLC formation may allow, for example, for various methods of testing, analyzing, and characterizing the performance of HPDLC mediums, discussed in more detail below. The positioning of the white light source and the detector depicted in FIG. 3 is merely an example, and other configurations are possible and intended to be within the scope of this disclosure.

The above described holography apparatus may be utilized to form enhanced broadband HPDLC mediums with broader ranges of reflected wavelengths and faster switching speeds than can be achieved by typical methods of HPDLC formation. In an embodiment, these enhanced broadband HPDLC mediums may be formed by dynamically varying elements of the above-described holography apparatus during formation. Dynamically varying elements of a holography apparatus may include, for example, the rotation and/or translation of one or more motorized stages having mirrors, beam splitters, or a pre-polymer mixture sample affixed thereto; thus allowing for time and spatial multiplexing during formation, as described in more detail below.

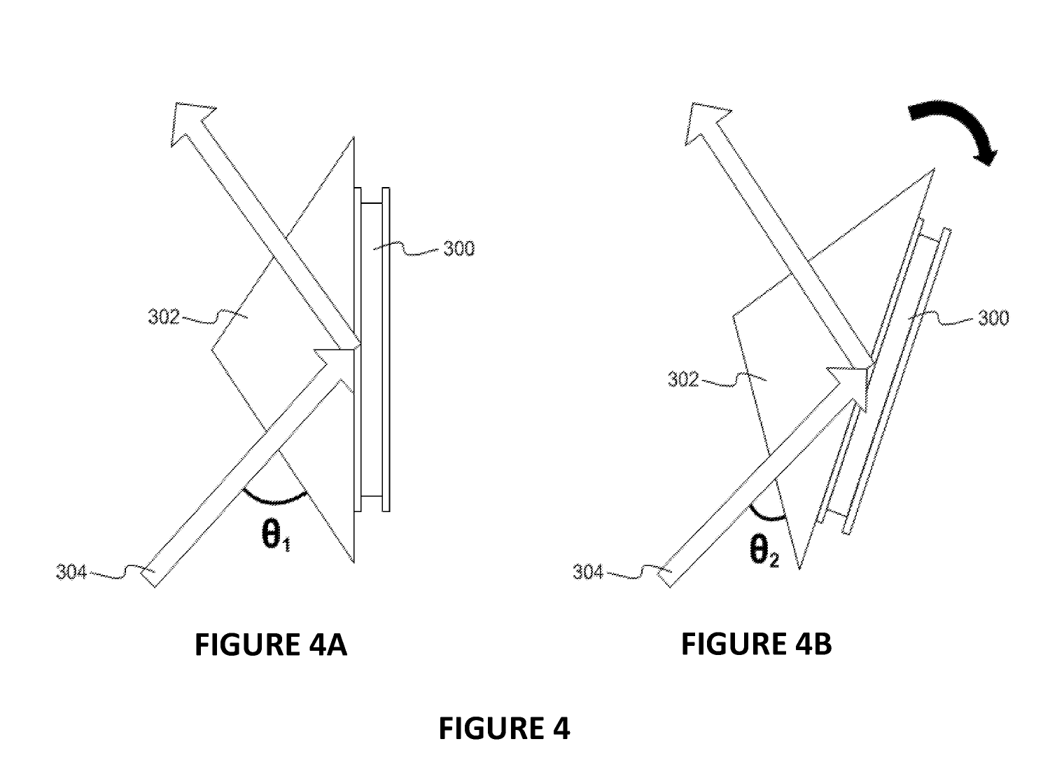

FIG. 4 comprising FIG. 4A and FIG. 4B depict an example technique for dynamically varying a holography apparatus during formation to broaden the interaction wavelength of an HPDLC medium via simultaneous time and spatial, or angular, multiplexing. The apparatus of FIG. 3 may be used, and modified as described herein. A pre-polymer sample 300 comprising a single layer of pre-polymer mixture may be mounted to a motorized translation and/or rotation capable sample stage. In an embodiment, a prism 302 may also be mounted to the sample stage so that the prism makes contact with the pre-polymer sample. A single beam of laser light may be directed to be incident on the prism/sample. As the incident laser beam passes through the prism as depicted in FIGS. 4A and 4B, and is reflected, diffracted, or otherwise affected, interference patterns may be created in the pre-polymer mixture that in turn result in the formation of reflection gratings in the resulting HPDLC medium. During laser beam exposure, the sample stage may rotate and/or translate along one or more of an x, y, or z axis. Rotation and/or translation of the sample stage allows the exposure angles of incident laser beam 304 during grating formation to be varied, for example via clockwise rotation of the sample stage from θ₁ in FIG. 4A to θ₂ in FIG. 4B along an axis perpendicular to the sample. A similar effect may be achieved with the use of a fixed or stationary sample stage, and through varying the angle of incidence of the laser beam itself, for example through the use of mirrors mounted to rotation and/or translation stages. The angle of incidence of the laser beam on the pre-polymer mixture may be varied continuously, or in incremental degrees by controlling the rotation and/or translation of holographic elements accordingly. Varying the angle of incidence of the laser beam on the pre-polymer mixture may cause interference patterns to form in the mixture, in turn resulting in the formation of multiple reflection gratings in the resulting HPDLC medium. These multiple gratings may have varying Bragg grating pitches and/or central wavelengths that overlap spatially and/or spectrally, thus forming an HPDLC medium with continuous broadband gratings capable of reflecting a broad range of wavelengths.

A variation of the single-beam holographic technique depicted in FIGS. 4A and 4B may be achieved by affixing a mirror (not shown) to the back of the pre-polymer mixture sample holder. The prism depicted in FIGS. 4A and 4B may be omitted as a result of adding the mirror to the sample holder. The mirror may induce self-interference in the incident laser beam, creating interference patterns in the pre-polymer mixture that in turn result in the formation of reflection gratings in the resulting HPDLC medium. During laser beam exposure, the sample stage may rotate and/or translate along one or more of an x, y, or z axis. Rotation and/or translation of the sample stage allows the exposure angles of incident laser beam 304 during grating formation to be varied, for example via clockwise rotation of the sample stage from θ₁ in FIG. 4A to θ₂ in FIG. 4B along an axis perpendicular to the sample. A similar effect may be achieved with the use of a fixed or stationary sample stage, and through varying the angle of incidence of the laser beam itself, for example through the use of mirrors mounted to rotation and/or translation stages. The angle of incidence of the laser beam on the pre-polymer mixture may be varied continuously, or in incremental degrees by controlling the rotation and/or translation of holographic elements accordingly. Varying the angle of incidence of the laser beam on the pre-polymer mixture may cause multiple interference patterns to form in the mixture, in turn resulting in the formation of multiple reflection gratings in the resulting HPDLC medium. These multiple gratings may have varying Bragg grating pitches and/or central wavelengths that overlap spatially and/or spectrally, thus forming an HPDLC medium with continuous broadband gratings capable of reflecting a broad range of wavelengths.

In yet another example embodiment of HPDLC formation using angular multiplexing, the holographic exposure apparatus may be configured with multiple pairs of counter-propagating beams, as depicted in FIG. 3. Although two beam pairs (i.e., four beams) are depicted, the scope of the disclosure should not be limited thereto, and additional beam pairs may be added. Additional sources of laser light, of the same or different wavelengths, may also be used in the generation of laser beam pairs. Exposing a sample of pre-polymer mixture using the angular multiplexing technique described herein provides the ability to simultaneously write multiple gratings in a single HPDLC medium. An HPDLC medium having a broadband reflection peak or multiple reflection peaks may result. In order to write two reflection gratings simultaneously, the laser output power may be set to 2 W, and the beam may be expanded and masked to a 1-inch diameter circle. Using beam splitter plates, two beam pairs (i.e., four beams) may be created and aligned so that each beam pair writes a different pitch grating in the HPDLC medium. For example, splitting the 2 W, expanded and masked beam into two beam pairs may result in four beams, with the resultant power in each beam being approximately 100 mW/cm². As previously mentioned, the use of variable beam splitter plates may allow the relative intensity of the beam pairs to be controlled, thereby allowing for tuning of the reflection intensity of individual reflection gratings formed within the HPDLC medium.

Referring again to FIG. 3, angular multiplexing of the four-beam embodiment may involve rotation and/or translation of the sample stage along one or more axes. In an example embodiment, a sample stage holding the pre-polymer mixture may be so rotated and/or translated in order to alter the angle of incidence of one or more of the laser beams on the surface of the pre-polymer mixture. The rotation and/or translation motion may be continuous, incremental with respect to time, or any combination thereof. Altering the angle of incidence of one or more of the counter-propagating laser beams on the surface of the pre-polymer mixture allows for the creation of multiple interference patterns and in turn multiple reflection gratings in the resulting HPDLC medium. The intensity of one of more of the incident laser beams may be varied, for example by the use of variable beam splitter plates 206, in order to create reflection gratings of varying intensity.

In another example, one or more motorized stages may be employed for rotation and/or translation of other elements of the apparatus, for example beam splitters 206, or mirrors 208. The use of additional motorized stages may be used concurrently with or in lieu of rotation and/or translation of the sample stage. The angle of incidence of one or more of the laser beams on the pre-polymer mixture may be altered via such rotation and/or translation, while one or more remaining laser beams may be held at a fixed angle of incidence. Rotation and/or translation of motorized stages having beam splitters or mirrors mounted thereto may allow for individual or simultaneous focusing of the laser beams, thereby allowing for a high degree of tunability in the creation of interference patterns within the pre-polymer mixture. Simultaneous rotation and or translation of both the sample stage and one or more additional motorized stages with beam splitters or mirrors mounted thereto provides the ability to ensure that individual beams are not reflected, diffracted, or otherwise mitigated by any portion of the physical mounting apparatus of the mounting stage.

The above-disclosed angular multiplexing techniques may result in multiplexed broadband Bragg gratings comprising peak reflection wavelengths of approximately 100 nm full width at half maximum (FWHM) or greater. Apparatus configuration parameters that may affect formation include variation speed of the angle of incidence, uniformity of the reflection wavelength, uniformity of the reflection intensity, incident power, and the like.

In order to effectuate transfer of an HPDLC medium by releasing a glass substrate from an HPDLC sample, thereby facilitating grating surface metrology, the surfaces of the glass substrates are treated prior to holographic exposure with a release agent (e.g., surfactants such as Tween and Brix). Treatment with a release agent facilitates complete removal of an HPDLC medium. Following holographic exposure, one glass substrate may be released from the HPDLC medium and HPDLC medium removed. The grating film may then be adhered to an index-matched polymeric substrate coated with an index-matched conducting substrate using the same polymer employed in the grating matrix of the HPDLC medium (e.g., acrylated urethane). An example substrate suited for this purpose is poly-methyl-meth-acrylate (PMMA) coated with Baytron-P conducting polymer, but other substrates may be used. The remaining glass substrate may then be similarly replaced with a second polymeric substrate. If this process is repeated, an index matched completely polymeric HPDLC medium stack may be formed. In an example process, hardening polymers (e.g., Norland Optical Adhesive 63 and/or 68) may be added to the pre-polymer mixture, to increase the toughness of the resulting HPDLC medium.

HPDLC mediums formed using the methods and apparatus disclosed herein often demonstrate reflection efficiencies of 85-90%, switching fields of approximately 15-20 V/μm, and switching times less than 2 ms. Scattering intensities are typically less than 1×10⁻⁷ dB outside the grating reflection peak. Wavelength shifts are typically less than 0.005λ, which may be measured using, for example, a Zygo white light interferometer.

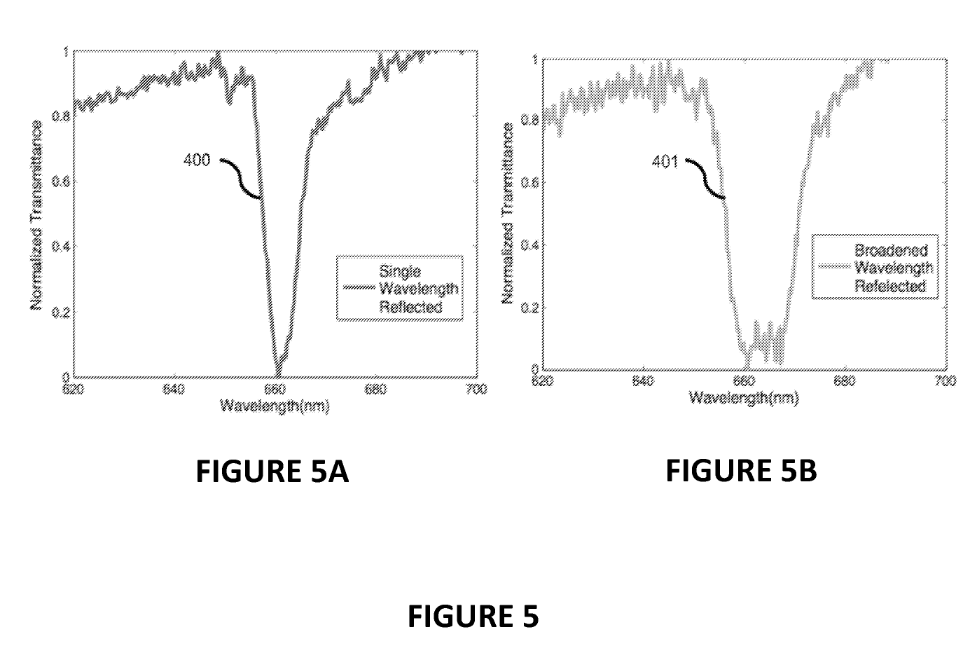

FIG. 5, which includes FIG. 5A and FIG. 5B, illustrates an example of broadened peak reflective characteristics achievable in an HPDLC medium through the creation of multiple reflections gratings using the techniques disclosed herein, in comparison to peak reflective characteristics of a typical single grating HPDLC medium. The reflective behavior of the example single grating HPDLC medium depicted in FIG. 5A has a normalized peak reflection wavelength with a full width at half maximum (FWHM) of 9 nm at 662.2 nm, depicted by the plotted line 400. FIG. 5B depicts an example hyperspectral HPDLC medium containing an infinite number of multiple reflection gratings created using the techniques disclosed herein. In comparison with the single grating HPDLC medium depicted in FIG. 5A, the multiple reflection grating HPDLC medium depicted in FIG. 5B exhibits a broadened peak reflection wavelength of 15 nm, depicted by the plotted line 401.

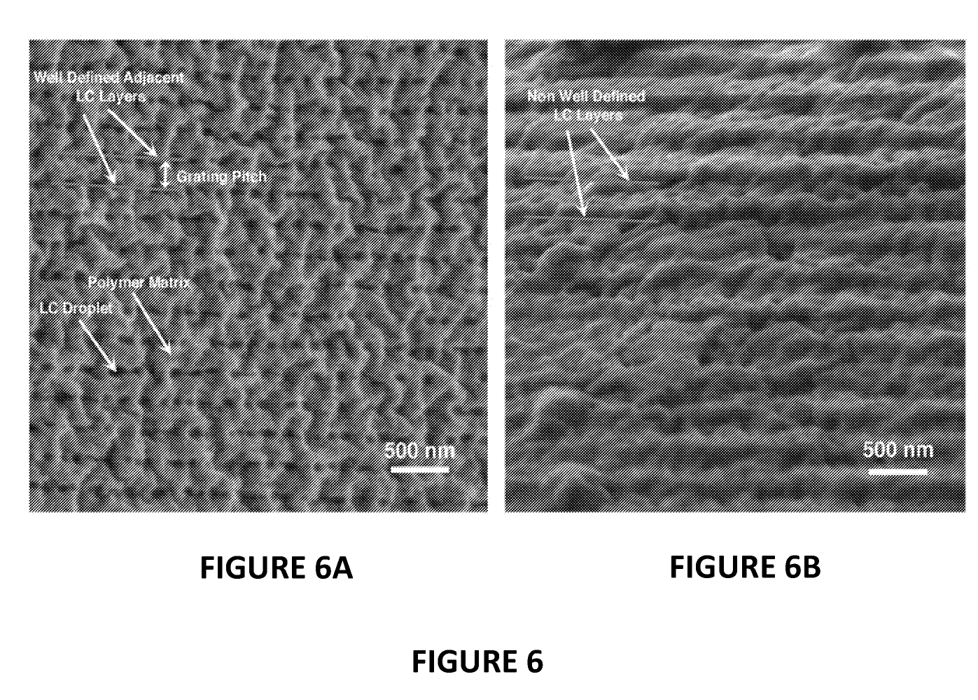

Nanoscale internal morphology of broadband HPDLC gratings may be studied using microscopy techniques, for example a scanning electron microscopy (SEM) technique can be used. FIG. 6, which includes FIG. 6A and FIG. 6B, depicts SEM micrograph images of a single wavelength reflecting and broadband wavelength reflecting HPDLC mediums respectively. In FIG. 6A the dark voids are liquid crystal (LC) droplets surrounded by a polymer matrix. The dark LC voids are arranged in parallel layers forming a periodic Bragg grating structure. The distance between the LC layers is termed as the grating pitch. The grating pitch is typically uniform for single wavelength reflecting HPDLC mediums. FIG. 6B represents a broadband wavelength reflecting HPDLC medium. Due to dynamic movement of a holography apparatus during fabrication, multiple gratings may be formed resulting in an overlapping LC layer structure. This structure results in a nonuniform grating pitch and a broadening of the wavelength reflected by the HPDLC medium of FIG. 6B.

Various grating characteristics of HPDLC mediums may be analyzed to optimize performance. For example, the uniformity of the wavelength reflection peak can be determined. The exposed HPDLC medium may be analyzed using a spectra-radiometer to measure reflection properties of the gratings in multiple locations to ensure uniformity in the exposure process. Other parameters to be examined within each measurement may include wavelength peak, reflection intensity, spatial uniformity, and the like. In another example, the wavefront may be analyzed. Maintaining the wavefront properties of individual wave packets as they interact with the reflecting film ensures accurate measurement at the detector. In yet another example, HPDLC mediums may be examined using a white light interferometer, for example, to measure scatter. Scattering of reflected and transmitted light may result in stray measurements and noise at the detector. This scattering effect may be characterized and compared to scatter effects from existing reflective technologies in order to mitigate or minimize the effect. In yet another example, electro-optic switching properties of an HPDLC medium can be analyzed. This may be accomplished with the use of a spectra-radiometer and high-voltage (e.g., ˜100V pp) switching setup, for example. When a high-frequency (e.g., 1 kHz) oscillating wave is applied to an HPDLC medium, the liquid crystal droplets align, effectively ‘washing out’ the Bragg grating. This enables partial switching of the entire grating, which can be used to ‘grayscale’ or vary the intensity of the grating. An HPDLC medium may be analyzed for uniformity in color purity, intensity, focal length and direction, and polarization during dynamic switching and grayscale switching.

The optical output behavior of reflective HPDLCs may be modeled using methods such as coupled wave theory and matrix approaches. To enable such modeling each layer of polymer and liquid crystal may be considered individually stacked, forming a periodic grating profile. In the coupled wave theory approach, the dielectric medium is typically isotropic and the refractive index varies in a sinusoidal fashion. The reflected beam may be coupled to the incident beam, giving an expression for the energy transfer efficiency. Different matrix approaches also can be used to deduce the output of the HPDLCs by considering Maxwell's equations in a matrix form. A 2×2 matrix approach has 2 element field vectors. The liquid crystal (LC) layer may be assumed to be isotropic. In a 4×4 matrix approach, there are 4 field vectors corresponding to electric and magnetic fields for 2 independent polarization modes. This may be useful for describing birefringent LCs. The characteristic matrix for LC and polymer layers, beginning from one end of the stack, may be computed and then the field vectors may be propagated to the other end of the stack by taking the product of the individual layer transfer matrices. A particular HPDLC reflecting wavelength can be tailor-made by theoretically modeling them individually.

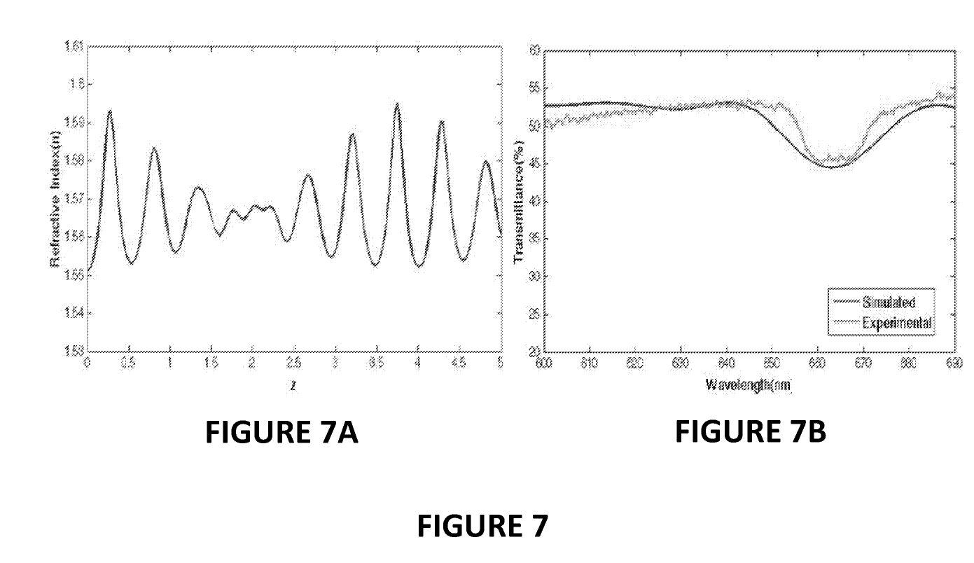

For example, FIG. 7, which includes FIG. 7A and FIG. 7B, depicts an example of theoretical modeling of a broadband HPDLC medium using Berreman's 4×4 matrix technique. Generally, the refractive index of a broadband grating is not uniform due to overlapping reflective gratings. This phenomena can be modeled by using a phenomenological diffusion model. FIG. 7A shows a modeled nonuniform refractive index profile of an example broadband grating. Here, the unit z depicts the thickness of the grating in microns. By substituting the refractive index profile using Berreman's 4×4 matrix technique, the output of the broadband grating can be accurately predicted and/or modeled as depicted in FIG. 7B. Thus, one may first theoretically design a desired HPDLC reflecting wavelength spectrum using the Berreman 4×4 technique and the phenomenological diffusion model. The parameters resulting from the theoretical prediction may be used to fabricate the HPDLC medium corresponding to the desired spectrum. In an example configuration, modeling may be used utilized to predict the output of a broadband HPDLC medium.

In an embodiment, broadband HPDLC mediums formed using the methods and apparatus disclosed herein may be utilized to form lightweight mirrors with electronically switchable focal points for remote sensing. Broadband HPDLC mediums formed using the methods and apparatus disclosed herein may be utilized to form lightweight filters with electronically switchable focal points for remote sensing. Broadband HPDLC mediums may be stacked in one configuration of such a mirror. And broadband HPDLC mediums may be stacked in one configuration of such a filter. Electrically switchable thin-film polymeric stacks (mirror, filter) exhibit good optical characteristics and typically only weigh several pounds, even when including drive electronics. In an example configuration, each layer of the stack comprises a spherically curved Bragg grating with a focal point independent from the other layers. This configuration enables such applications as electrically refocused virtual mirrors for instrument clustering.

Broadband HPDLC stacks as disclosed herein may be constructed by forming, for example, 5 cm diameter broadband HPDLC reflecting mirrors, and laminating them together. One laminating technique that may be used in the construction of a stack comprises gluing the HPDLC mirror films together using optical adhesive. To adhere multiple HPDLC mirror films together using optical adhesive, the HPDLC mirror films may be formed on traditional ITO-coated glass substrates, and may be laminated into a stack using optical adhesive. An example of a suitable adhesive is Norland Optical Adhesive 71, as it possesses several advantageous characteristics, for example UV optical curing that permits precise alignment with no time pressure, very low absorption in the visible wavelength regime resulting in low optical transmission loss, and index of refraction matching the glass substrates, but other adhesives may be used.

Another technique for laminating HPDLC mirror films together to form a mirror stack may involve transferring the HPDLC mirror films (after holographic exposure) to index matched polymeric substrates coated with conducting layers, thereby reducing optical losses through the stack. The HPDLC stack laminating techniques disclosed herein are merely examples. Alternative laminating techniques may be obvious to those skilled in the art, and are meant to be included within the scope of this disclosure.

A broadband HPDLC medium with one or more spherically curved Bragg gratings may be formed using the above-disclosed apparatus and techniques, wherein the exposure technique incorporates a spherical wave to form spherical focusing reflection gratings. To create spherical interference patterns in a pre-polymer mixture, spherical beam expanding methods may be used to holographically expose the pre-polymer mixture. Spherical beam expanding methods may also be used to examine the optical qualities of the resulting spherical gratings. Exposure methods may be adjusted to compensate characteristics of the pre-polymer mixture. For example, the aforementioned holographic techniques work by creating volume interference patterns, which are recorded regardless of the media, and may need to be altered to form high-quality gratings due to the volume of the pre-polymer mixture. Spherically expanded laser beams may be used to form a spherically curved Bragg reflection grating. Exposure condition factors that may be considered during formation include beam power, beam expansion quality, beam coherence, and time of exposure.

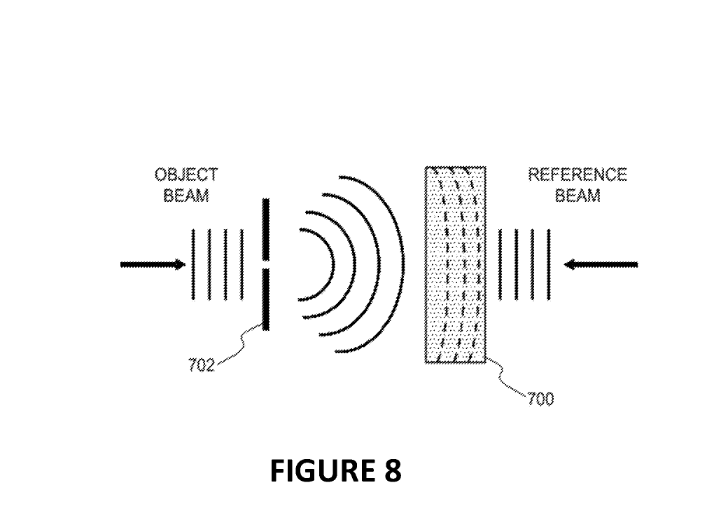

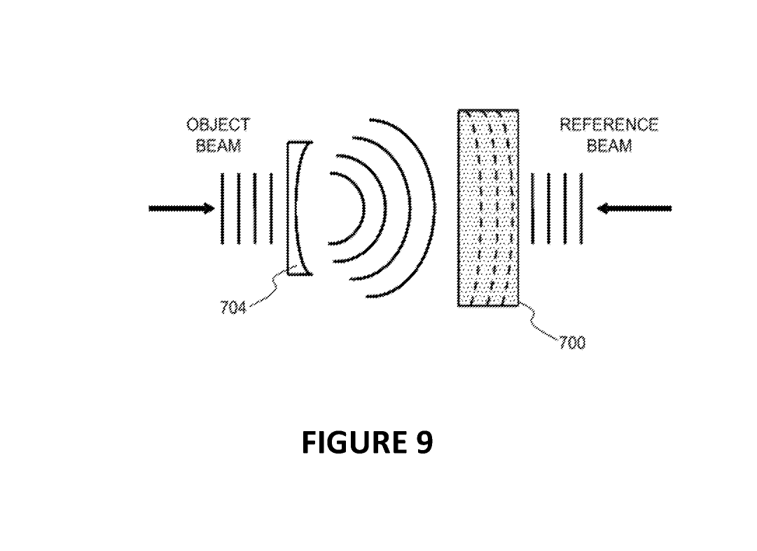

FIG. 8 and FIG. 9 depict two example methods and systems for creating spherically expanded laser beams. The first method, depicted in FIG. 8 involves placing a plate having a pinhole 702 between the object beam from a laser light source and the pre-polymer mixture 700. Passing through the pinhole causes spherical expansion of the object beam wavefront. The spherically expanded object beam interferes in the pre-polymer mixture with the plane wavefronts of a reference beam, forming an interference pattern in the pre-polymer mixture and resulting in a focusing, curved grating pattern of high index (liquid crystal) and low index (polymer) layers.

The second method, depicted in FIG. 9 involves placing a plano-concave lens 704 between the object beam from a laser light source and the pre-polymer mixture 700. Passing through the plano-concave lens causes spherical expansion of the object beam wavefront. The spherically expanded object beam interferes in the pre-polymer mixture with the plane wavefronts of a reference beam, forming an interference pattern in the pre-polymer mixture and resulting in a focusing, curved grating pattern of high index (liquid crystal) and low index (polymer) layers.

An example application of electrically-switchable thin-film polymeric mirrors lies in the optics systems of satellites. A significant limiting factor for satellite design is overall weight, particularly the relatively heavy optics associated with the primary mirrors typically used in satellites for collecting and focusing light on instrumentation, for example cameras, spectrometers, and the like. Additional design considerations include potential complications and weight associated with mechanically-operated beam steering optics typically necessary to utilize multiple instruments with a single primary collection mirror. Current state-of-the-art satellite optics technology employs polished aluminum mirrors, weighing up to several hundred pounds for a one-meter diameter mirror. Cost per pound of payload launched into low earth orbit typically places severe restrictions on the size and extent of light collection devices that can be included on specific missions. The herein described electrically-switchable thin-film polymeric mirrors may allow clustering of multiple scientific instruments around a single lightweight primary mirror and redirection of the focal point of the mirror to individual instruments, using devices that do not require moving parts.

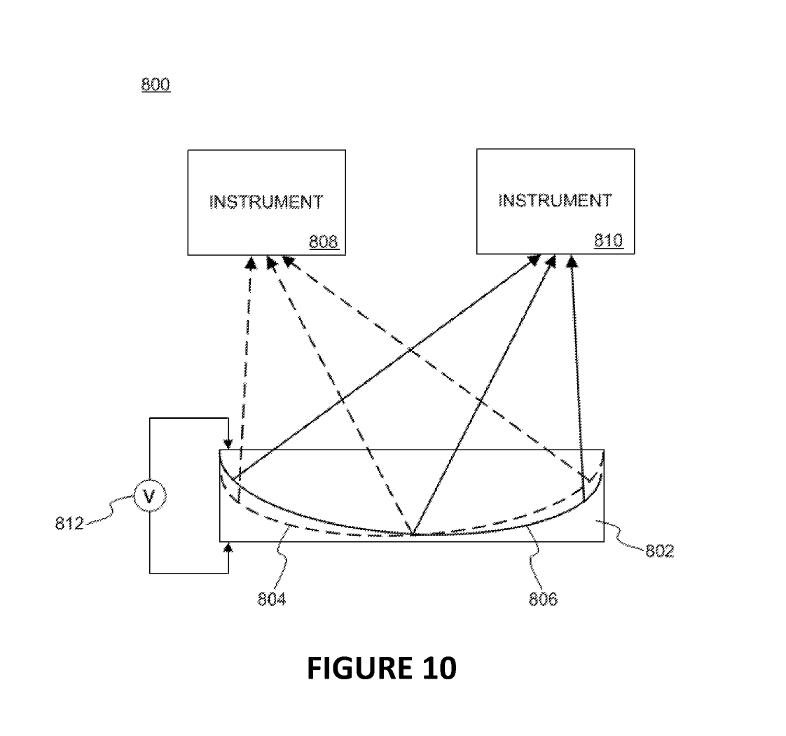

FIG. 10 depicts an example apparatus 800 comprising an electrically-switched thin-film polymeric stack 802. The stack may be constructed from broadband HPDLC thin films as formed as disclosed herein. Two spherically curved Bragg gratings 804 and 806 are focused on instruments 808 and 810 respectively. Instruments 808 and 810 may be any instrumentation for which switchable mirror optics is desirable, for example cameras, spectrometers, and the like. The stack may be electrically-switchable, for example by application of a voltage 812. In an embodiment, varying the voltage applied to the HPDLC may cause grating 804 to be transparent, while grating 806 reflects a broadband peak wavelength to instrument 810. A different variation of applied voltage may cause grating 806 to become transparent while grating 804 reflects a broadband peak wavelength to instrument 808. Thus, by simply varying the applied voltage, different mirrors in the HPDLC stack may be quickly and efficiently turned “on” and “off,” effectively changing the stack's focus between different instruments. In this manner, an electrically-switched thin-film polymeric stack (e.g., mirror, filter)r may serve to replace typical mechanically-operated beam steering optics. It may also be possible using the techniques disclosed herein to direct reflected light properties including wavefront, scatter, and polarization. The electrically-switchable mirrors and/or filters disclosed herein may also be useful a number of other applications, for example LIDAR, radar mapping, oceanographic measurements, and spectral analysis.

The electrically-switchable mirrors and/or filters disclosed herein may also incorporate wavelength filtering capabilities. For example, when electrically-switchable mirrors comprise a multi-color stack, individual HPDLC mediums can be electrically tuned to reject any given visible wavelength through color addition algorithms. A simple example configuration comprises a three-color red-green-blue stack, however, many different color HPDLC mediums can be stacked allowing for finer control over the wavelengths reflected. Wavelength filtering using HPDLC stacks is particularly suited to charge-coupled device (CCD) color filtration, for example in remote sensing and hyperspectral work, where it is desirable to avoid the use of moving parts.

Various characteristics of spherically curved gratings may be analyzed to optimize performance. For example, the uniformity of the wavelength reflection peak can be determined. The exposed HPDLC medium may be analyzed using a spectra-radiometer to measure reflection properties of the curved gratings in multiple locations to ensure uniformity in the exposure process. Parameters to be examined within each measurement may include wavelength peak, reflection intensity, spatial uniformity, and the like. In another example, the wavefront may be analyzed. Maintaining the wavefront properties of individual wave packets as they interact with the reflecting film ensures accurate measurement at the detector. In yet another example, HPDLC mediums may be examined using a white light interferometer, for example, to measure scatter. Scattering of reflected and transmitted light may result in stray measurements and noise at the detector. This scattering effect may be characterized and compared to scattering effects of existing mirror technologies in order to mitigate or minimize this effect. In yet another example, Electro-optic switching properties of spherically curved gratings can be analyzed. This may be accomplished with the use of a spectra-radiometer and high-voltage (e.g., ˜100V p-p) switching setup, for example. When a high-frequency (e.g., 1 kHz) oscillating wave is applied to the spherically curved gratings, the liquid crystal droplets align, effectively ‘washing out’ the Bragg grating. This enables partial switching of the entire grating, which can be used to ‘grayscale’ or vary the intensity of the grating. Spherically curved gratings may be analyzed for uniformity in color purity, intensity, focal length and direction, and polarization during dynamic switching and grayscale switching.

In order to effectuate transfer of an HPDLC medium by releasing a glass substrate from an HPDLC sample, thereby facilitating grating surface metrology, the surfaces of the glass substrates may be treated prior to holographic exposure with a release agent (e.g., surfactants such as Tween and Brix). Treatment with a release agent facilitates complete removal of an HPDLC medium. Following holographic exposure, one glass substrate may be released from the HPDLC medium and HPDLC medium removed. The grating film may then be adhered to an index-matched polymeric substrate coated with an index-matched conducting substrate using the same polymer employed in the grating matrix of the HPDLC medium (e.g., acrylated urethane). An example substrate suited for this purpose is poly-methyl-meth-acrylate (PMMA) coated with Baytron-P conducting polymer, but other substrates may be used. The remaining glass substrate may then be similarly replaced with a second polymeric substrate. If this process is repeated, an index matched completely polymeric HPDLC stack may be formed. In an example process, hardening polymers (e.g., Norland Optical Adhesive 63 and/or 68) may be added to the prepolymer mixture, to increase the toughness of the resulting HPDLC medium.

The dynamically formed broadband HPDLC mediums disclosed herein have useful applications in a wide array of optical devices, for example optical devices designed for beam steering for instrument clusters, hyperspectral imaging, wavelength filtering. Beam steering using stacked broadband HPDLC films with spherically curved gratings can provide the ability to selectively focus specific wavelengths among numerous instruments, for example in space-borne satellite applications. The high color purity exhibited by these HPDLC mediums is a desirable feature for hyperspectral imaging, where objects may be analyzed using different spectral sections. Use of broadband HPDLC mediums as light filters can allow for higher device sensitivity and reliability. Optical devices incorporating these broadband HPDLC mediums may: contain no moving parts; be light weight; and have small physical footprints compared to typical prisms and lenses, thus providing critical advantages when vibration, weight, and real estate are critical design parameters.

Broadband HPDLC mediums are well suited for use in full-color reflective displays, where their high color purity and balanced white point are desirable. Also, H-PDLC films have demonstrated sub-millisecond response times because of the large surface-to-volume ratio, making video rate switching, and perhaps time sequential switching, possible. Other useful applications for broadband HPDLC mediums in optical devices include electrically controllable lenses for use in remote sensing, filter arrays for display and wavelength filtering, optical color filters for micro-displays, application-specific integrated lenses to perform the function of individual lenses, mirrors, prisms, electro-optic switches for routing particular wavelengths, tunable photonic crystals, and controllable photomasks.

In another example embodiment, a HPDLC film may be fabricated via spatial multiplexing and spin coating overlapping reflection gratings. During the HPDLC formation process two counter propagating laser beams may create a one dimensional reflective volume hologram on a photosensitive recording medium comprising a uniform blend of liquid crystals, monomers, and photo-initiator. The standing wave interference pattern generated by the laser beams may be made incident on the material set and photopolymerization techniques may be employed to fabricate the HPDLCs. The monomers may polymerize at the bright regions of the interference pattern and the liquid crystals phase may separate as droplets and diffuse into the dark regions, creating a hologram with periodically varying refractive index. Thus a Bragg grating structure of alternating polymers and liquid crystal droplet layers may be formed. The grating pitch A, which is the thickness of a layer of LC droplets and a layer of polymer matrix, may be dependent on the angle at which the two laser beams interfere to fabricate the HPDLC holograms. Reflective-mode HPDLCs thus formed may reflect a particular wavelength λ_{R} due to coherent scattering of the incident wavelengths by the periodic layers denoted by λ_{R}≈2 nΛ, where n is the average refractive index of the HPDLC grating and n=1.55 for HPDLC recipe considered here. This reflective optical property may be electrically controllable by applying an electric field. Applying an electrical field across the HPDLC may reorient the LCs in the direction of the field and result in a uniform refractive index along the HPDLC. This may transform the HPDLC from a wavelength selective state to an optically transparent state which transmits the entire incident spectrum.

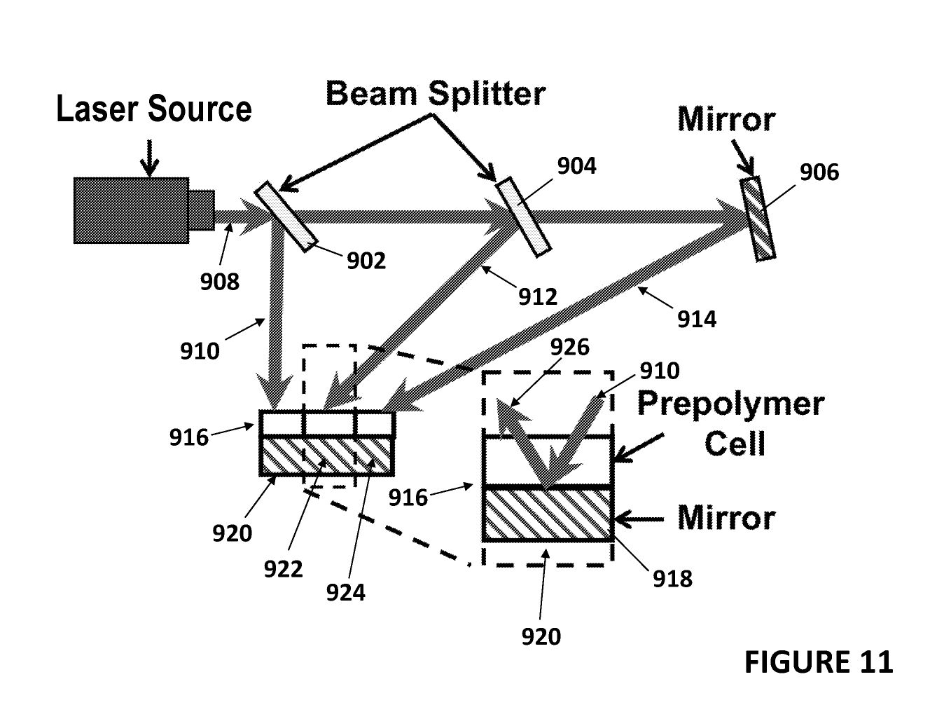

FIG. 11 is a depiction of an example fabrication setup for fabricating three arrayed reflection volume holograms. Two beam splitters 902, 904, and a mirror 906 may be used to split a laser beam 908 into three equal intensity beams 910, 912, 914 each having an irradiance, for example, of 200 mW/cm². Each of these beam paths may be incident at distinct areas on the prepolymer syrup of a prepolymer cell 916, for the formation of spatially arranged HPDLC units 920, 922, 924. Angles at which the beams are incident on the prepolymer cell 916 may determine the grating pitch of the HDLC. A mirror 918 may be placed flush against the prepolymer syrup cell 916 to enable fabrication. During the HPDLC formation, the laser beams 910, 912, 914 may transmit through the prepolymer syrup cell 916 and may reflect back from the mirror 918. An example depiction of the incident beam 910 and a reflected beam 926 is shown for HPDLC unit 920 in FIG. 11. The incident beam (example beam 910) and reflected beam (example beam 926), which correspond to the reference and the object beam in hologram fabrication, may interfere for a period of time (e.g., 60 seconds) to form volume reflection HPDLC holograms. The dimensions of the three gratings formed from the configuration depicted in FIG. 11 may be 20×5 mm placed adjacent to each other. Once the gratings are formed they may be treated with a UV blanket for a period of time (e.g., 10 minutes) to react any unreacted monomer remnants.

Various devices may be formed by utilizing the aforementioned HPDLCs. For example, HPDLCs possess fast microsecond range electro-optic response, good diffraction efficiency, and high color purity making them useful in the design of wide-ranging electro-optic devices such as optical switches, optical strain gauges, reflective displays, reconfigurable lenses, wavelength filters, optical data storage devices, or the like.

A spectrometer may be formed from HPDLCs that were fabricated as described above. Both transmission and reflection types of holograms may be used for wavelength detection in a spectrometer. Transmission holograms may be used in dispersive spectrometers as diffraction gratings. In a dispersive spectrometer, a prism or diffraction grating may separate the incident wavelengths based on their refractive index. An arrayed detector may capture the separated wavelengths and characterize them individually. Multiplexing the transmission holograms as dispersive medium may have high resolution and small footprint.

Spectrometers based on electric field-controlled reflection HPDLC holograms may filter wavelengths based on their individual Bragg reflection wavelengths. There may be various types of spectrometers based on stacking of HPDLC units adjacent to each other and field controlling them individually. Configurations may differ in placement of the detector. In one example type, the detector may be placed to capture the reflection intensity of the stack and in the another example type, the detector may capture the incident wavelength intensity transmitted through the stack.

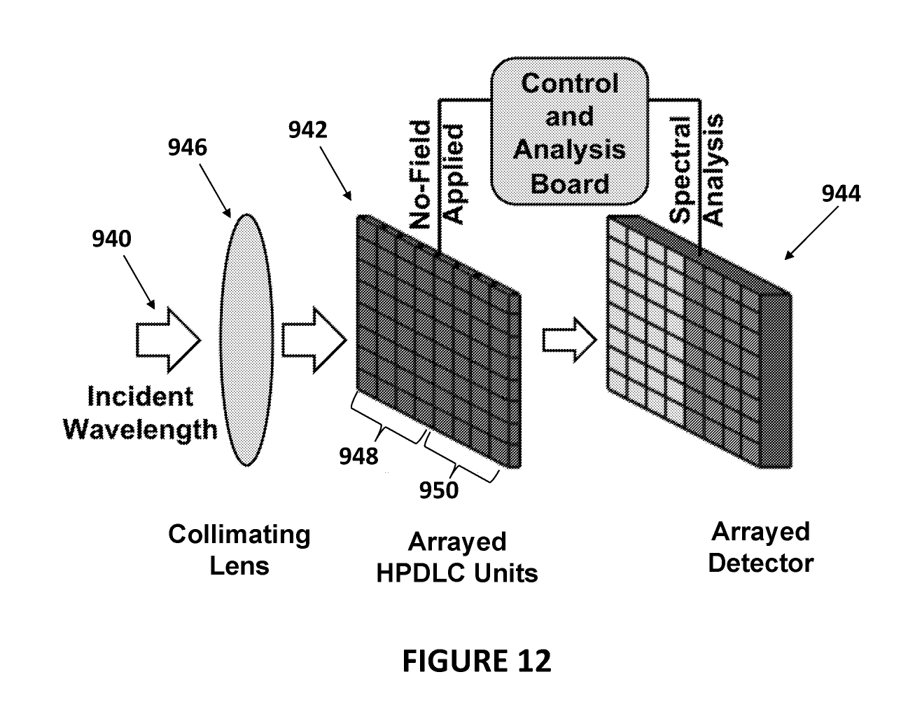

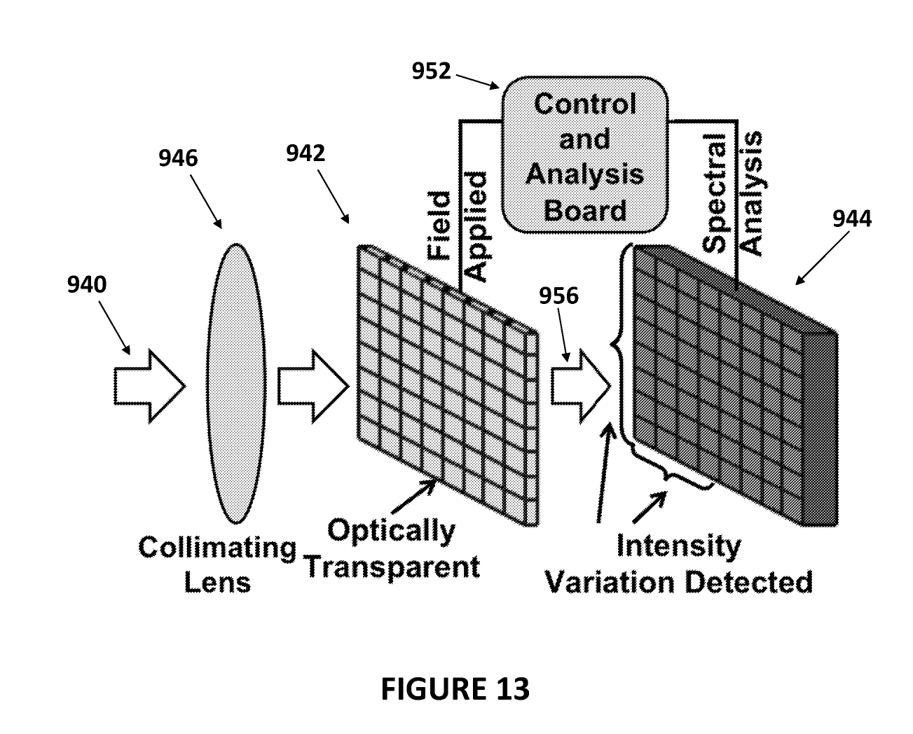

FIG. 12 and FIG. 13 depict an example spectrometer detection system and process. In the prototype spectrometer, arrayed HPDLCs in a single layer form the wavelength-separating segment of the spectrometer. An arrayed CCD detector measures individual intensities transmitted by each of the HPDLC units. The detection process of source wavelengths was two-stepped. As depicted in FIG. 12, during the first step, wavelengths 940 to be analyzed are transmitted through a collimating lens 946 and HPDLC arrays 942, and individual intensities transmitted through each of the units are measured at the detector end 944. As depicted in FIG. 12, the left half 948 of the 64-array HPDLC filter 942 has one particular Bragg reflecting wavelength. When a source comprising this wavelength is incident, the unit cells on the left half reflect most of it whereas the HPDLC units at the right half 950 transmit it. A matching 64-array detector 944 may capture intensity transmitted through each of these unit cells of the HPDLC filter 942.

As depicted in FIG. 13, during the second step, an electric field may be applied (e.g., via control and analysis unit 952) across the HPDLC filter 942 rendering the entire HPDLC unit cells optically transparent and transmitting incident wavelength without wavelength selectivity. The transmitted intensity 956 may be mapped at the detector 944. A change in intensity detected at any of the detector array units of the detector 944 after the two-step process may indicate the presence of wavelength corresponding to the Bragg reflection wavelength of the HPDLC unit in the test source and thus may enable detection. As depicted in FIG. 13, a change in intensity transmitted at the left half is recorded after this two-step process, thus enabling detection of wavelength corresponding to the Bragg reflecting wavelength of the left half of the HPDLC units. No intensity variation detected at the right half infers that the test wavelength does not correspond to any of the right half unit cell's reflecting wavelength.

The prototype spectrometer was formed using spatially arranged holographic polymer dispersed liquid crystals (HPDLCs) in a single layer as described herein. Electric field controllable HPDLCs were fabricated by the holography technique described herein. In the spectrometer, a detector may measure the incident spectrum filtered by each of the HPDLCs in the array. Analysis of the detector intensity following electric-optic control of HPDLCs may result in wavelength detection.

To fabricate the HPDLCs for the spectrometer, a prepopolymer recipe made of tri and hexa-functional acrylate oligomers Ebecryl 4866 and Ebecryl 8301 from Cytec, LC BL038 from Merck, photoinitator to sensitize the syrup to visible wavelength enabling hologram formation and surfactant Tween 80 to improve the electro optic response was used. The photoinitiator comprised 4% Rose Bengal, 10% of coinitiator N-Phenyl Glycine, and 86% of N-Vinyl Pyrrolidone. The percentage ratio weight of the ingredients used was 22.5% (Ebecryl 4866): 22.5% (Ebecryl 8301): 32.4% (LC): 12.6% (Photoinitiator): 10% (surfactant). The homogeneously blended recipe was placed between conductive indium tin oxide (ITO) coated glass substrates spaced 5 μm apart.

The prototype spectrometer comprised three HPDLC units fabricated on a single layer. In the arrayed HPDLC based spectrometer, the spatial multiplexing technique described above (e.g., FIG. 11) was used for the formation of multiple HPDLC units in a single layer. To experimentally demonstrate performance of the three spatially fabricated HPDLCs, a setup was constructed comprising of a monochromator light source Cornerstone 74100 from Newport, three unit arrayed HPDLCs and grayscale CCD detector XC-77 from Sony all placed in line. The CCD detector is connected to an oscilloscope to enable easy interpretation of the detected intensity. The HPDLC array in the setup is connected to an electric field generating unit to field bias and unbias it.

To assess performance of the wavefront of the HPDLC unit cells, wavefront analysis was performed using a wavefront sensor. A white light source transmitted through a HPDLC unit and the resulting wavefront was analyzed. In the wavefront sensor, the test source was passed through an array of lenses having the same focal length. The deviation of the incident wavefront from the focal spot of each lens incident on a CCD sensor was sampled, software analyzed, and curve fitted for an approximate test wavefront envelope. Wavefront characterizing parameters such as Strehl ratio for example, were determined. Strehl ratio is the comparison of the maximum intensity due to a point source at the detector in the presence of aberration, to the theoretical maximum intensity of a perfect system without any aberrations.

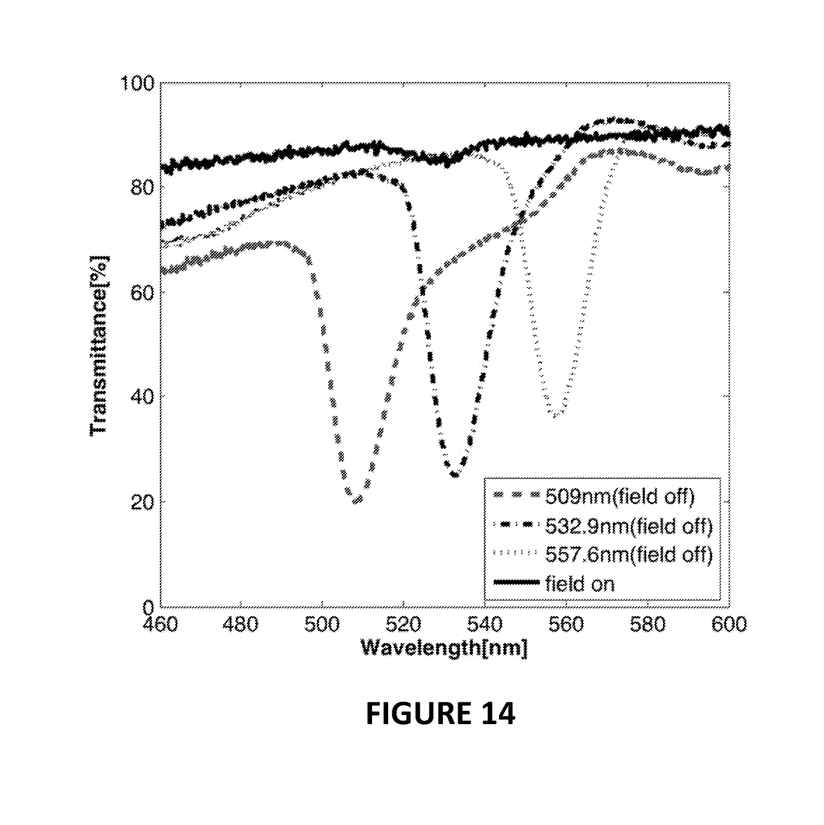

FIG. 14 illustrates example response curves for the three individual HPDLCs, fabricated by the aforementioned fabrication technique. To obtain the response curves (percent transmittance vs. wavelength), white light was transmitted incident on each HPDLC. The detected output was measured by spectrometer. The grating wavelengths or the notch wavelengths after polymer shrinkage were 509 nm, 533 nm and 558 nm. Applying an electric field bias of 12V/μm resulted in the transmission of the entire incident source wavelengths as shown by the continuous lineshape in the curves depicted in FIG. 14. The transmission spectrum of the individual unit was approximately 55% reflection efficiency and full width half maximum (FWHM) of 15 nm. The baseline of the spectrum was lower at smaller wavelengths compared to that at higher wavelengths, which may have been due, for example, to incoherent scattering losses from the LC droplets in the Rayleigh regime associated with each of the HPDLC units.

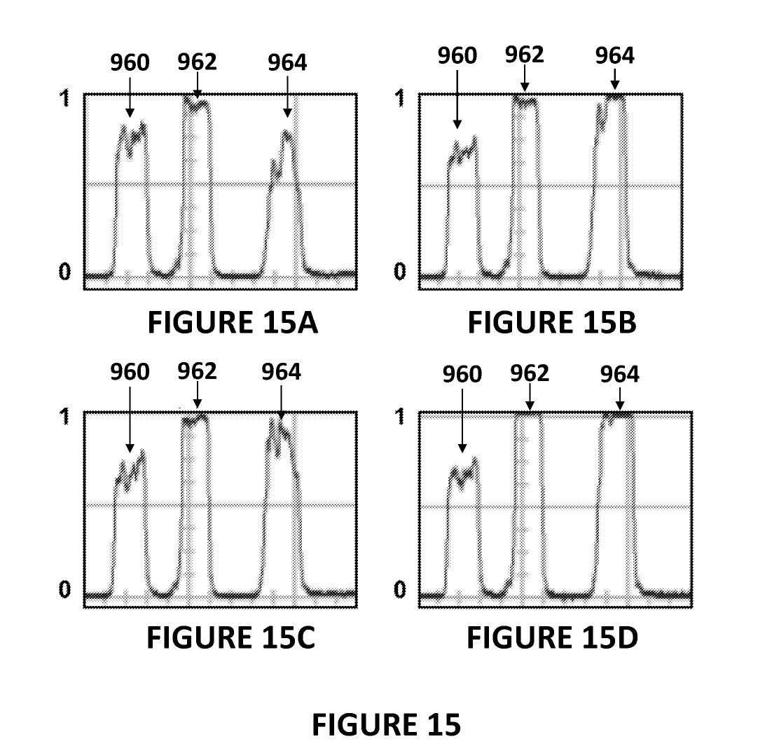

As an example application of the aforementioned HPDLCs in a spectrometer, the monochromator source was made to output different wavelengths and the response at the detector was determined for both an unbiased and a biased state of the arrayed filter. FIG. 15, which includes FIG. 15A, FIG. 15B, FIG. 15C, and FIG. 15D, illustrates example results as shown on an oscilloscope for two different incident wavelengths. The curves are traces of normalized intensity vs. wavelength. The three distinct intensity peaks named 960, 962, 964 correspond to transmission through the 3 HPDLC arrays with Bragg wavelength of 509 nm, 533 nm, and 558 nm respectively.

FIG. 15A and FIG. 15B illustrate oscilloscope trace when 558 nm corresponding to Bragg wavelength of the third HPDLC was made incident. In the unbiased state the three arrays transmitted three incident peaks as shown in FIG. 15A. The rightmost intensity peak detected corresponds to the intensity transmitted through the 558 nm Bragg wavelength HPDLC unit. FIG. 15B shows an intensity increase of 33% percent transmitted through the 558 nm HPDLC filter when the filter array was field biased. When a source wavelength other than the HPDLC Bragg wavelengths was incident there was no variation in the detected intensity between the unbiased and biased state. This is demonstrated for the wavelength 600 nm as depicted in FIG. 15C and FIG. 15Dd respectively. In an example embodiment, an increase in the transmitted intensity between field biased and unbiased state may occur due to, for example, realignment of LC droplets and reduction in incoherent scattering due to uniform refractive index in the HPDLC filter. This can be seen for non-Bragg wavelengths clearly indicated for wavelength 558 nm between FIG. 15C and FIG. 15D. In an example embodiment, a lower limit threshold intensity setting may avoid false detection.

The herein described spectrometer may precisely detect narrow banded wavelength sources up to a resolution of 0.1 nm using, an may be suitable for detecting wavelengths ranging from UV to IR due to the fabrication of HPDLCs with Bragg wavelengths ranging from UV to IR. Recurring of the same wavelength cell through the filter may ensure that all the wavelengths of the incident spectrum pass through it for detection for large HPDLC filter dimension. In an example embodiment, to prevent cross talk, where the transmitted signal from one unit spills over to the detector unit of another, padding may be provided between the filter and detector units. Innumerable arrayed HPDLC units may be fabricated without loss of SNR. However increasing the number of units may increase the complexity of the hologram fabrication setup and may require additional lasers to maintain beam irradiance to form each unit cell. The herein described arrayed spectrometer may have the ability to precisely detect the presence of known wavelengths for remote sensing applications. For example, to detect presence of life, known spectrums of water molecules may be searched to match with an HPDLC cell's wavelength.

An optical filter constructed with holographic polymer dispersed liquid crystal (HPDLC) elements, such as HPDLC films, may be configured to be switchable between a light scattering state, wherein at least one, such as a plurality of wavelengths of light incident upon the filter can be refracted and/or reflected by respective HPDLC elements of the filter, and a transparent or semitransparent state, wherein at least one, such as a plurality of wavelengths of light incident upon the filter can pass through the filter. The HPDLC filters may be formed by exposing a homogenous blend of photopolymer and liquid crystals sandwiched between Indium Tin oxide (ITO) coated glass slides-spaced a few microns apart, to light. Polymerization induced phase separation results in randomly oriented nematic liquid crystal (LC) droplets trapped in the polymer matrix. The refractive index mismatch between the LC droplets and the polymer matrix results in light scattering in the Rayleigh regime.

In an example configuration, the herein described HPDLC tunable filter may comprise a stack of HPDLC elements, wherein each element is designed for reflecting a particular Bragg wavelength. In accordance with an example embodiment, an HPDLC element may be fabricated, in part, by spin coating liquid crystals onto a glass or flexible substrate, as described in more detail below. Each HPDLC element in the stack may be individually biased between its respective scattering and transparent states through application of a voltage. In this way, the HPDLC tunable filter may be tuned, element by element, though the spectral range of the stack, allowing selected wavelengths of incident light to be transmitted through the stack. As described in more detail below, the HPDLC tunable filters described herein may exhibit extremely fast bias switching speeds, thereby allowing for a variety of real world applications, for example use in hyperspectral imaging, as described in more detail below.

In accordance with one embodiment, an HPDLC tunable filter may be formed by exposing a prepolymer mixture to a holographic interference pattern generated using coherent laser beams. Diffusion kinetics of the polymer force the liquid crystals (LC)s into the dark regions of the interference pattern where they remain trapped as nematic droplets. This may result in a Bragg grating structure whose refractive index varies periodically with the thickness of the cell. Depending on the fabrication geometry either diffraction or reflection gratings can be fabricated.

In operation, application of an electric field (E-field) across the HPDLC tunable filter may cause a reorientation torque across respective LC droplets such that the LC droplets substantially align along the direction of the applied E-field. This alignment essentially causes the LC droplets to align such that the ordinary refractive indices of the birefringent nematic LC droplets substantially match that of the surrounding polymer matrix, hence rendering respective HPDLC elements of the filter transparent or semitransparent relative to their corresponding frequencies of light.

In an example embodiment, an HPDLC tunable filter as described herein may selectively block long-wavelength infrared (IR) emissions (e.g., solar emissions). In an example embodiment, a region of interest may comprise wavelengths having a wavelength in the range of about 8 to 12 microns. An example application of such an IR HPDLC may be for IR solar immunity of optical instrumentation. In this application, electrically controlled selectivity over the wavelength range may be incorporated.

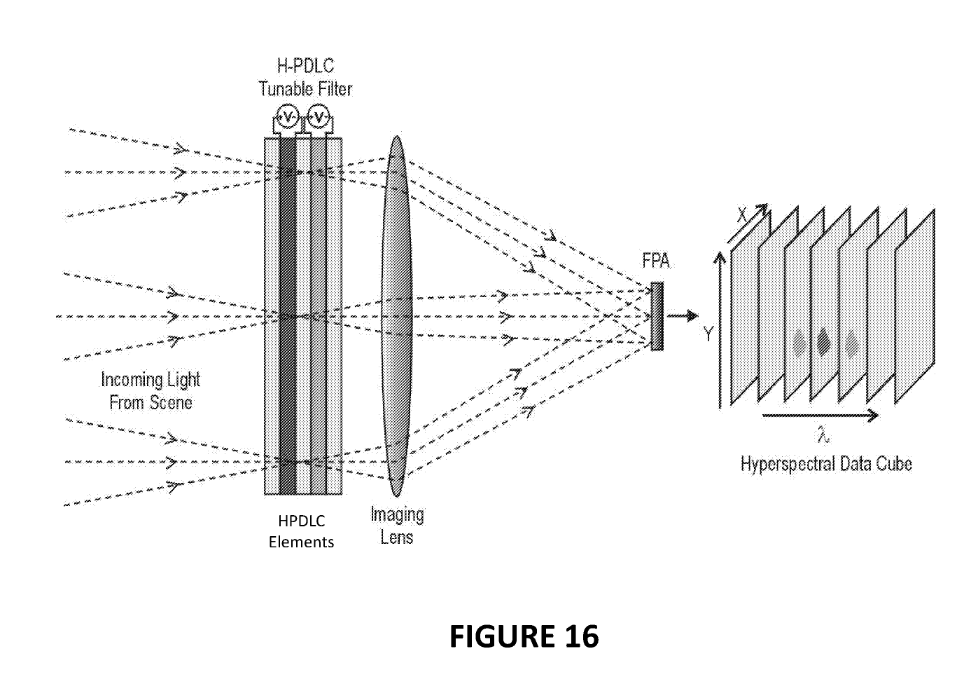

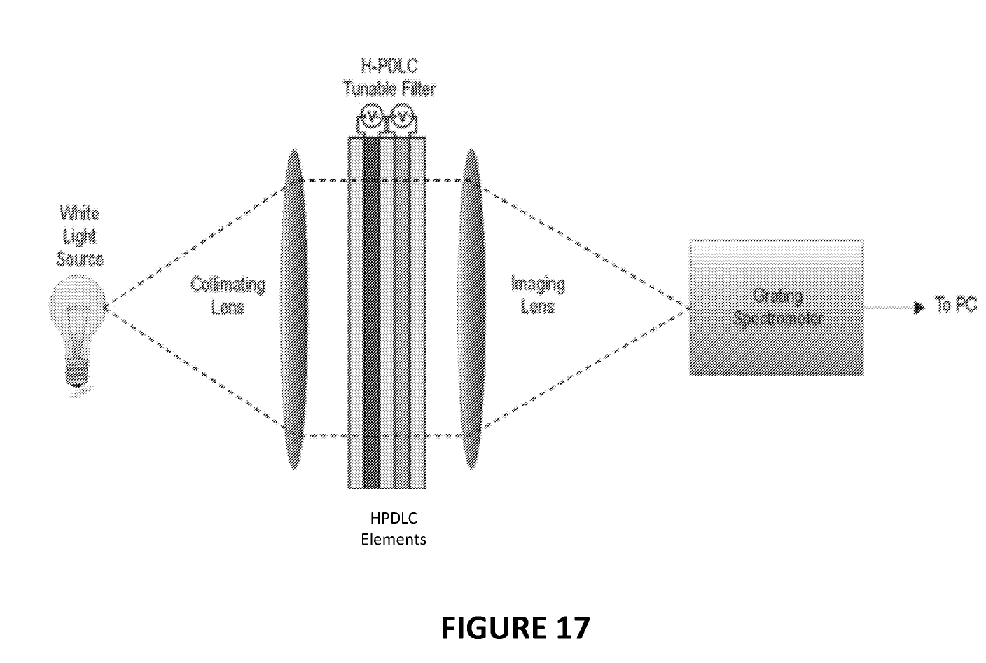

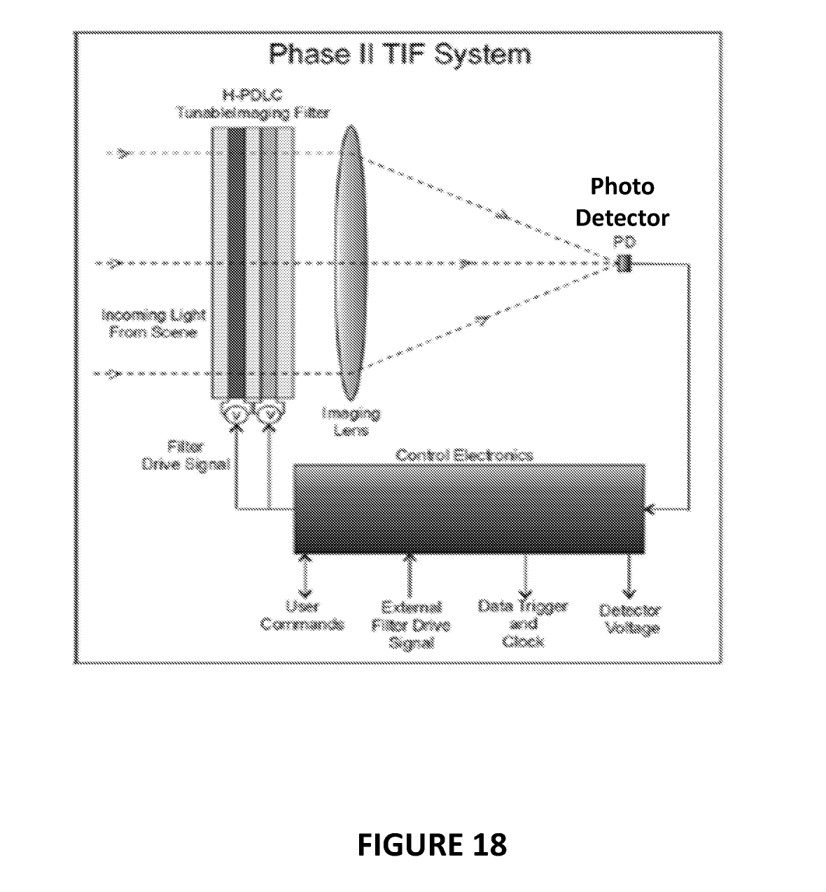

FIG. 16 depicts an example HPDLC tunable filter system. The illustrated HPDLC tunable filter system may include a number of components, such as an HPDLC tunable filter stack, an imaging lens, and focal plane array. In accordance with the illustrated embodiment, light from a scene of interest may be incident upon the HPDLC stack comprising a series of HPDLC elements (e.g., HPDLC thin films) each designed for a different Bragg wavelength. The HPDLC tunable filter may be used with the imaging lens and the focal plane array (FPA), for example, to acquire hyperspectral imaging data from the scene of interest. In such a scenario, the HPDLC tunable filter system may operate as a hyperspectral imaging system. The hyperspectral imaging data acquired may be used to assemble a hyperspectral data cube associated with the scene of interest, as described in more detail below. Moreover, the HPDLC tunable filter may be used, for example with the imaging lens and the focal plane array (FPA), in order to interface with imaging optics and/or other components that can be used with the HPDLC tunable filter system. For example, see FIG. 17, which depicts an example HPDLC tunable filter in conjunction with a grating spectrometer. FIG. 18 depicts another example HPDLC tunable filter in conjunction with a photo detector and control electronics.

In an example configuration, an HPDLC element may comprise periodic structure comprising alternating polymer and liquid crystal (LC) droplet layers which create a Bragg grating. The period of the layers may determine the Bragg wavelength that is reflected and the number of layers may determine the passband or spectral resolution about the Bragg wavelength. Applying a voltage across the structure may cause the LC droplets to rapidly rotate state which may alter the refractive index of the LC layers such that it matches that of the polymer layers; this effectively may negate the Bragg grating such that the Bragg wavelength may no longer be reflected and may transmits through the HPDLC element. The small size of the LC droplets may support an extremely high switching speed on the order of 20 microseconds (μs) to 10 nanoseconds (ns). A tunable filter may be realized with a stack of HPDLC elements each designed for a different Bragg wavelength and separated by the passbands of the HPDLC elements.

HPDLCs that function in the visible wavelength range may have layer thicknesses on the order of a few hundred nanometers. These thicknesses may be achieved through a holographic exposure from a UV or visible laser. In order for an HPDLC to reflect light in the 8-12 μm range, the thickness of individual layers may be on the scale of 5-10 μm. HPDLCs with these layer thicknesses may pose fabrication difficulties due to polymer insensitivity in the NIR and IR spectra. As described herein, one example technique for fabricating HPDLCs for IR filtering comprises a hybrid holographic formation technique. Another technique comprises a spin coating technique.

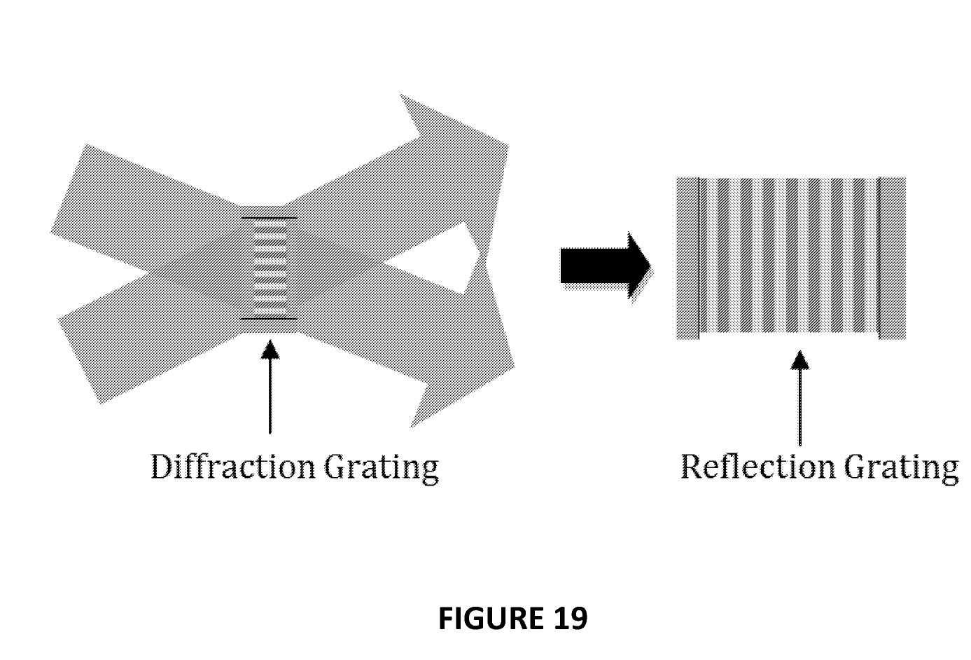

FIG. 19 illustrates an example holographic formation of a diffraction grating. In an example embodiment, the diffraction grating structure may be used as a reflection grating when rotated 90 degrees after the grating is fully formed. As opposed to pure holographic formation of reflection gratings in HPDLCs with 5-10 μm individual layer thicknesses that may require an extremely high power holographic process on the order of 100 W, the herein described holographic formation may achieve these layer thicknesses holographically in a diffraction grating geometry. When a sample is appropriately prepared and exposed, it may possible to create a reflection grating with 5-10 μm layer thicknesses through a diffraction grating formation.

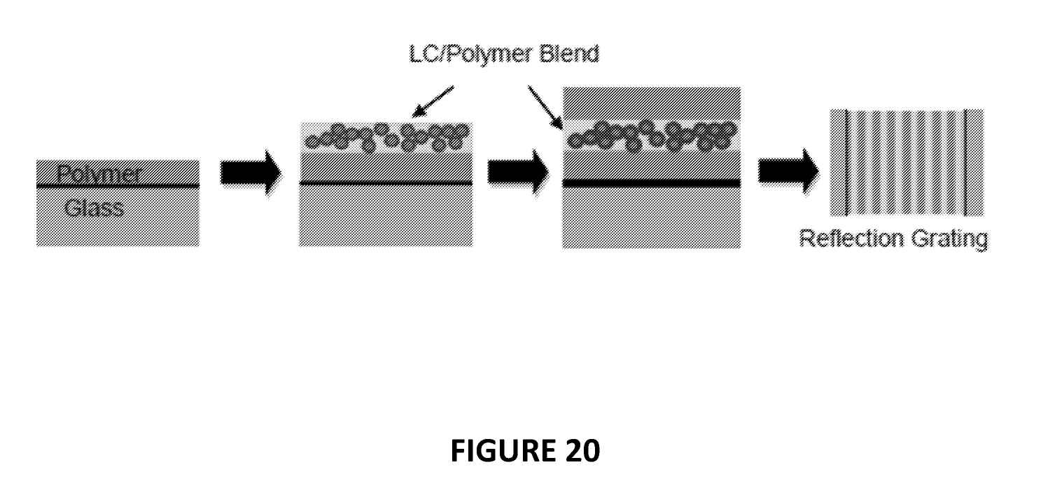

FIG. 20 illustrates an example fabrication by spin coating. Another example embodiment comprises fabricating HPDLCs by spin coating. This technique be used to create HPDLCs that reflect in the 8-12 μm range by building each layer individually. In this technique, a polymer layer may be applied with the spin coater then exposed to UV light. Then a liquid crystal/polymer blend layer may be applied and exposed. This technique may be repeated until the entire grating has been formed.

The herein described IR HPDLC fabrication techniques may provide dynamic filtering of light in the 8-12 μm range. The use of micron sized LC drops may result in extremely fast switching times of better than 100 microseconds. The ability to modulate wavelengths at different frequencies may create spectral multiplexing that results in a SNR improvement proportional to the square root of the number of spectral bands. The technique of formation of the HPDLC grating structures may enable the formation of specific target wavelengths within a given range. The grating wavelength separation does not need to be uniform. Specific regions of interest may have a higher wavelength sensitivity within the spectrum being analyzed. The use of thin film reflection gratings may reduce the path length of light through absorptive material.

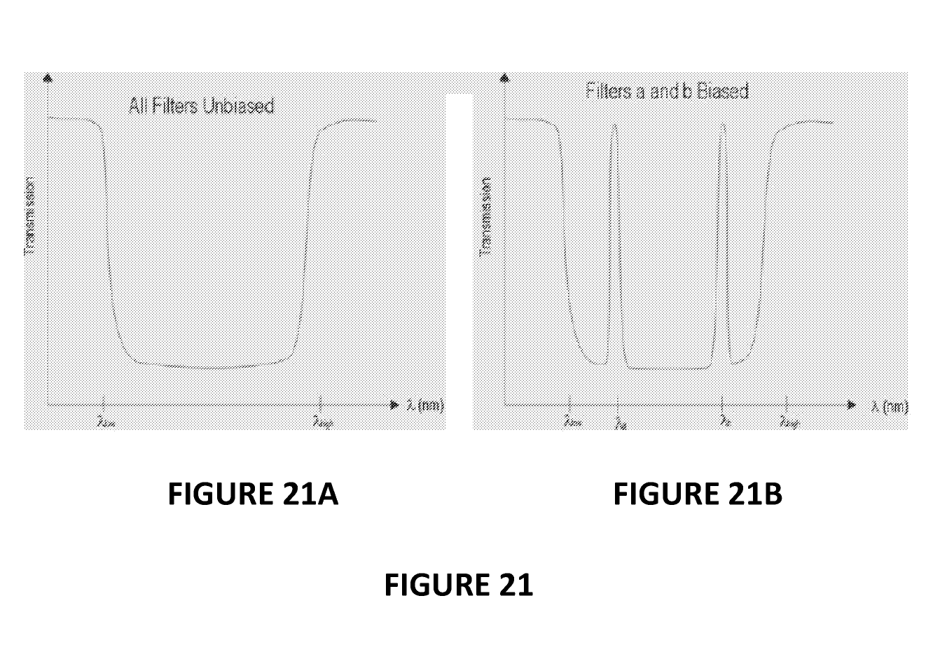

FIG. 21, which includes FIG. 21A and FIG. 21B, depicts example spectral characteristics of an example HPDLC tunable filter. When all elements are not biased (FIG. 21A), each Bragg condition is in place and all Bragg wavelengths are reflected by the stack, and thus there is no transmission of light through the stack. Applying a voltage across example elements, depicted as “a” and “b” in FIG. 21B, may disrupt the Bragg condition in these elements, and allows spectral resolution elements a and b to pass. In operation, a voltage applied to all elements may therefore result in full transparency across the spectral range, and the unbiasing of select elements may result in the rejection of the corresponding Bragg wavelengths. In this way, the filter may be tuned, element by element, though the spectral range of the stack. Alternatively and as a result of the extremely fast switching speed, each HPDLC element may be modulated at a different frequency on the order of tens of kHz, thereby supporting the ability to synchronously detect and demodulate each wavelength with a high update rate of the entire hyperspectral cube. In other words, the HPDLC tunable filter can spectrally multiplex.

In an example embodiment, an HPDLC tunable filter stack may be fabricated by spin coating and photocuring individual layers of prepolymer mixture, alternated by layers of conducting polymers. In this fabrication technique, a layer of prepolymer mixed with liquid crystals is spin coated on a glass or flexible substrate, coated with a conducting polymer, with a thickness of 20 microns, for example, and then exposed to an interference pattern generated by a laser beam. A Bragg grating is formed in the sample post exposure which reflects a particular wavelength, hence forming a wavelength filter. Another layer of conductive polymer is spincoated or evaporated on top of this first layer, the conductive polymer layer configured for application of an electric field. The combination of the exposed HPDLC and conductive layer can be operated as a tunable filter, that is it can be switched, upon application of an electric field, between a reflecting state and a transparent or semitransparent state. Subsequent layers of HPDLC are spincoated on top of this layer, exposed to an interference pattern with different respective pitches, along with corresponding layers of conductive polymers, creating discrete HPDLC elements, sequentially to form a stack of HPDLC elements. The HPDLC element stack can be electrically controlled, for example by application of particular voltages, to reflect various wavelengths. In other words, each HPDLC filter element in the stack can be electro-optically controlled.

Typical HPDLC element stacking techniques require two Indium Tin Oxide (ITO) coated glass substrates to fabricate one HPDLC filter element, and multiple such filters elements can be affixed to one another in a filter stack using an index matching glue. Use of ITO is known to be very expensive and susceptible to mechanical fracture. The herein described spin coating fabrication technique bypasses utilizes conductive polymers to separate HPDLC elements within the stack, eliminating the need to sandwich individual HPDLC elements between ITO coated glass slides and the need to use index matching glue to construct the stack. The use of conductive polymers as intermediate layers dramatically reduces the optical path length of the HPDLC tunable filter stack without adversely affecting the electro-optic performance of the stack. Additionally, reduction in fresnel reflection due to elimination of the glass substrates can obviate the need to use anti-reflection coatings. Moreover, reduction in thickness of the composite stack reduces wavefront errors induced in the wavefront surface traversing through the stack. Small size makes it integratable in lab on-chip devices. As described in more detail below, the spin coating techniques described herein can be scaled to varying production needs as desired.

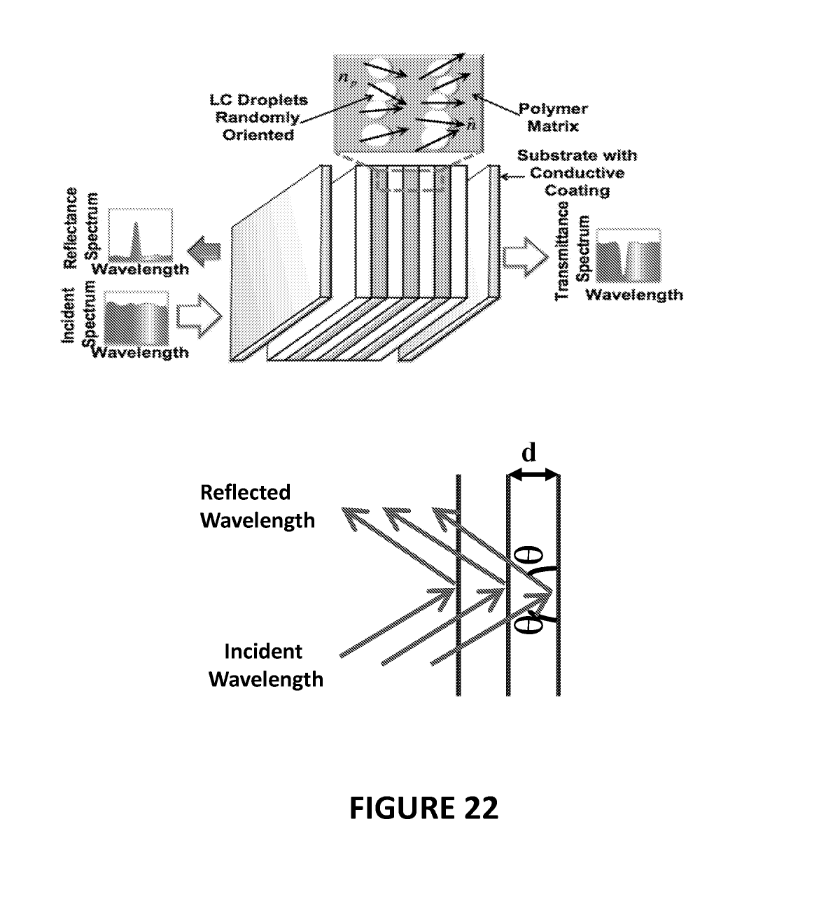

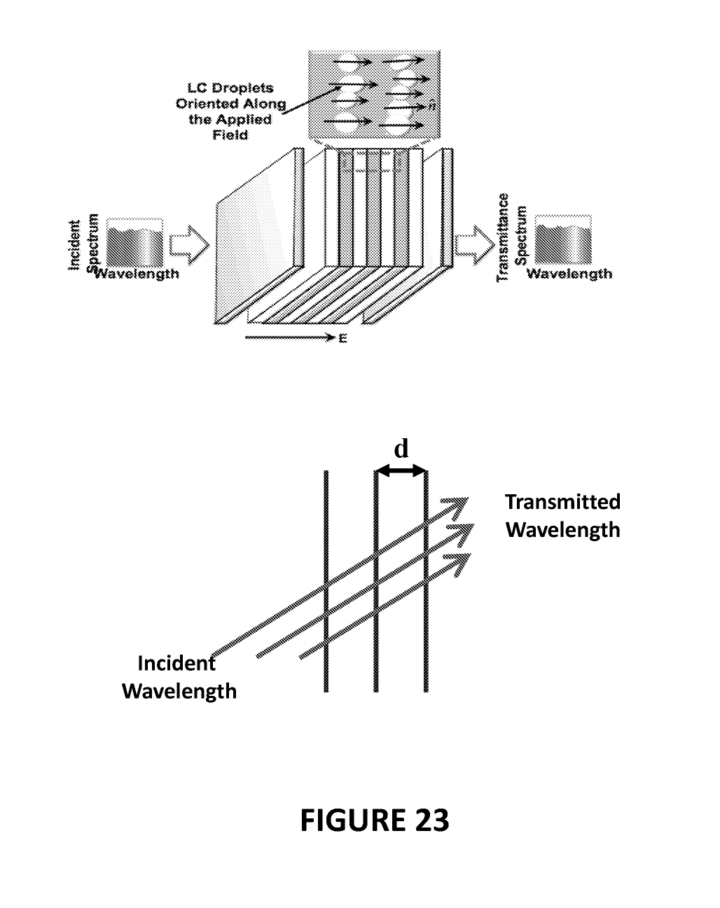

FIG. 22 depicts an example HPDLC tunable filter stack in an unswitched, reflective state. FIG. 23 depicts the example HPDLC tunable filter stack illustrated in FIG. 22 in a switched, transparent state.

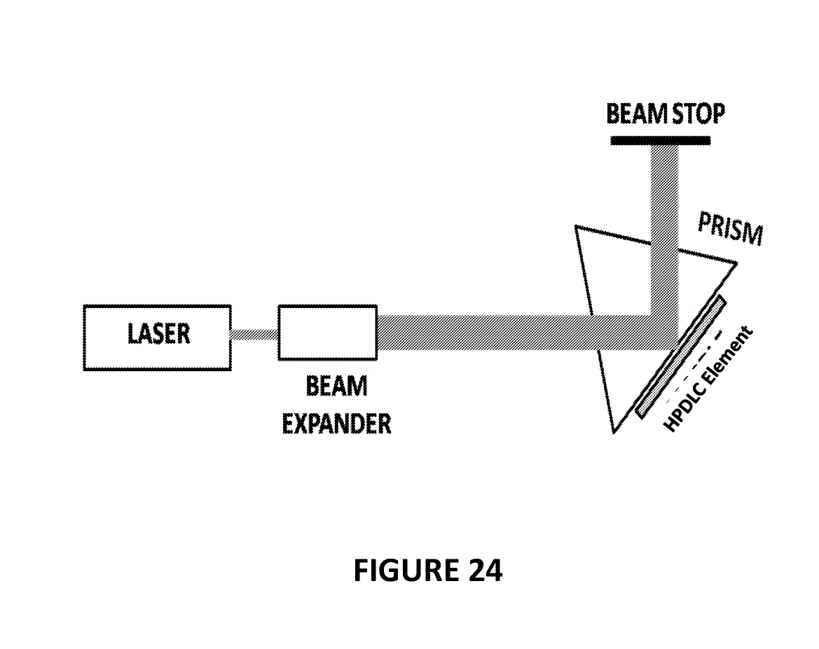

FIG. 24 depicts an example system and process for generating HPDLC films. In an example embodiment utilizing the illustrated system, an HPDLC film may be created by starting with a homogeneous mixture of photosensitive monomer and micron sized LC droplets. The mixture may be exposed to an interference pattern, for instance a holographic interference pattern generated by directing light from a source onto a prism, and subsequently onto an HPDLC element. The light can be collimated (e.g., with a focus at infinity). In accordance with the illustrated embodiment, the light source may be a laser light emitter. Characteristics of the beam of laser light may be tuned before the light reaches the HPDLC element, for example by passing the beam of light through a beam expander. While the HPDLC element is exposed to the interference pattern, LC droplets within the HPDLC element migrate to the low intensity regions of the interference pattern and photopolymerization of the monomer occurs in the high intensity regions of the interference pattern. The end result is a periodic structure of LC droplets and polymer layers. In their nominal state, the symmetry axis of the LC droplets are randomly oriented, which results in a refractive index mismatch between the LC layers and polymer layers, and creates a Distributed Bragg Grating Reflector (DBR). For normal incidence, the DBR reflects the Bragg wavelength, λ_{B},

λ_{B}=2nΛ, (1)

where n is the average refractive index of the grating and Λ is the grating period, while passing all other wavelengths. Upon application of a bias voltage, the LC droplets align along the direction of the field, resulting in a refractive index match with the adjacent polymer layer due to birefringence of the LC material. This disrupts the Bragg condition and results in transmission of the Bragg wavelength along with all other wavelengths. The reflectivity, R, of the DBR is a function of the number of layers and refractive index difference,

$$R = {[ \frac{{n}_{0} {n}_{2}^{( 2 N )} - {n}_{s} {n}_{1}^{( 2 N )}}{{n}_{0} {n}_{2}^{( 2 N )} + {n}_{s} {n}_{1}^{( 2 N )}} ]}^{2} \qquad ( 2 )$$

where n₀, n₁, n₂, and nₛ are the respective refractive indices of the surrounding medium, the alternating layers, and the substrate material, and N is the number of layers. The bandwidth (passband) of the DBR is a function of the refractive index difference,

$$Δλ = \frac{4 {λ}_{B}}{π} \cdot {sin}^{- 1} ( \frac{{n}_{2} - {n}_{1}}{{n}_{2} + {n}_{1}} ) \qquad ( 3 )$$

An HPDLC filter can be constructed by stacking a plurality of HPDLC elements, such as HPDLC films, each HPDLC element individually written to reflect a different Bragg wavelength across the desired operating waveband band. By disposing HPDLC elements adjacent to one another in the stack, for example in ascending order of Bragg wavelength, it is possible to construct an HPDLC filter through which no light will be transmitted, across the passband, in the nominal state (i.e., when no bias voltage is applied to the filter), since each HPDLC element will selectively reflect a given portion of the wavelength range. Biasing an individual HPDLC element within the stack, for example by applying an appropriate voltage, will result in transmission of the Bragg wavelength for that HPDLC element. Accordingly, an HPDLC filter constructed as described herein can be selectively tuned to pass at least one, such as a plurality of individual wavelengths, for example through the simultaneous application of voltages to respective ones of the HPDLC elements of the stack.

The small size of the LC droplets enables the HPDLC elements of the HPDLC filter stack to exhibit rapid switching response times, for example between the reflective and transparent states, for example, approaching 20 μs. Rapid switching response times allows imaging data collected through the HPDLC elements of the HPDLC filter to be spectrally multiplexed, or information to be collected for all the individuals wavelengths simultaneously (in parallel). These effects can be achieved by modulating each HPDLC element layer at a slightly different frequency and then synchronously detecting each information component. Alternatively, the detected waveform can be digitized and Fourier transformed (FFT) to retrieve the spectra, which can be more efficient for a system with a large number of HPDLC elements.

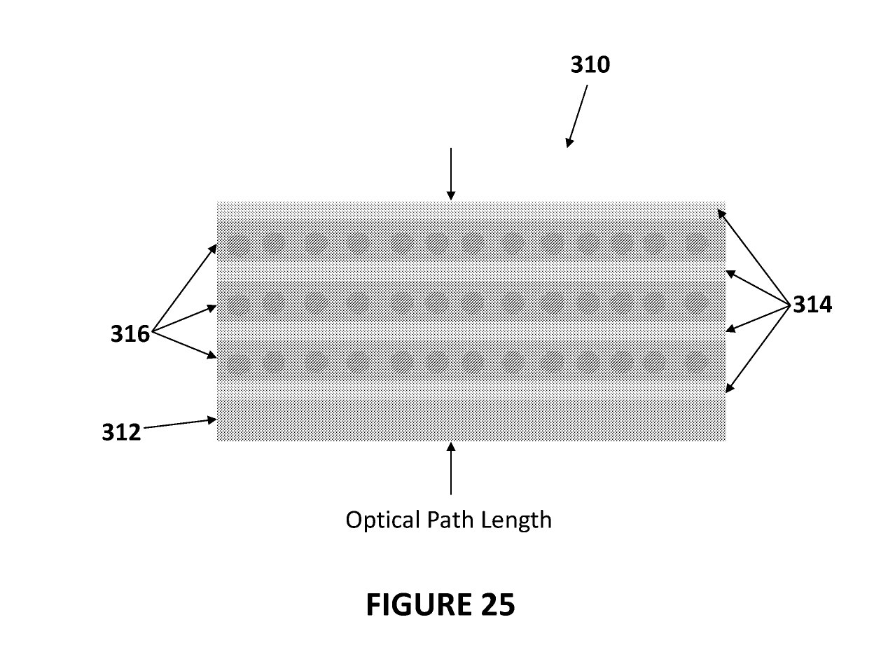

FIG. 25 depicts an example HPDLC tunable filter stack 310. In the example configuration depicted in FIG. 25, the HPDLC tunable filter stack 310 may comprise a single glass substrate 312 and alternating conductive layers 14 and holographic polymer dispersed liquid crystal layers 316. The optical path length of the HPDLC tunable filter stack 310 is dramatically reduced relative to known HPDLC element stacks that comprise substrates sandwiching each respective HPDLC element because only one substrate 12 is used as a stage to support multiple HPDLC elements. The number of discrete HPDLC elements that comprise the stack 310 may be an appropriate number. For example, in an example configuration, the number of HPDLC elements may be equal to or greater than 340.

In order to effectuate transfer of an HPDLC medium by releasing a glass substrate from an HPDLC sample, thereby facilitating grating surface metrology, the surfaces of the glass substrates are treated prior to holographic exposure with a release agent (e.g., surfactants such as Tween and Brix). Treatment with a release agent facilitates complete removal of an HPDLC medium. Following holographic exposure, one glass substrate may be released from the HPDLC medium and HPDLC medium removed. The grating film may then be adhered to an index-matched polymeric substrate coated with an index-matched conducting substrate using the same polymer employed in the grating matrix of the HPDLC medium (e.g., acrylated urethane). An example substrate suited for this purpose is poly-methyl-meth-acrylate (PMMA) coated with Baytron-P conducting polymer, but other substrates may be used. The remaining glass substrate may then be similarly replaced with a second polymeric substrate. If this process is repeated, an index matched completely polymeric HPDLC medium stack may be formed. In an example process, hardening polymers (e.g., Norland Optical Adhesive 63 and/or 68) may be added to the pre-polymer mixture, to increase the toughness of the resulting HPDLC medium.

HPDLC mediums formed using the methods and apparatus disclosed herein often may demonstrate reflection efficiencies of 85-90%, switching fields of approximately 15-20 V/μm, and switching times less than 20 μs. Scattering intensities are typically less than 1×10⁻⁷ dB outside the grating reflection peak. Wavelength shifts are typically less than 0.005λ, which may be measured using, for example, a Zygo white light interferometer.

Various grating characteristics of HPDLC mediums may be analyzed to optimize performance. For example, the uniformity of the wavelength reflection peak can be determined. The exposed HPDLC medium may be analyzed using a spectra-radiometer to measure reflection properties of the gratings in multiple locations to ensure uniformity in the exposure process. Other parameters to be examined within each measurement may include wavelength peak, reflection intensity, spatial uniformity, and the like. In another example, the wavefront may be analyzed. Maintaining the wavefront properties of individual wave packets as they interact with the reflecting film ensures accurate measurement at the detector. In yet another example, HPDLC mediums may be examined using a white light interferometer, for example, to measure scatter. Scattering of reflected and transmitted light may result in stray measurements and noise at the detector. This scattering effect may be characterized and compared to scatter effects from existing reflective technologies in order to mitigate or minimize the effect. In yet another example, electro-optic switching properties of an HPDLC medium can be analyzed. This may be accomplished with the use of a spectra-radiometer and high-voltage (e.g., ˜100V pp) switching setup, for example. When a high-frequency (e.g., 1 kHz) oscillating wave is applied to an HPDLC medium, the liquid crystal droplets align, effectively ‘washing out’ the Bragg grating. This enables partial switching of the entire grating, which can be used to ‘grayscale’ or vary the intensity of the grating. An HPDLC medium may be analyzed for uniformity in color purity, intensity, focal length and direction, and polarization during dynamic switching and grayscale switching.

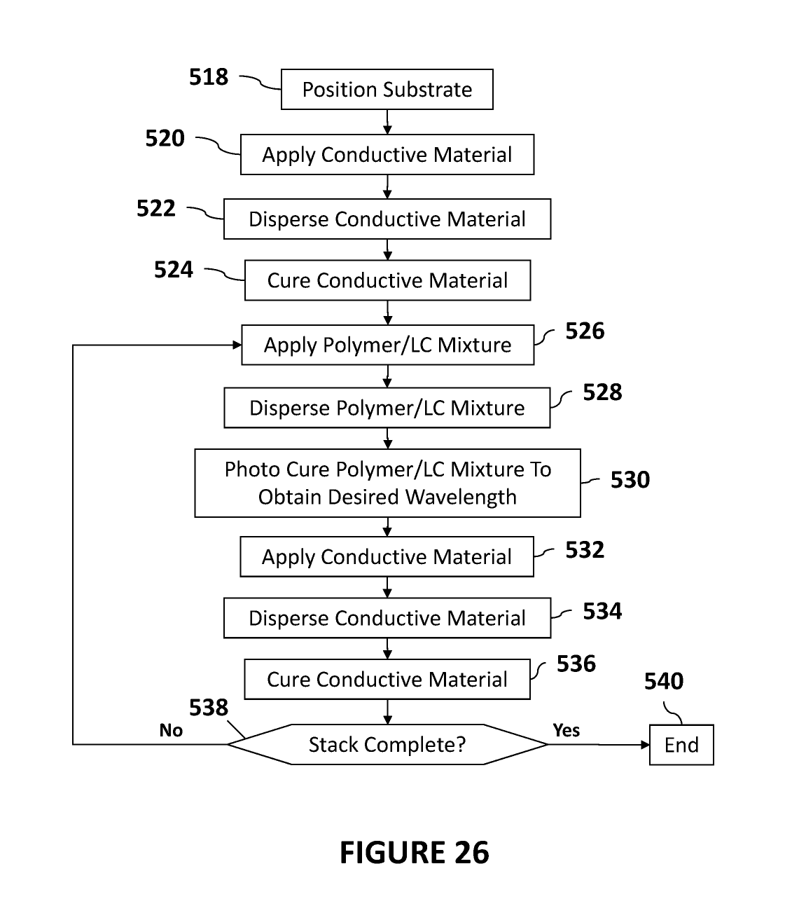

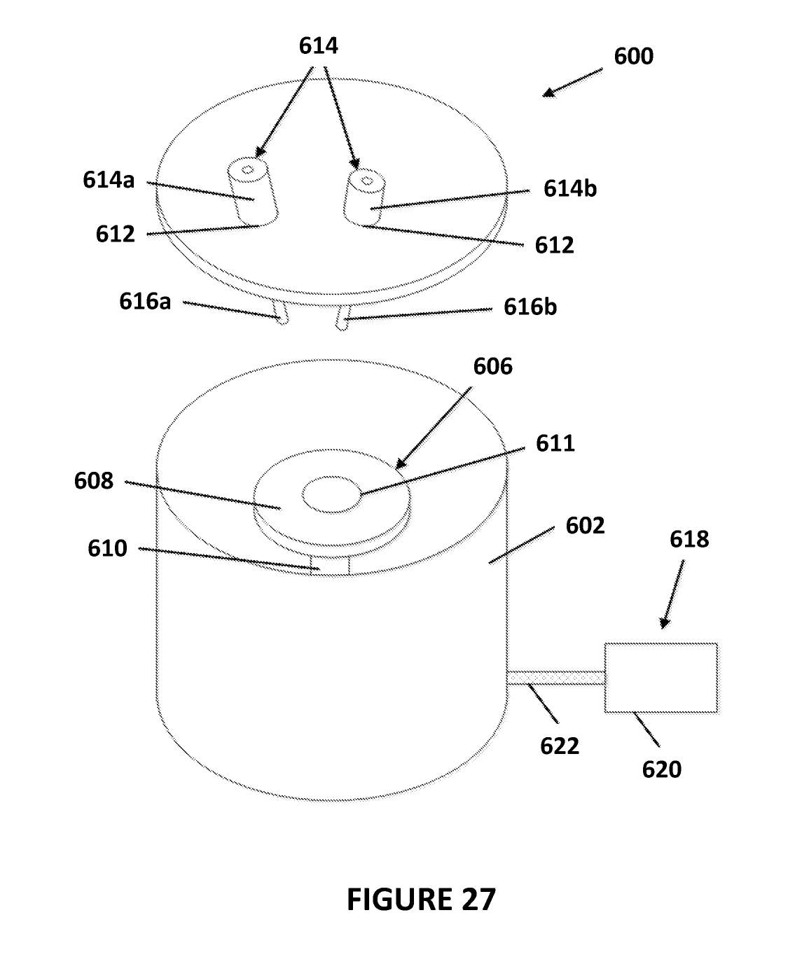

FIG. 26 illustrates an example flow diagram for fabricating an HPDLC element stack. FIG. 27 illustrates an example spin coating apparatus 200 that can be utilized to fabricate an HPDLC element stack. Reference is made below of performing various steps of the fabrication method illustrated in FIG. 26 utilizing components of the spin coating apparatus 600 depicted in FIG. 27. However, it should be appreciated that fabrication of the HPDLC tunable filter via the steps of illustrated in FIG. 26 need not be carried out utilizing the spin coating apparatus 600, and that the HPDLC tunable filter may alternatively be fabricated via the steps of illustrated in FIG. 26 and using any other suitable fabrications apparatus.

The illustrated spin coating apparatus, or spin coating system 600 may comprise a vessel 602 having a detachable lid 604. The illustrated lid 604 is removable from the vessel 202, but could be alternatively configured as a lid 604 that is openable and closeable relative to the vessel 602, for example by hinging the lid 604 with respect to the opening at the top of the vessel 602. It should be appreciated that the spin coating system 600 is not limited to the illustrated cylindrically shaped vessel 602 and lid 604, and that the vessel 602 and lid 604 can be alternatively constructed defining any other suitable geometry as desired.

One or more additional components of the spin coating system 600 can be disposed within the vessel 602. For instance, the illustrated spin coating system 600 further comprises a rotatable stage 606 configured to be disposed into the vessel 602. In accordance with the illustrated embodiment, the stage 606 comprises a cylindrical platform 608 that is configured to have a substrate, such as the substrate 612, releasably secured thereto. The platform 608 is supported by the upper end of a rotatable shaft 610. The lower end of the shaft 610 can be coupled to a source of rotational force, such as a motor which can be disposed into the vessel 202 or located externally from the vessel 602 and coupled to the shaft 610 via a mechanical linkage. The motor can transmit a rotational force to the shaft 610, which in turn transmits the rotational force to the platform 608, thus causing the stage 606 to rotate. The speed of rotation (e.g., the RPM) and/or the direction of rotation of the stage 606 can be controlled, for instance via a motor speed control manually operated by a user of the spin coating system 600, electronically controlled, for instance by a software program, or by any combination thereof. In accordance with the illustrated embodiment, the stage 606 is substantially centered relative to the lower end of the vessel 602, but could be otherwise located within the vessel 202 as desired. The shaft 610 defines a height such that the platform 608 is accessible, for example to allow placement or removal of the substrate 312, when the lid 604 of the vessel is removed and/or open.

In accordance with the illustrated embodiment, the lid 604 defines at least one, such as a plurality of ports 612 extending therethrough. The lid 604 further comprises at least one, such as a plurality of dispensers 614, each dispenser 614 configured to be disposed within a corresponding one of the plurality of ports 612. Each of the dispensers 614 can be configured to dispense material into the vessel 602 and in particular onto the substrate 312. For instance, in accordance with the illustrated embodiment, a first dispenser 614a of the plurality can be configured to dispense the conductive polymer described elsewhere herein. A second dispenser 614b of the plurality can be configured to dispense the prepolymer mixture described elsewhere herein. The illustrated dispensers 614a, 614b, are disposed into corresponding ports 212 along respective trajectories that are offset with respect to the axis of rotation of the stage 208, such that respective tip 616a, 616b of each dispenser 614a, 614b, is disposed above substantially the center of the substrate 312. The dispensers 614a, 614b can be configured to dispense pre-determined amounts of their respective materials at pre-determined intervals, as described in more detail below. It should be appreciated that the spin coating system 600 is not limited to the illustrated number and/or placement of dispensers 614, and that the spin coating system 600 can alternatively be provided with any number and/or configuration of dispensers 614 as desired.

The spin coating system 600 can further comprise a light emitting assembly 618. Although the illustrated light emitting assembly 618 comprises a laser light emitter 620 configured to emit a laser beam 622, it should be appreciated that the light emitting assembly 618 can further comprise one or more devices configured to modify characteristics of the laser beam 622, such as beam expanders, lenses, beam splitters, or the like. It should be appreciated that the spin coating system 600 is not limited to a single light source as illustrated, and a plurality of light emitting assemblies 618 can be provided, as desired.

In accordance with the illustrated embodiment, the light emitting assembly 618 can be provided separate from the vessel 602, such that the beam 622 emitted by the light emitting assembly 218 is directed into an aperture extending into the vessel 602. Alternatively, the light emitting assembly 218 can be integral with the vessel 602 or the lid 604, as desired. In accordance with the illustrated embodiment, the laser beam 622 is redirected within the vessel, for example via the use of mirrors, beams splitters, or the like, such that the beam 622 is incident upon a prism, thereby creating an interference pattern to be created within material (e.g., prepolymer mixture) dispersed on the substrate 312, so as to form Bragg gratings, for example as described above.

Referring now to FIGS. 25, 26, and 27, at step 518, a substrate 212 may be positioned. The substrate 312 may be positioned in any appropriate mechanism for fabricating the HPDLC tunable filter stack. For example, in accordance with the illustrated embodiment, the substrate 312 may be secured to the upper surface of the platform 608. The substrate 212 may comprise any appropriate material. For instance the substrate 312 may comprise glass, such as a 3 mm thick glass slide. At step 520, a layer of conductive material (e.g., conductive layer 314) may be applied to the exposed surface of the substrate 312, for example by dispensing the conductive material from dispenser 614a. The conductive layer may comprise any appropriate material. For example, the conductive layer can comprise a conductive polymer. Example conductive polymers include PEDOT:PTS and PDOT:PSS.

At step 522, the conductive layer may be dispersed along the exposed, or upper surface of the substrate 312. For example, a portion of conductive material dispensed onto the substrate 312 by the dispenser 614a can be caused to disperse by applying a rotational force to the substrate 312. That is, the conductive material can be dispersed along the upper surface of the substrate 312 by rotating, or spinning the stage 608 at an appropriate speed. The rotational force can be applied to the substrate 312 by applying a rotational force to the stage 608, which in turn imparts the rotational force to the substrate 312 secured to the stage 608.

It may desirable to vary the speed of rotation of the stage 608 during dispersal of the conductive material. For example, the stage 608 may be rotated at a first speed for a first interval of time, and rotated at a second speed for a second interval of time. The stage 608 can initially be rotated at a first pre-determined speed to cause an initial dispersal rate of the conductive material along the surface of the substrate 312. As the conductive material spreads radially further from the center of the substrate 312, the speed of rotation of the stage 608 can be increased, for instance to the second speed, to ensure that the conductive material continues to disperse at an even rate over the surface of the substrate 312, thereby ensuring a conductive material layer of substantially uniform thickness along the exposed surface of the substrate 312. In other words, the stage 608 can be rotated at a first speed for a first interval of time and at a second speed for a second interval of time. Alternatively, the speed at which the stage 208 is rotated can be uniform or varied between a first speed that is faster than a second speed, or the stage 608 can be rotated at more than two discrete speeds, such as three speeds, etc.

In an example embodiment, dispenser 614a may be configured to dispense a quantity of conductive material sufficient to be spun to an approximately 200 nm thick layer. Alternatively the conductive material may be applied to the substrate 312 and allowed to disperse on its own, without spinning the stage 608. At step 524, the conductive layer may be cured. The conductive layer may be cured in any appropriate manner. For example, the conductive layer may be heated, the conductive layer may be allowed to evaporate on the exposed surface, the conductive layer may undergo controlled evaporation in a gas evaporation chamber, or the like. The stage 608 can come to rest during curing of the conductive layer, for example through application of a braking force counter to the direction of rotation, or by allowing the stage 608 to come to rest after ceasing application of the rotational force to the stage 608. Alternatively, application of the rotational force to the stage 608 can be maintained during curing of the conductive layer.

At step 526, a material comprising a prepolymer mixed with liquid crystals (e.g., the prepolymer mixture that, upon exposure, becomes holographic polymer dispersed liquid crystal layer 316) may be applied to the exposed surface of the conductive layer (e.g., conductive layer 314), for example by dispensing the conductive material from dispenser 614b. At step 528, the prepolymer mixture is dispersed along the conductive layer. For example, a portion of prepolymer mixture dispensed onto the substrate 312 by the dispenser 614b can be caused to disperse by applying a rotational force to the substrate 608. That is, the conductive material can be dispersed along the upper surface of the substrate 312 by rotating, or spinning the stage 608 at an appropriate speed. The rotational force can be applied to the substrate 312 by applying a rotational force to the stage 608, which in turn imparts the rotational force to the substrate 312 secured to the stage 608. This second rotational force applied to the stage 608 to disperse the prepolymer mixture can be of the same or different magnitude as the first rotational force applied to the stage 608 at step 522 to cause dispersal of the conductive material.

The speed of rotation of the stage 608 may be varied during dispersal of the prepolymer mixture. For example, the stage 608 may be rotated at a first speed for a first interval of time, and rotated at a second speed for a second interval of time. The stage 608 can initially be rotated at a first pre-determined speed to cause an initial dispersal rate of the prepolymer mixture along the surface of the conductive material layer. As the prepolymer mixture spreads radially further from the center of conductive material layer, the speed of rotation of the stage 608 can be increased, for instance to the second speed, to ensure that the prepolymer mixture continues to disperse at an even rate over the surface of the conductive material layer, thereby ensuring a prepolymer mixture layer of substantially uniform thickness along the exposed surface of the conductive material layer. In other words, the stage 208 can be rotated at a first speed for a first interval of time and at a second speed for a second interval of time. Alternatively, the speed at which the stage 608 is rotated can be uniform or varied between a first speed that is faster than a second speed, or the stage 208 can be rotated at more than two discrete speeds, such as three speeds, etc. The prepolymer mixture can thus be spun to form a coating of a polymer/LC, mixture material on the previous layer (e.g., the previously formed conductive layer 14). In an example embodiment, dispenser 614b can be configured to dispense a quantity of prepolymer mixture sufficient to be spun to an approximately 20 micron thick layer. Alternatively, the prepolymer mixture can be applied and allowed to spread on its own, without spinning the stage 608. As describe above, the stage 608 can come to rest between application of the first and second rotational forces.

At step 530, the prepolymer mixture may be cured to form a polymer layer. For example, the prepolymer mixture may be exposed to a holographic interference pattern and photo-cured, as described above, to obtain an HPDLC element having the aforementioned optical properties associated with a specific wavelength. That is, exposure to the holographic interference pattern can cause a grating structure that reflects a particular wavelength, such as a Bragg grating, to be formed in the mixture (i.e., in the polymer layer). In accordance with the illustrated embodiment, the stage 608 is static during the curing process. Alternatively, the stage could continue spinning, and the interference pattern dynamically varied in accordance with creating the desired Bragg grating in the cured polymer layer.

At step 532, an additional layer of conductive material (e.g., conductive layer 14) can be applied to the exposed surface of the cured polymer layer (the mixture), such that the grating structure formed in the polymer layer may be coated with the conductive material, such that an electric field (E-field) can be applied to the polymer layer. The additional, or second layer of conductive material may be applied as described above with reference to step 520. At step 534, the second layer of conductive material may be dispersed along the cured polymer layer, for example by applying a third rotational force to the stage 608 (spinning the stage 608) as described above with reference to step 522. At step 536, the dispersed additional layer of conductive material may be cured, for instance as described above with reference to step 524.

At step 538, it can be determined whether the HPDLC element stack is complete, that is if the HPDLC element stack comprises the desired number of alternating conductive and polymer layers. If, at step 538, it is determined that the HPDLC element stack is complete, the process may end at step 540, and a second substrate, such as a glass slide, may be affixed to the exposed layer of the HPDLC stack. If, at step 538, it is determined that the HPDLC element stack is not complete, the process may proceed to step 526 to fabricate additional conductive and polymer layers. By repeating steps 526 to 536, an HPDLC tunable filter may be fabricated. The characteristics of the resulting HPDLC tunable filter, for instance the spectrum of wavelengths that can be reflected by the filter, may be configured by exposing each polymer layer with an interference patterns designed to create an appropriate Bragg grating, during photocuring of each polymer layer, respectively.

The resulting HPDLC tunable filter may comprise an HPDLC tunable filter stack, more specifically a stack of HPDLC thin film filter elements. The HPDLC tunable filter stack may comprise alternating conducting and polymer layers, such that a first HPDLC thin film filter element abuts a first surface of an intervening conductive layer and a second HPDLC thin film filter element abuts an opposed second surface of the intervening conductive layer. The HPDLC thin film filter elements at opposed upper and lower ends of the stack can be disposed adjacent respective glass substrates, as described elsewhere herein, such that each HPDLC thin film filter element of the stack abuts a surface of a conductive element (e.g., a layer of conductive material) disposed adjacent to the HPDLC thin film filter element within the stack. Thus, the HPDLC tunable filter stack can comprise a stack of HPDLC tunable filter thin films and conductive elements.

Although the aforementioned fabrication techniques include spin coating and natural evaporation, it is to be understood that other appropriate fabrication techniques may be utilized. For example, a Langmuir trough may be utilized to fabricate films for the HPDLC tunable filter stack.

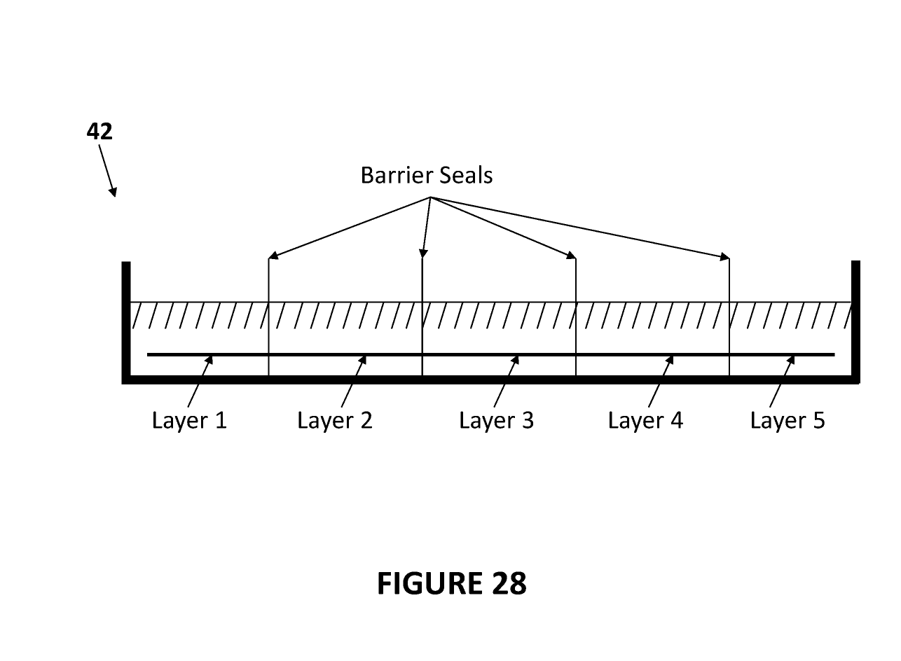

It should be appreciated that the herein described HPDLC element stacks need not be created using the above described spin coating techniques, and that the HPDLC element stacks can alternatively be fabricated using other suitable processes. For example, FIG. 28 depicts fabricating an HPDLC tunable filter stack using a Langmuir trough 42. Layers of an HPDLC tunable filter stack to be fabricated, depicted as layer 1, layer 2, layer 3, layer 4, and layer 5, in FIG. 28, can be fabricated individually. Each layer fabrication compartment, confined by the barrier seals (and the edge of the Langmuir trough for the end compartments), can be used to fabricate a desired type of layer. For example, the layer fabrication compartment in which layer 1 is placed can be filled with the appropriate conductive material and allowed to evaporate. The layer fabrication compartment in which layer 2 is placed can be filled with the appropriate polymer/LC mixture material and allowed to evaporate. The layer fabrication compartment in which layer 3 is placed can be filled with the conductive material and allowed to evaporate. The layer fabrication compartment in which layer 4 is placed can be filled with the appropriate polymer/LC mixture material and allowed to evaporate. And the layer fabrication compartment in which layer 5 is placed can be filled with the conductive material and allowed to evaporate. The appropriate polymer/LC mixture material layers can be exposed to respective interference patterns and optically cured to obtain respective desired Bragg gratings, and the resulting conductive and cured polymer layers can be positioned on a glass substrate to form an HPDLC tunable filter stack. For example, the layer sections can be folded to form a layered stack comprising alternate conductive layers and HPDLC layers, and can be placed on a glass substrate to form an HPDLC tunable filter stack.

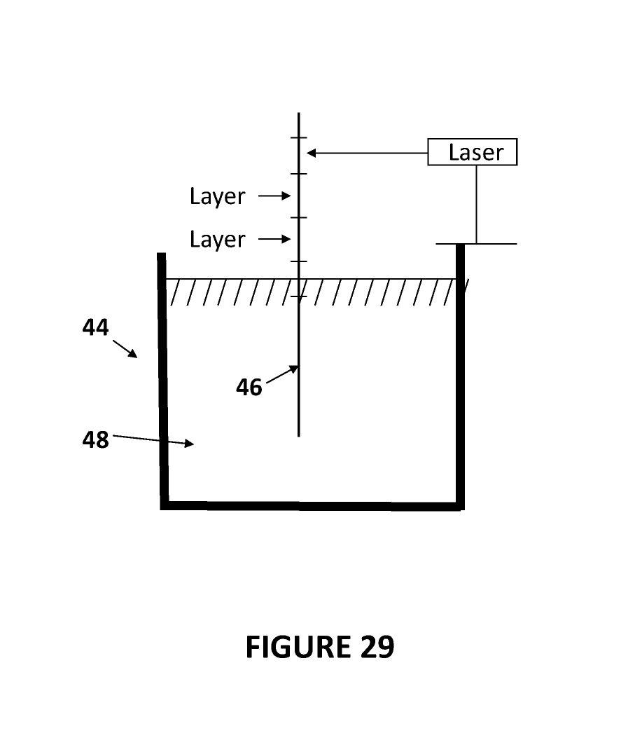

FIG. 29 depicts an alternative example of fabricating an HPDLC tunable filter stack using a Langmuir trough 44. The Langmuir trough may be filled with an appropriate polymer/LC mixture material 48. A conductive layer 46 can be pulled through the material 48. As the conductive layer 46 is being pulled from the material 48, individual layer sections can be optically cured (as depicted by the laser in FIG. 29) to achieve a desired Bragg wavelength. For example, alternate layer sections can be optically cured. Upon completion of the optical curing of the desired number of layer sections, the layer sections can be folded to form a layered stack comprising alternate conductive layers and HPDLC layers, and can be placed on a glass substrate to form an HPDLC tunable filter stack.

Electrical and/or optical characteristics of HPDLC elements may be at least partially determined based upon, for example, the composition of the prepolymer mixture, the conductive polymer used in between polymer layers, and/or the equipment and techniques employed during fabrication of the HPDLC elements. For example, 30 to 50 mm clear aperture HPDLC elements exhibiting uniform reflection efficiency across the aperture area can be fabricated by passing the laser beam through a high power pinhole to achieve flat wavefronts and by expanding the beam width to 50 mm using a high power beam expander. A high power single mode 533 nm laser with a peak tunable output of 10 W may be used as a source to achieve a uniform illumination of 200 mW/cm² across the aperture since the photo-polymerization of HPDLC may be sensitive to gradients. The total internal reflection phenomenon from a prism may be the source of an interference pattern which can be recorded in the HPDLC element. Changing the angle of incidence of the beam on the prism enables fabrication of HPDLC elements configured to reflect at various wavelengths. HPDLC elements capable of reflecting in the range of 400 nm to 600 nm can be fabricated using a high power continuous wave (CW) laser radiating at 355 nm and HPDLC elements capable of reflecting in the range 600 nm to 800 nm can be fabricated using a high power CW laser radiating at 533 nm.

Further, HPDLC elements exhibiting reflection efficiencies 70% and beyond, and exhibiting minimized band scattering, may be fabricated. In an example embodiment, a reduction in off band scattering may be achieved by increasing reflection efficiency. For example, introducing a high dielectric anisotropy MLC 6240 000 (Δ∈=35, γ=65 cp) into the BL038 (Δ∈=16.9, γ=72 cp) LC system that phase separates into the LC rich regions forming smaller droplets than the critical size of scattering can in turn improve the reflection efficiency by increasing the index modulation between the LC rich and polymer rich regions. The reflection efficiency is given by:

$$η = \frac{{\vert κ \vert}^{2} {sinh}^{2} ( sL )}{{s}^{2} {cosh}^{2} ( sL ) + ( \frac{Δβ}{2} ) {sinh}^{2} ( sL )} \qquad ( 4 )$$

In the above equation (4) since efficiency is proportional to

$$κ = \frac{2 π {n}_{1} {n}_{o} Λ}{{λ}^{2}} , \qquad ( 5 )$$

incrementing ∈ in n₁=√∈μ directly improves the reflection efficiency.

Additionally, reflection efficiency band scattering can be improved by fabricating a combination of alternating pure LC and polymer layers and HPDLC while maintaining polarization insensitivity using the aforementioned fabrication technique.

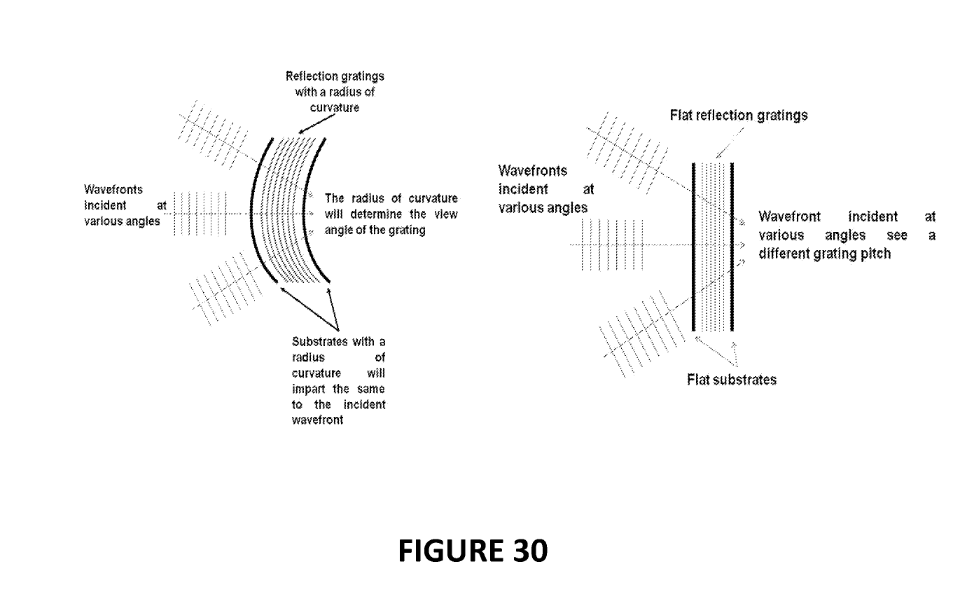

Various techniques may enhance the viewing angle of HPDLC elements and mitigate blue shift in the reflected wavelength observed at angles of incidence other than normal to the grating vector. For example, as depicted in FIG. 30, this limitation may bypassed by adding a curvature to the grating, where the degree of curvature controls the view angle of the HPDLC element. This technique is akin to concentric spheres where the distance between the surfaces of two consecutive spheres is equivalent to the grating pitch and the light incident from any direction on such a structure sees a constant grating pitch rather than a variable one as in case of conventional gratings. Fabricating HPDLC elements using curved substrates can help to impart the grating curvature to the incident wavefront, and thus minimize any path length mismatch.

Switching response times and/or the switching voltage of HPDLC elements may be reduced by improving the electro-optic properties of the polymer layers of HPDLC elements, for instance by introducing dopants into the prepolymer mixture. For example, in an example embodiment, switching times may be reduced and response times may be reduced by adding predetermined amounts of carbon based nanoparticles, such as, for example, alliform carbon particles, carbon onions, or the like, or any appropriate combination thereof, to the HPDLC prepolymer mixture before hologram recording. During the process of phase separation carbon based nanoparticles may become trapped in the polymer matrix and act as physical barriers to the counter diffusing LC's, preventing coalesce, thereby reducing the droplet size, and imparting conductivity to the polymer matrix. The equation below explains the reduction in switching voltage.

$${V}_{c} = \frac{{d}_{o}}{3 a} ( \frac{{σ}_{LC}}{{σ}_{polymer + mwnt}} + 2 ) {( \frac{K ( {1}^{2} + 1 )}{{ɛ}_{o} Δɛ} )}^{1 / 2} \qquad ( 6 )$$

A change in conductivity enhances the E-field across the LC droplet in accordance with:

$${E}_{LC} = {E}_{appl} ( \frac{3 {σ}_{polumer + mwnt}}{2 {σ}_{polumer + mwnt} + {σ}_{LC}} ) \qquad ( 7 )$$

As used herein, the term “alliform carbon particles” refers to substantially spherical or quasi-spherical carbon nanoparticles comprising at least one concentric external graphitic shell, but generally more than one such external shell, resembling the concentric shells of an onion (the term “alliform” derived from “allium” meaning onion). Particles described as “carbon onions” or “onion-like carbon” particles, in many respects, may be related to these alliform carbon particles, but these terms are normally associated with particles having multiple concentric shells. The external graphitic shell or shells of alliform carbon may have surfaces wherein at least 25%, or at least 50%, or at least 75% of their area comprise sp² carbon. The term “substantially spherical” relates to the shape being without near-sized appendages (i.e., having appendages such as carbon nanotubes) which substantially interfere with their ability to organize into packed matrices. To the extent that a given particle or population of particles deviates from a purely spherical shape, such that each particle As used herein, the term “alliform carbon particles” refers to substantially spherical or quasi-spherical carbon nanoparticles comprising at least one concentric external graphitic shell, but generally more than one such external shell, resembling the concentric shells of an onion (the term “alliform” derived from “allium” meaning onion). In fact, particles described as “carbon onions” or “onion-like carbon” particles, in many respects, are related to these alliform carbon particles, but these terms are normally associated with particles having multiple concentric shells. The external graphitic shell or shells of alliform carbon have surfaces wherein at least 25%, or at least 50%, or at least 75% of their area comprise sp² carbon. The term “substantially spherical” relates to the shape being without near-sized appendages (i.e., having appendages such as carbon nanotubes) which substantially interfere with their ability to organize into packed matrices. To the extent that a given particle or population of particles deviates from a purely spherical shape, such that each particle can be described as having a major and minor axis, the ratio of the lengths of the major and minor axis of each particle can be less than about 2, less than about 1.5, less than about 1.3, less than about 1.2, less than about 1.1, or less than about 1.05 or less than about 1.02. As used herein, where the particles are other than purely spherical, the term “mean diameter” refers to the arithmetic average of the lengths of the major and minor axes of the particles. Independent embodiments provide that the alliform carbon particles As used herein, the term “alliform carbon particles” refers to substantially spherical or quasi-spherical carbon nanoparticles comprising at least one concentric external graphitic shell, but generally more than one such external shell, resembling the concentric shells of an onion (the term “alliform” derived from “allium” meaning onion). In fact, particles described as “carbon onions” or “onion-like carbon” particles, in many respects, are related to these alliform carbon particles, but these terms are normally associated with particles having multiple concentric shells. The external graphitic shell or shells of alliform carbon As used herein, the term “alliform carbon particles” refers to substantially spherical or quasi-spherical carbon nanoparticles comprising at least one concentric external graphitic shell, but generally more than one such external shell, resembling the concentric shells of an onion (the term “alliform” derived from “allium” meaning onion). In fact, particles described as “carbon onions” or “onion-like carbon” particles, in many respects, are related to these alliform carbon particles, but these terms are normally associated with particles having multiple concentric shells. The external graphitic shell or shells of alliform carbon have surfaces wherein at least 25%, or at least 50%, or at least 75% of their area comprise sp² carbon. The term “substantially spherical” relates to the shape being without near-sized appendages (i.e., having appendages such as carbon nanotubes) which substantially interfere with their ability to organize into packed matrices. To the extent that a given particle or population of particles deviates from a purely spherical shape, such that each particle can be described as having a major and minor axis, the ratio of the lengths of the major and minor axis of each particle can be less than about 2, less than about 1.5, less than about 1.3, less than about 1.2, less than about 1.1, or less than about 1.05 or less than about 1.02. As used herein, where the particles are other than purely spherical, the term “mean diameter” refers to the arithmetic average of the lengths of the major and minor axes of the particles. Independent embodiments provide that the alliform carbon particles have a mean diameter in the range of about 2 nm to about 30 nm, in the range of about 2 to about 20 nm, in the range of about 2 to about 10 nm, and in the range of about 5 nm to about 10 nm; however, particles having mean diameters encompassing a larger range (i.e., 1 to about 50 nm) may also be acceptable. Described more generally, particles having a mean diameter range wherein the lower end of the range is independently about 1, 2, 4, 6, 10 or 20 nm and the upper end of the range is about 50, 40, 30, 25, 20, 15, or 10 nm are encompassed by this invention. These particle sizes and distributions are defined herein by TEM photomicrograph analysis. In this method, a predetermined number of particles (more than 100) are analyzed in representative transmission electron micrographs (typically derived from more than 3 randomly selected powder samples) by measuring the mean diameters of the particles, counting particles within a pre-determined size fraction gradient, and statistically correlating those numbers.

Given these diameters, alliform carbon particles may offer a moderate specific surface area as compared to activated carbons, but this surface is fully accessible to ion adsorption, in contrast to other commonly used nano- or microporous materials, where the large surface areas are made mainly by the nano- or micropores, which are inaccessible or only slowly accessible by ions. In an ideal case, they can be considered as multi-shell giant fullerenes, but the real particles may have discontinuous and defective shells when synthesised at temperatures below 1800° C., or polygonized shells when higher temperatures or longer times are used.

Various example embodiments of alliform carbon particles may have an example surface areas in the range of about 250 to about 750 m²g⁻¹, in the range of about 300 to about 700 m² g⁻¹, in the range of about 350 to about 650 m² g⁻¹, in the range of about 400 to about 600 m² g⁻¹, a specific surface area of about 500 m² g⁻¹, or the like.

Alliform carbon particles may be made in any appropriate manner. For example, alliform carbon particles may be made by chemical vapor deposition and spark ignition. In an example embodiment, the particles may be derived by annealing detonation nanodiamond powders. The method is inexpensive and may be used to synthesize large amounts of alliform carbon. See, for example, Kuznetsov, V. L. et al. Effect of explosion conditions on the structure of detonation soots: ultradisperse diamond and onion carbon. Carbon 32, 873-882 (1994), which is incorporated by reference herein for this purpose. Detonation nanodiamonds tend to be unimodal in particle size distribution and available (and so produce alliform carbon particles). In various embodiments, annealing may be done at, for example, temperatures in the range of about 1200° C. to about 2500° C., at temperatures in the range of about 1500° C. to about 2000° C., or at temperatures in the range of about 1800° C. to about 2000° C. The specific surface area, pore size, and pore size distribution appear to be nearly independent of annealing temperatures, at least over the ranges cited herein, but the electrical conductivity of the samples may increase with temperature.

Moreover, addition of optimal amounts of a conductive polymer such as the commercially available PEDOT:PSS, may reduce the switching voltages of HPDLC elements, and may improve the switching response of HPDLC elements in accordance with the above equations.

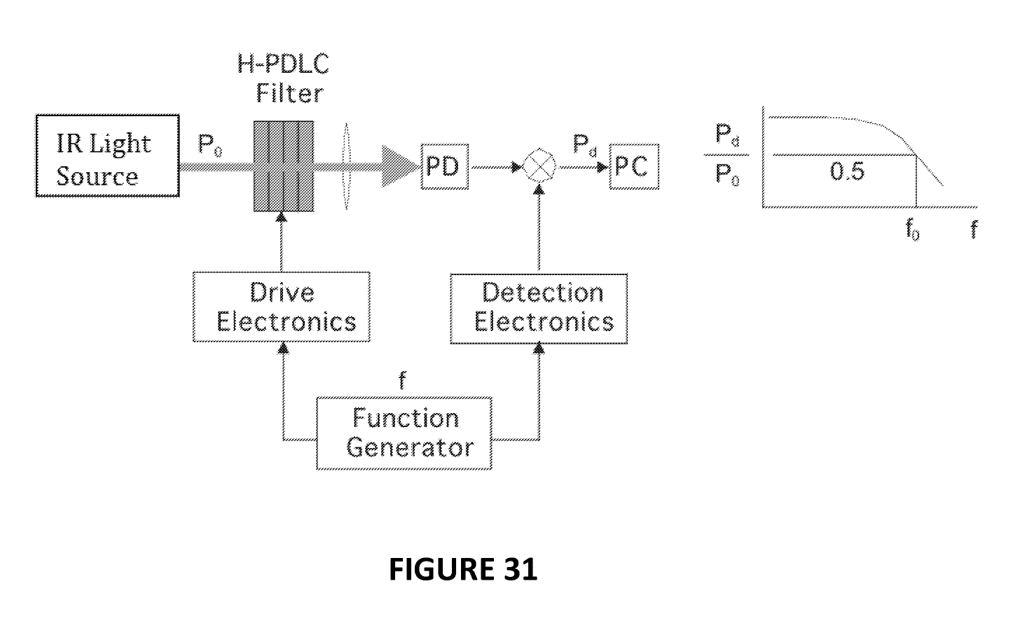

FIG. 31 illustrates and example system and process for measuring HPDLC filter response time, wherein PD represents a photodiode and PC represents a computer or the like. The frequency response of the system is a transfer function given by the magnitude of the output divided by the input. In an example embodiment, the frequency response of the HPDLC layer with a Bragg wavelength equal to the laser wavelength may be successively modulated at higher frequencies until the magnitude of the output signal is one half the nominal value, which is the open loop bandwidth of the filter. The frequency associated with the 3-dB down point (output is equal to one-half the input) may be used as the maximum bandwidth, f₀, of the system. The response time, τ, may be obtained from the bandwidth according to the following equation.

$$τ = \frac{1}{2 π {f}_{0}} .$$

The transmission also may be obtained by measuring the ratios of the detected powers with and without the filter placed in the laser beam path (at a frequency well within the bandwidth of the system).

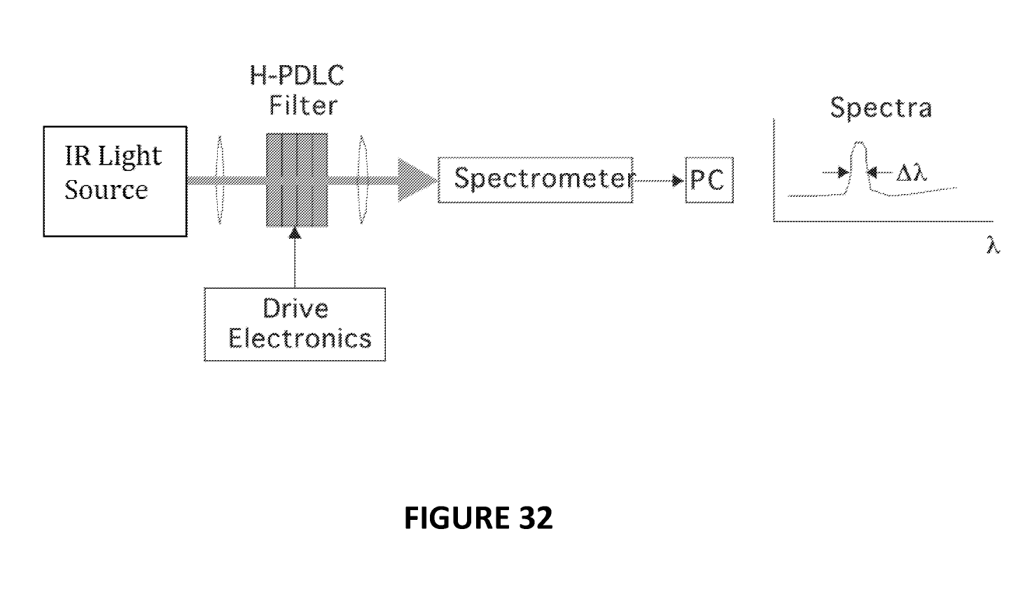

FIG. 32 illustrates an example system and method for obtaining filter wavelength range and resolution. A FTIR spectrometer may be used to generate the spectra. In an example embodiment, a white light source may collimated and passed through the HPDLC filter, wherein it may be sampled by a spectrometer. The resolution is measured by switching on a single layer to disrupt the Bragg condition and pass a small portion of the source energy. The wavelength range is obtained by measuring the width of the passband with all the filter layers in their nominal state (no bias voltage applied).

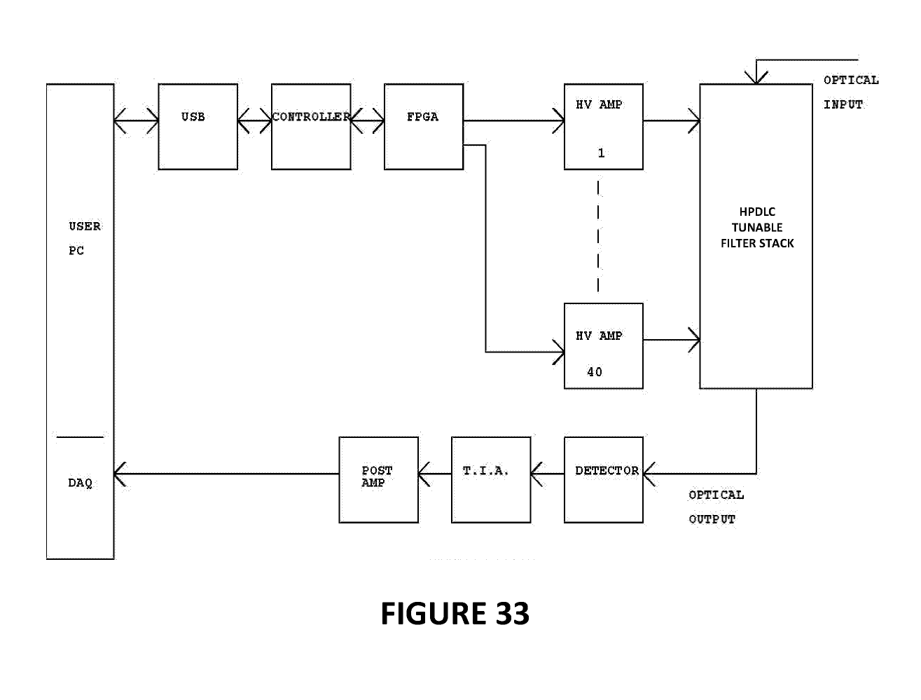

FIG. 33 is a block diagram of an example optical filter system into which an HPDLC tunable filter stack can be incorporated. In an example embodiment the system depicted in FIG. 33 may comprise four operating modes: unipolar mode (simultaneous mode), step mode, bipolar mode, and external mode. In unipolar mode, HPDLC element can be switched on and off at a unique frequency. Spectral amplitude data can be extracted from the detected digitized signal using a fast Fourier transform (FFT). In step mode, each HPDLC element can be switched on sequentially. Spectral amplitude can be extracted by storing the detected signal at the end of the on time pulse. The step pulse width can be determined by the optical filter characteristics. In an example configuration, the step pulse is 100 μs. In bipolar mode, an HPDLC element can be driven with a bipolar square wave, resulting in the HPDLC element being turned on continuously (DC). Detected data can be processed by averaging the digitized output. In the external mode all enabled HPDLC elements can be driven by an external frequency applied to a connector. Each of the HPDLC elements in the HPDLC tunable filter stack can have separate enable commands.

In an example embodiment, the controller depicted in the optical filter system shown in FIG. 33 may receive commands from and send data to a user pc via a USB port. The controller can reformat commands and send data to a field programmable gate array (FPGA). The controller can comprise any appropriate controller, such as a microcontroller design based on the TI TMS320F2812, for example.

The FPGA may receive commands from the controller, and send commands to at least one, such as a plurality of high voltage amplifiers. In the example system depicted in FIG. 33, there are 40 high voltage amplifiers corresponding, respectively, to 40 HPDLC elements. A high frequency clock can be divided to create forty unique frequencies for the unipolar mode. The frequency values can be determined by system analysis. In an example configuration, the FPGA generates ten frequencies between 1 kHz and 2 kHz. A parallel bus can be used to receive commands from, and send data to the controller.

A data acquisition card can be used to acquire an analog signal from an amplified silicon photodiode and to extract spectral data using various techniques such as fast Fourier transform for the unipolar mode, or sample and hold for the step mode. A camera can be used for hyperspectral imaging. The image acquisition scheme can comprise any appropriate image acquisition scheme, such as Firewire or USB2 interface, for example.

In an example configuration, the high voltage amplifiers can drive the HPDLC elements (i.e., optical filters) with square waves of 0 to HV (unipolar and step modes), or +/−HV square waves (bipolar mode). The value of HV can be determined by the filter characteristics, and, in an example configuration is about 150 volts. In another example configuration, the amplifier can be replicated in an application specific integrated circuit (ASIC). An ASIC with at least 10 amplifier circuits can meet the long term goal of a compact instrument. The design can use high voltage switching transistors and resistors. Switching voltage can be determined by the high voltage power supply.

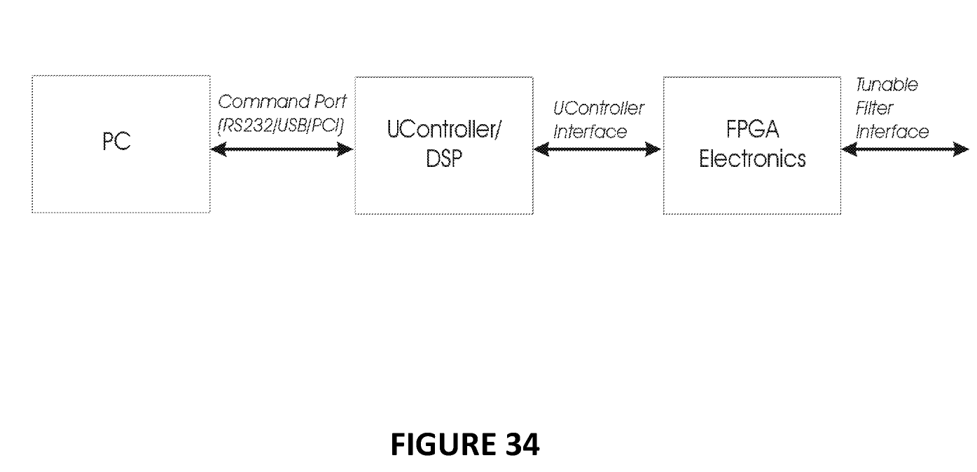

A processing architecture of the system can accept system control commands from a PC compatible interface (RS232, PCI, or USB) and can accomplish those commands via an FPGA-controlled HPDLC tunable filter stack. The commands can select the mode of operation (e.g., simultaneous, step, bipolar, or external) and/or which filter, filters, or filter ranges to enable in each mode. An example processing architecture comprises a Texas Instruments TMS320F2812 microController/DSP, as illustrated in FIG. 34. The TMS320F2812 DSP has 32-bit, fixed-point DSP core, up to 150 MIPS operation (millions of instructions per seconds), 1.9V core and 3.3V peripherals, a complete software development package, a C Compiler/Assembler/Linker, real-time debugging, 128 Kbytes of Flash for embedded autonomous operation, 16 Kbytes of RAM for fast execution speeds, standard UART serial port interface for PC communication, 56 Programmable I/O lines for user-defined I/O control/status, and 16 channel, 12.5 MHz A/D data acquisition capability.

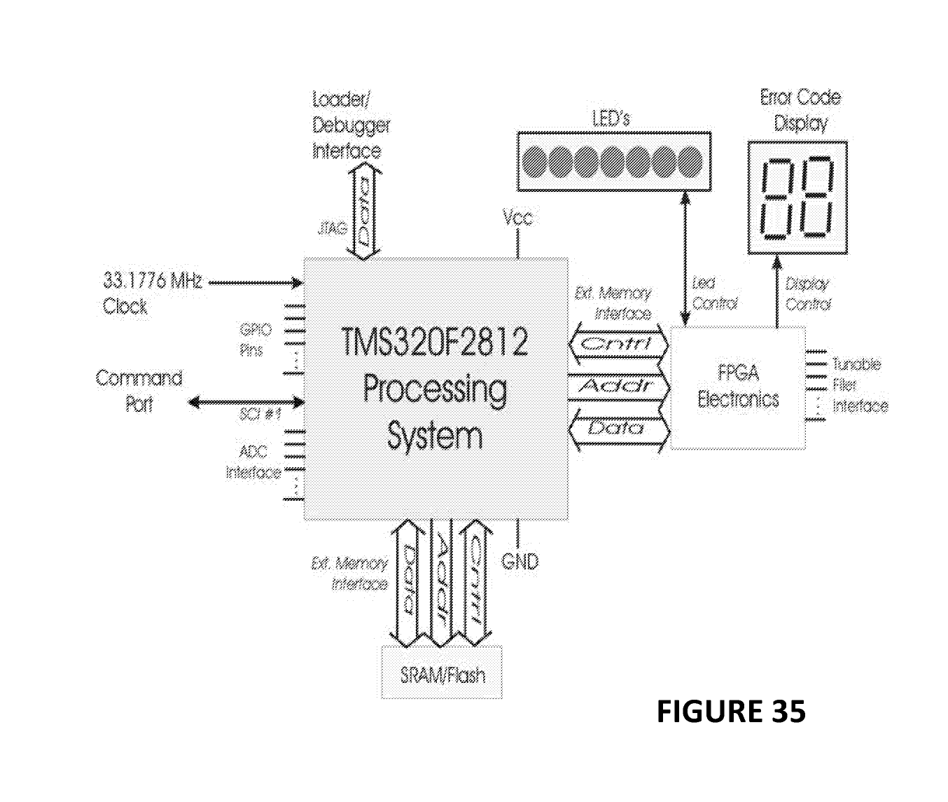

FIG. 35 is a diagram of an example implementation of the TMS320F2812 within the above-described system. The system in FIG. 35 illustrates example interconnects between the microController/DSP and external devices (protocol, data components, and rates), defining software components required for the programs, and updating throughput and sizing estimates. The Serial Communication Interface (SCI) can be used to accept mode/filter selection commands from the user. The external interface (XINT) can be used to communicate these commands to the FPGA for implementation using the HPDLC tunable filter stack. During debug and testing, the developed software can be loaded and executed via the JTAG interface to allow for the full suite of debugging/analysis options available from Texas Instruments Integrated Development Environment (IDE) to be utilized. Subsequently, all program code and data can be stored in the on-chip flash memory to be executed autonomously on power up. Any time-critical software identified during development can be transferred from flash to RAM on power up to increase throughput margins. A 33.1776 MHz clock can be used to drive the processor. A bank of LEDs and hex digital display can be made available via an external memory interface with address and data lines for debug purposes.

The HPDLC tunable filter stack may be used in a variety of applications. For example, the HPDLC tunable filter stack may be utilized to form a lightweight mirror with electronically switchable focal points for remote sensing. HPDLC mediums may be stacked in one configuration of such a mirror. Electrically switchable thin-film polymeric mirror stacks exhibit good optical characteristics and typically only weigh several pounds, even when including drive electronics. In an example configuration, each layer of the mirror stack comprises a spherically curved Bragg grating with a focal point independent from the other layers. This configuration enables such applications as electrically refocused virtual mirrors for instrument clustering.

Broadband HPDLC mirror stacks may be constructed by forming, for example, 5 cm diameter broadband HPDLC reflecting mirrors, and laminating them together. One laminating technique that may be used in the construction of a mirror stack comprises gluing the HPDLC mirror films together using optical adhesive. To adhere multiple HPDLC mirror films together using optical adhesive, the HPDLC mirror films may be formed on traditional ITO-coated glass substrates, and may be laminated into a stack using optical adhesive. An example of a suitable adhesive is Norland Optical Adhesive 71, as it possesses several advantageous characteristics, for example UV optical curing that permits precise alignment with no time pressure, very low absorption in the visible wavelength regime resulting in low optical transmission loss, and index of refraction matching the glass substrates, but other adhesives may be used.

Another technique for laminating HPDLC mirror films together to form a mirror stack involves transferring the HPDLC mirror films (after holographic exposure) to index matched polymeric substrates coated with conducting layers, thereby reducing optical losses through the stack. The HPDLC mirror stack laminating techniques disclosed herein are merely examples. Alternative laminating techniques may be obvious to those skilled in the art, and are meant to be included within the scope of this disclosure.

An example application of electrically-switchable thin-film polymeric minors lies in the optics systems of satellites. A significant limiting factor for satellite design is overall weight, particularly the relatively heavy optics associated with the primary mirrors typically used in satellites for collecting and focusing light on instrumentation, for example cameras, spectrometers, and the like. Additional design considerations include potential complications and weight associated with mechanically-operated beam steering optics typically necessary to utilize multiple instruments with a single primary collection mirror. Current state-of-the-art satellite optics technology employs polished aluminum mirrors, weighing up to several hundred pounds for a one-meter diameter mirror. Cost per pound of payload launched into low earth orbit typically places severe restrictions on the size and extent of light collection devices that can be included on specific missions. The herein described electrically-switchable thin-film polymeric mirrors may allow clustering of multiple scientific instruments around a single lightweight primary mirror and redirection of the focal point of the mirror to individual instruments, using devices that do not require moving parts.

In another example application, an HPDLC tunable filter stack may be used to perform hyperspectral imaging. A shortcoming of known hyperspectral imagers is that typically each spectral resolution element is acquired in series, with the integration time associated with the acquisition of each spectral resolution comprising only a small fraction of the total hyperspectral cube acquisition time. Because the herein described HPDLC elements exhibit rapid switching response times, imaging data can be collected through the HPDLC elements of the HPDLC filter stack in a spectrally multiplexed fashion. In other words, imaging data can be collected through each of the HPDLC elements simultaneously. The capability to rapidly tune between and/or through the spectral bands enables the HPDLC tunable filter stack to be deployed in circumstances where known hyperspectral imaging devices exhibit limited capabilities, for instance hyperspectral imaging from a moving platform such as an aircraft. The HPDLC tunable filter stack can overcome these limitations. For example, the ability of the HPDLC tunable filter stack to rapidly acquire the hyperspectral cube minimizes artifacts due to the motion of an object during the acquisition. An ideal switching rate between spectral bands for such an application is less than 1 ms.

Hyperspectral imaging systems may produce a continuous spectrum of light which can define the chemical composition of the scene elements via their spectral signatures. Example applications of hyperspectral imaging using the HPDLC tunable filter stack include, but are not limited to: surveillance and/or remote sensing from a moving platform including airborne, for instance the airborne detection of activities associated with the production of weapons of mass destruction; time resolved biological measurements; ranging (e.g., photon-counting MCP/CDL imager); particle scattering measurements; mine detection; defeating camouflage, concealment, and deception (CC&D); agricultural assessment and mapping, oil, gas, and mineral exploration; natural hazard detection (e.g., oil spills, floods, forest fires, volcanoes); coastal mapping (e.g., phytoplankton detection, ocean color, river deltas, iceberg tracking); and environmental detection (e.g., air pollution, opacity monitoring).

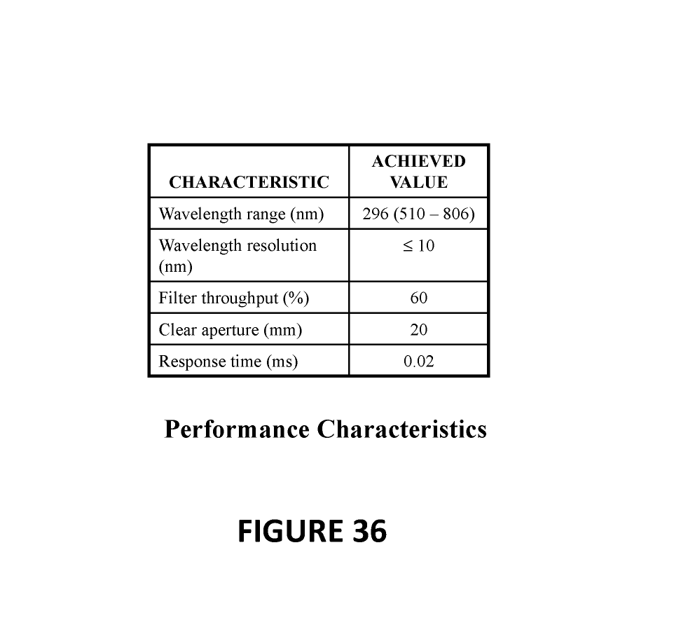

FIG. 36 is a table depicting performance characteristics of an example HPDLC tunable filter stack fabricated in accordance with the herein described methods and techniques. Acceptance angles beyond 45 degrees are supported by the HPDLC tunable filter stack. An example HPDLC tunable filter stack spanning approximately the 500 to 800 nm spectral range exhibits a switching speed of 20 μs, an ability to modulate at frequencies up to 40 kHz, an ability to perform synchronous detection with ten separate spectral channels, a spectral resolution of better than 10 nm, a reflection efficiency (equating to throughput) of 60%, and an electro-optic response time of 20 μs, with a filter aperture of about 20 mm to 30 mm. The example HPDLC tunable filter stack can be fabricated using acrylate materials, thiolene materials, or the like.

The HPDLC tunable filter stack can support different modes of operation depending, for instance, upon the filter driving electronics employed to drive the HPDLC tunable filter stack. A first mode of operation of the HPDLC tunable filter stack can be a unipolar mode that comprises a 0-100V, 50% duty cycle square wave at selectable drive frequency across 1-2 kHz. This operation mode can provide parallel collection of spectral data (i.e., spectral multiplexing where synchronous detection can be provided for each channel). A field programmable gate array (FPGA) can be used to provide square wave inputs to the synchronous detection circuits that are in phase or quadrature with the drive signal, allowing in phase or quadrature components of the detected signal to be measured. The synchronous detection outputs can be filtered by a 2 pole low pass filter with a bandwidth of 50 Hz.

A second mode of operation of the HPDLC tunable filter stack can be a bipolar mode that comprises a ±100V, 50% duty cycle square wave at selectable drive frequency across 1-2 kHz. This operation mode can provide DC operation (full transparency) of an individual HPDLC filter element. DC operation can enable analysis of HPDLC filter characteristics (transmission, resolution) with a conventional COTS spectrometer.

A third mode of operation of the HPDLC tunable filter stack can be a step mode that comprises a 100V, 500 microsecond pulse applied sequentially to each HPDLC filter element. This operation mode can provide operation with a high bandwidth detector such as the single photon detection RULLI sensor system technology. Sample and hold circuits can provide a triggered output for each channel. The pulse duration can be modified to accommodate slower or faster requirements.

A fourth mode of operation of the HPDLC tunable filter stack can be an external mode comprising a TTL square wave input. This operation mode can provide the ability to externally drive an HPDLC filter with a function generator.

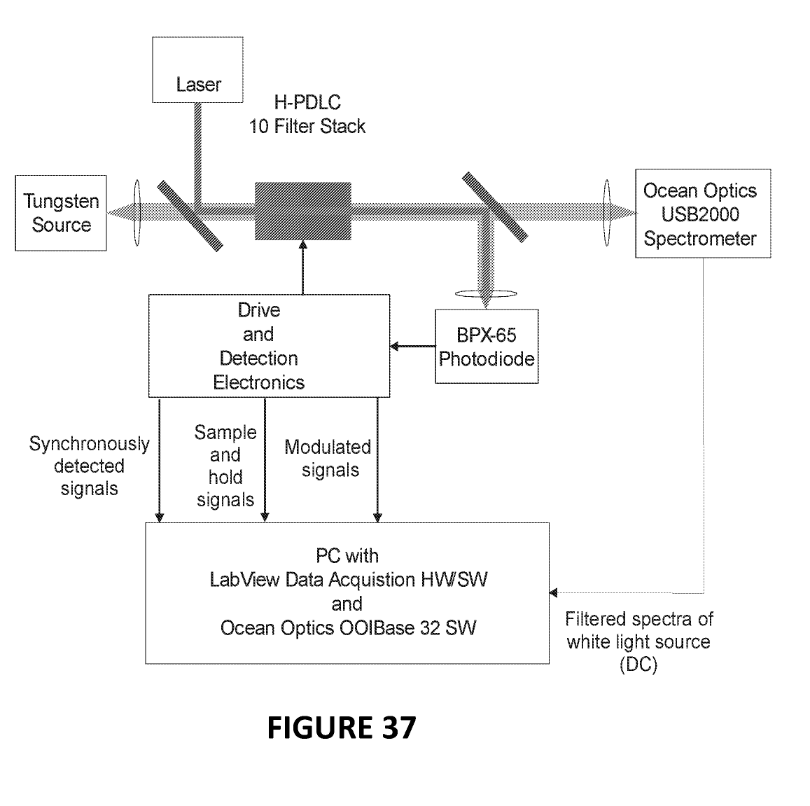

FIG. 37 depicts a breadboard system that can be used to evaluate the HPDLC tunable filter stack. Various light sources can be used to test the HPDLC tunable filter stack, for instance a monochromatic laser operating at 532 nm or a polychromatic tungsten lamp. The light sources can be directed through the HPDLC filters and then separated for analysis using a pair of beam splitters. The sources can be operated independently. The laser can be used to measure the frequency response of the HPDLC tunable filter stack and crosstalk between HPDLC filter elements. The white light source can be used to measure the resolution and transmission of the HPDLC tunable filter stack.

A silicon photodiode, such as a Siemens BPX65, 1 mm square active area, can be used for light detection. The photodiode can be installed on an electronics pre-amplifier board that includes a transimpedance amplifier for converting the diode current signal to a voltage. This board can be integrated with the above-described drive and detection electronics custom controller. The drive and electronics board can support the above-described modes of operation and can provide a number of outputs, including but not limited to: synchronous detection wherein the outputs of up to ten HPDLC filter channels after synchronous detection can be provided on a separate connector, the signals sampled in unipolar mode; sample and hold wherein sampled outputs of up to ten HPDLC filter channels can be provided on a separate connector, the signals sampled in the step mode; and modulated signals wherein the photodiode signal after amplification can be provided on a separate connector, the signal containing the multiplexed output of the HPDLC filter elements. In an example embodiment, modulated signals mode can acquire data via a data acquisition system and perform a fast Fourier transform to extract the spectral information.

A spectrometer, such as an Ocean Optics USB2000 COTS grating spectrometer, can be used for spectral analysis in the static bipolar mode. The spectrometer software can provide both data acquisition and analysis of the spectra via a USB port. The spectrometer operates from 350 to 850 nm (50% average efficiency in the visible) and has a 25 μm slit that provides a 1.23 nm spectral resolution.

The breadboard hardware can be used to make a variety of measurements including but not limited to response time, transmission, reflection efficiency, wavelength range, and spectral resolution. The laser can be used as the light source. A filter matching the laser wavelength can be driven with a 1 kHz square wave and the modulated light can be detected with the photodiode. The resulting voltage waveform can be sampled using a digital oscilloscope or standard data acquisition system. The 10-90% rise and fall times can be measured to determine the response time of the HPDLC tunable filter stack.

An ideal hyper spectral imaging filter would achieve a reflection efficiency of 1. However, this is not feasible in practice. Fresnel reflection losses occur at each filter interface surface, lowering the maximum obtainable transmission at transparency. Scattering of light throughout the filter can further reduce transmission. The amount of reflection can be dependent on a number of factors, including materials used and number of Bragg layers. The type of liquid crystal can also impact the maximum transmission due to any residual index mismatch with the polymer. The reflection efficiency can also vary as a function of modulation frequency given different relaxation processes in the filter.

The DC reflection efficiency can be measured for each channel using the tungsten light source and the spectrometer. The spectral magnitude (in counts) can be measured for both OFF and BIASED (bipolar mode) states and the efficiency can be calculated as the difference between the on and off magnitude divided by the on (transparent or semitransparent) magnitude.

The AC reflection efficiency can be measured for the resonant channel using the laser light source and the photodiode. In a manner similar to the response time measurement, a fixed frequency can be used to drive the resonant filter and a waveform can be acquired digitally. The reflection efficiency can be measured as the peak to peak difference divided by the peak value.

The wavelength range can be measured using the white light source and the spectrometer. Spectra can be acquired for two cases: 1) No bias to any filter, and 2) All filters biased on. These two spectral measurements can be subtracted from each other. The full width half maximum of the residual non-zero signal can be measured to determine the full wavelength range.

The spectral resolution for each HPDLC filter element can be measured using the white light source and the spectrometer. This is effectively the same measurement as the wavelength range except only a single filter element can be biased on at a time.

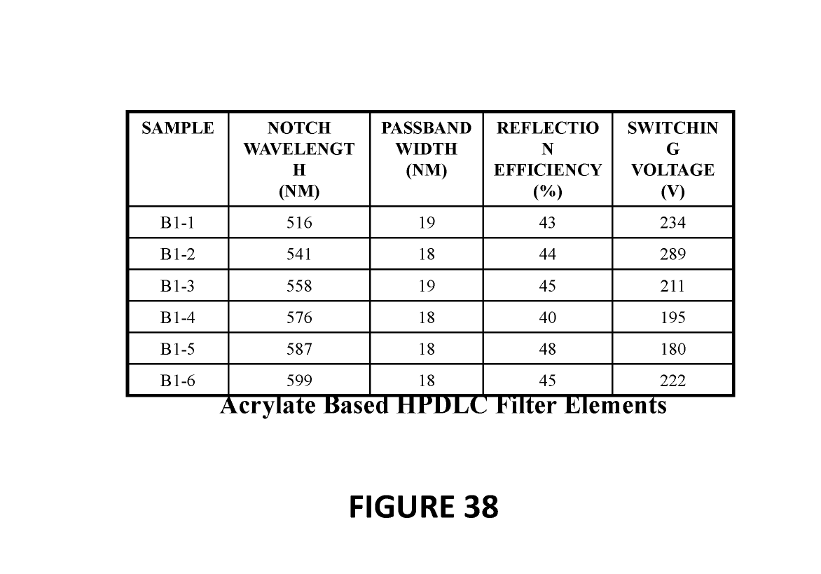

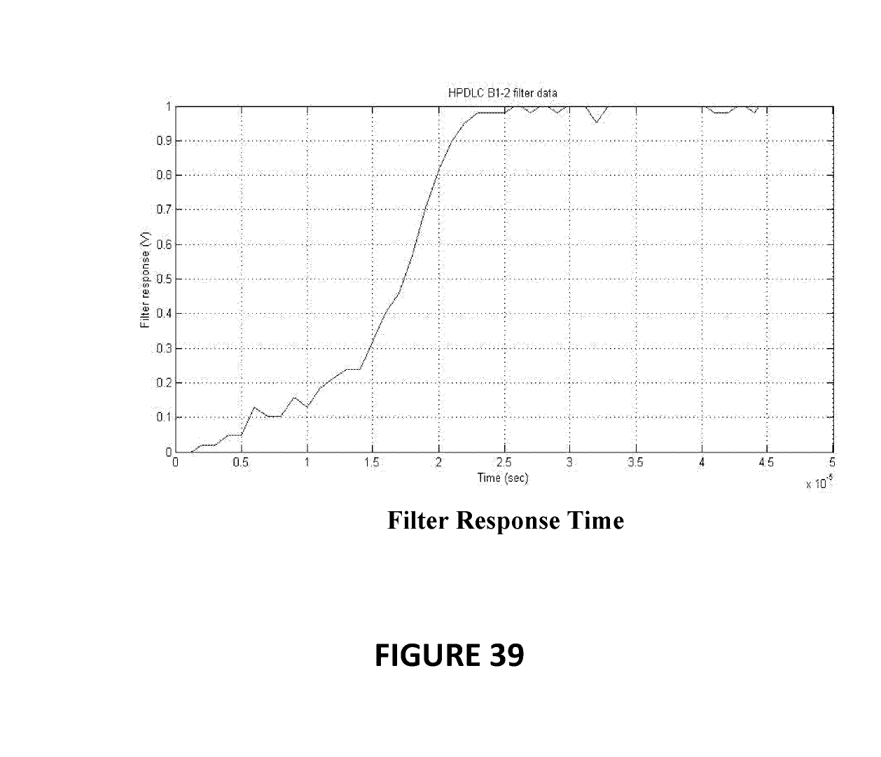

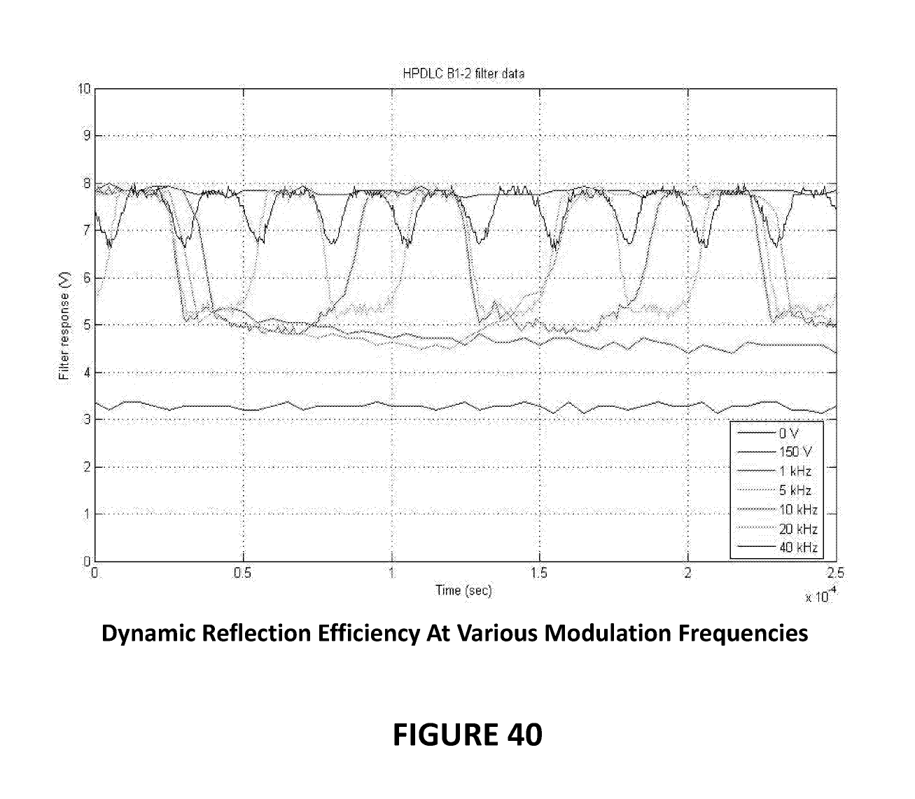

FIG. 38 is a table containing parameters and metrics associated with a plurality of example acrylate based HPDLC filter elements. Each HPDLC filter element was tested individually to determine its respective performance characteristics. FIG. 39 illustrates a graph depicting a resulting filter response time of about 20 microseconds for an example of the plurality of acrylate based HPDLC filter elements. FIG. 40 illustrates a graph depicting resulting dynamic reflection efficiency indicating a dynamic filter throughput of about 37% for modulation frequencies up to 40 kHz, exhibited by an example of the plurality of acrylate based HPDLC filter elements.

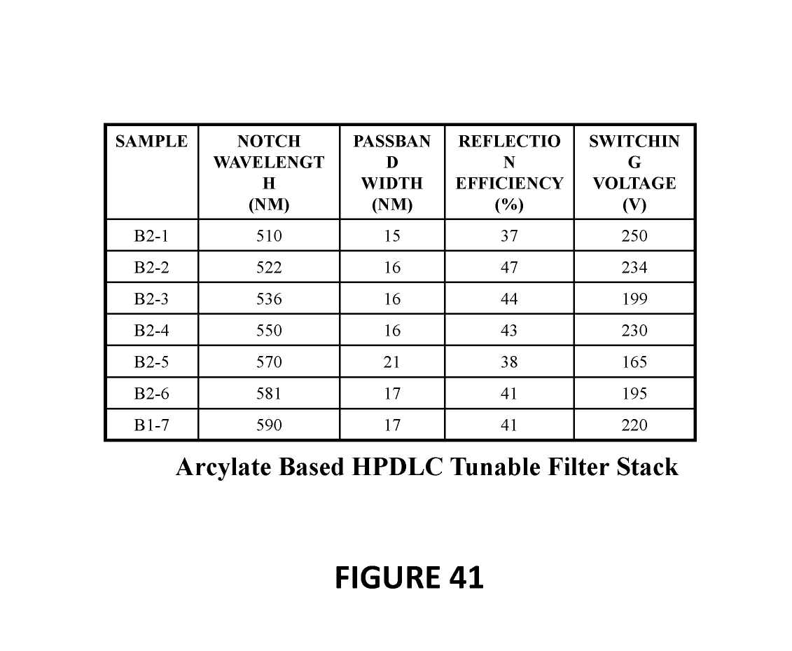

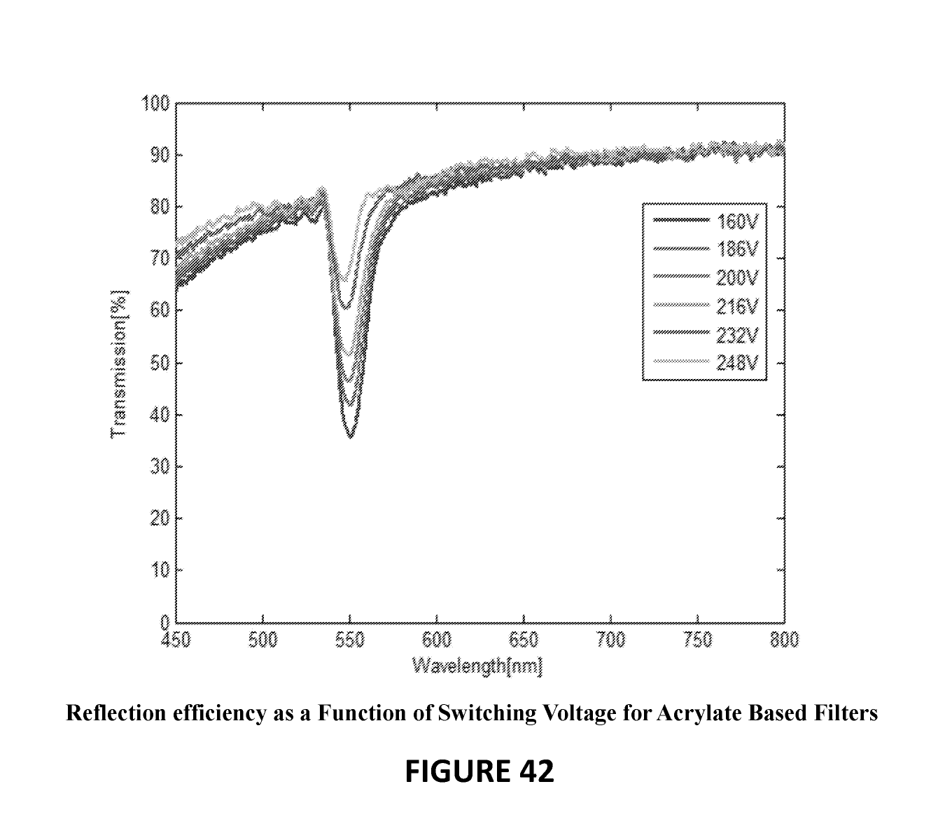

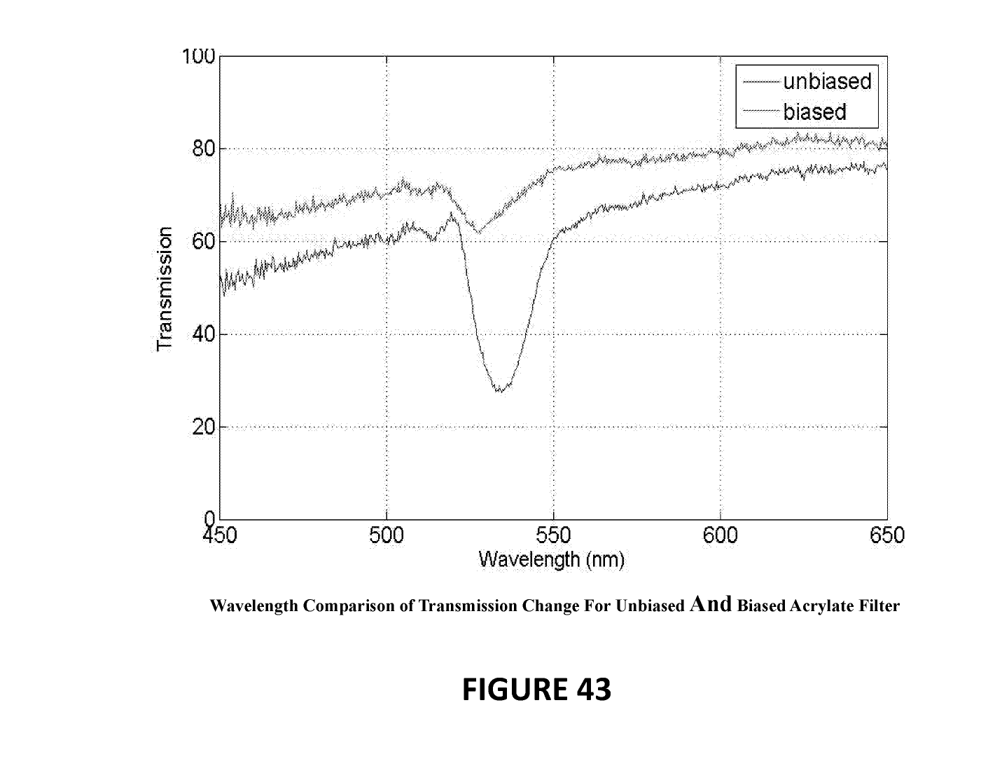

FIG. 41 is a table containing parameters and metrics of an example acrylate based HPDLC tunable filter stack. FIG. 42 illustrates a graph depicting the filter reflection efficiency of the example acrylate based HPDLC tunable filter stack as a function of switching voltage. FIG. 43 illustrates a graph depicting the transmission curves for the example acrylate based HPDLC tunable filter stack in unbiased and biased states.

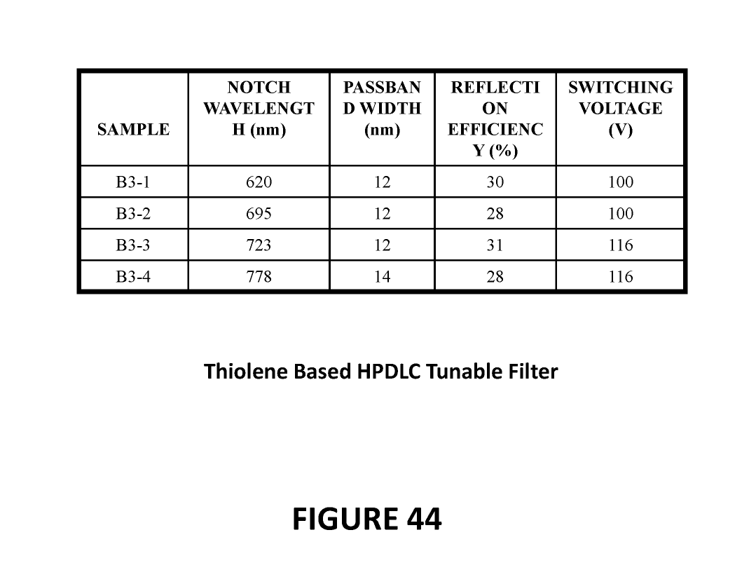

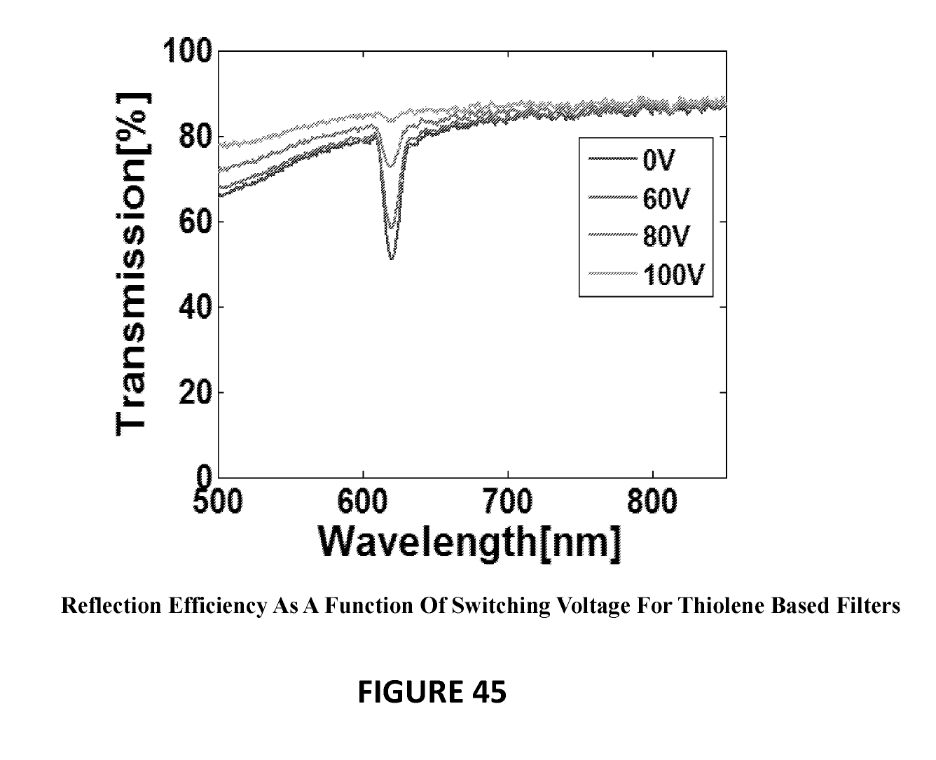

FIG. 44 is a table containing parameters and metrics associated with an example thiolene based HPDLC tunable filter stack. An example thiolene based HPDLC tunable filter stack can exhibit lower scattering and decreased switching voltage relative to a respective example acrylate based HPDLC tunable filter stack, but can exhibit decreased overall reflection efficiency relative to a respective example acrylate based HPDLC tunable filter stack. FIG. 45 illustrates a graph depicting a comparison of reflection efficiency as a function of switching voltage for an example thiolene based HPDLC tunable filter stack.

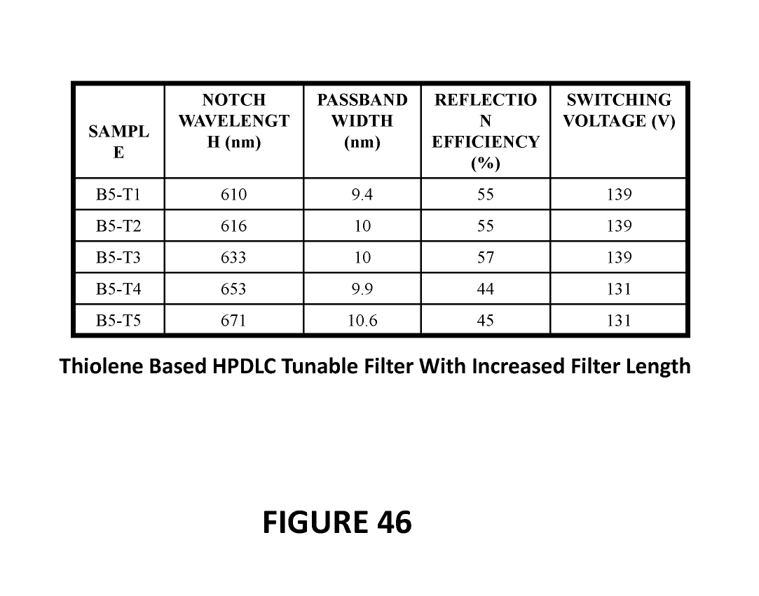

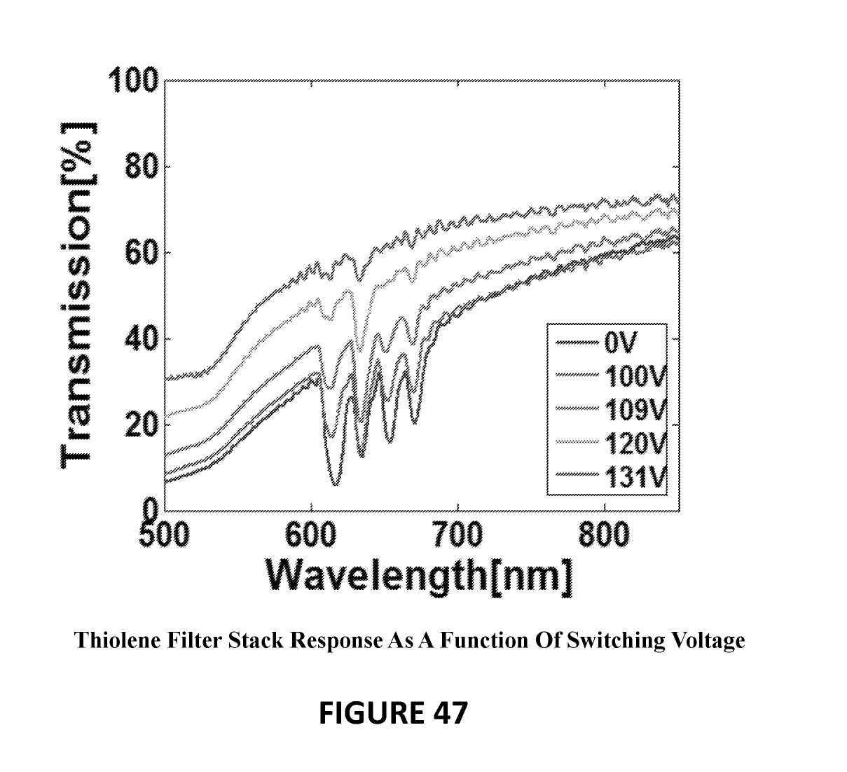

FIG. 46 is a table containing parameters and metrics associated with an example thiolene based HPDLC tunable filter stack comprising HPDLC filter elements having filter lengths of 20 microns. An HPDLC tunable filter stack comprising HPDLC filter elements with 20 micron filter lengths exhibits improved reflection efficiency and resolution, but require increased switching voltage relative to an HPDLC tunable filter stack comprising HPDLC filter elements having 5 micron filter lengths. FIG. 47 illustrates a graph depicting the response of an example HPDLC tunable filter stack comprising HPDLC filter elements with 20 micron filter lengths as a function of switching voltage and indicates the performance of high-speed tunable filtering of light. Only four distinct notches are seen since the 610 and 616 filter passbands overlap.

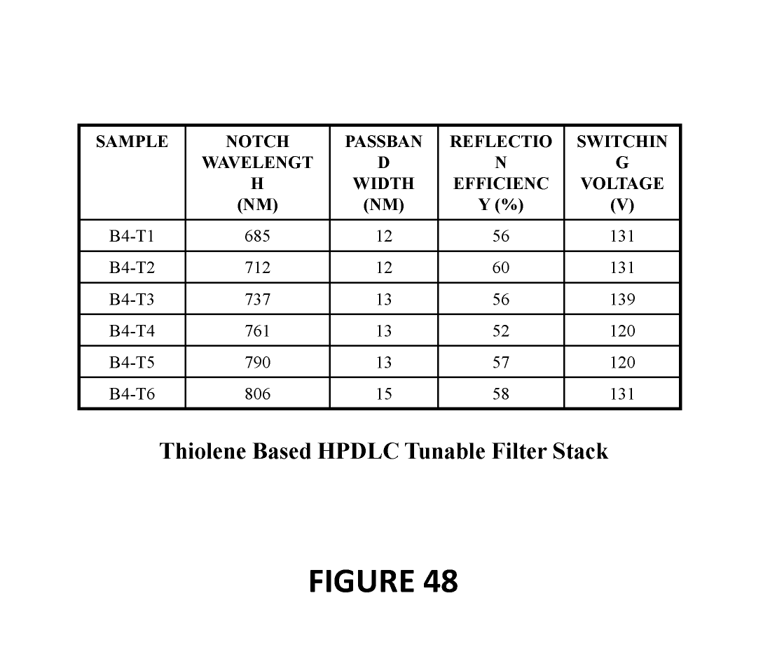

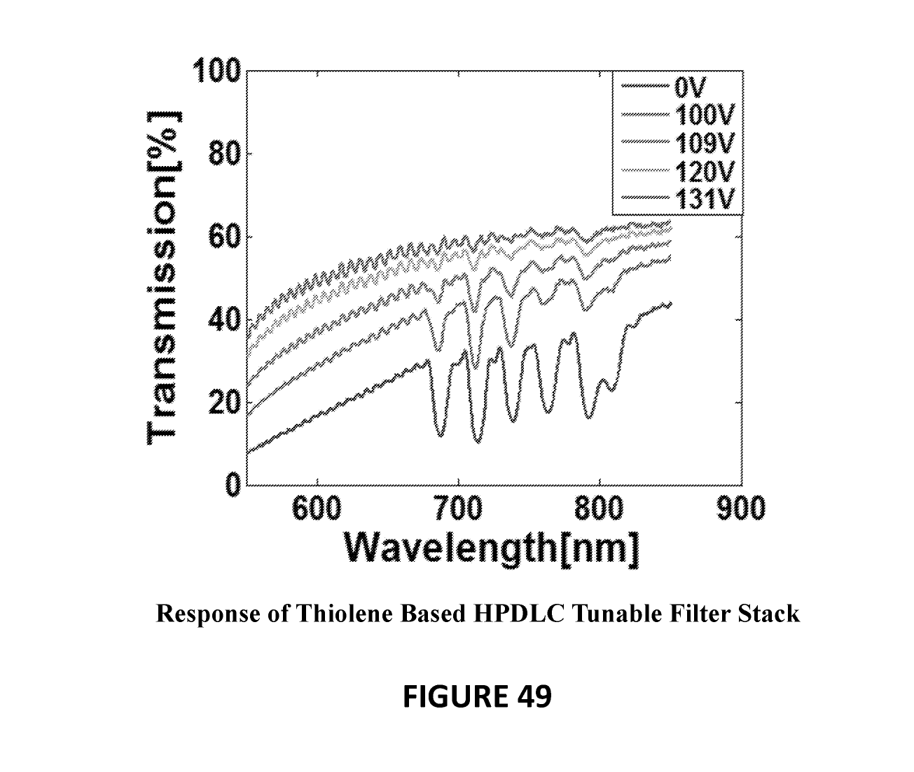

FIG. 48 is a table illustrating the performance of an example thiolene based HPDLC tunable filter stack operating in the near-IR portion of the spectrum. Similarly to the visible region, good performance is exhibited for resolution, reflection efficiency and switching voltage. FIG. 49 illustrates a graph depicting the response of the thiolene based HPDLC filter stack as a function of switching voltage, indicating good performance is obtained across the near-IR region.

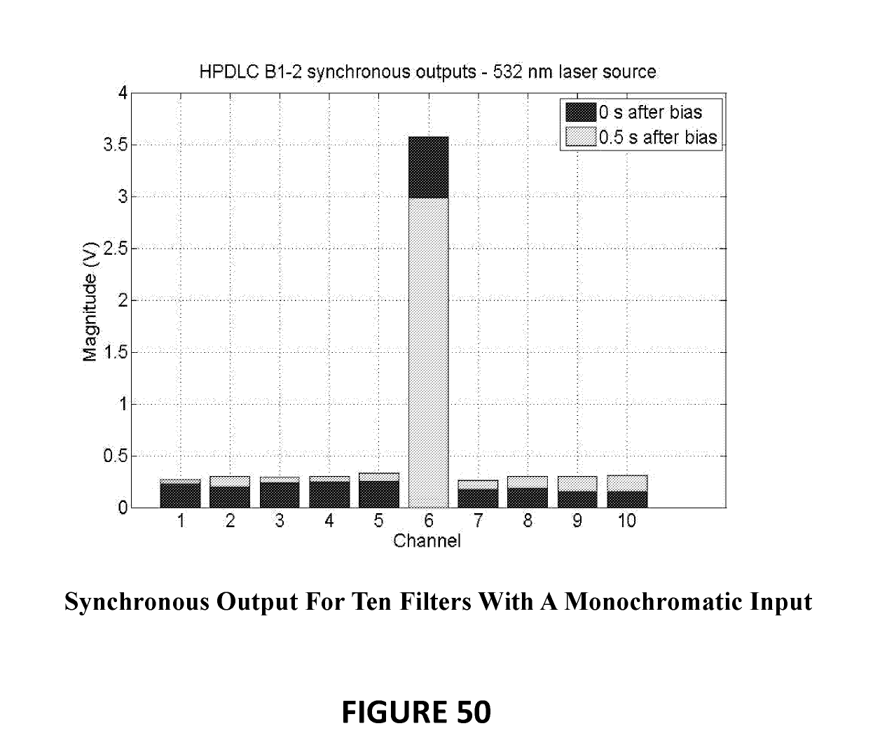

Each HPDLC element within an HPDLC tunable filter stack can be modulated at a different frequency on the order of tens of kHz due to the extremely fast filter switching time, thereby supporting the ability to synchronously detect and demodulate each wavelength, in other words to spectrally multiplex imaging data. FIG. 50 depicts the demodulated signals for an example HPDLC tunable filter stack comprising ten filters when the HPDLC tunable filter stack is subjected to a monochromatic light source resonant with the HPDLC tunable filter stack operating at channel 6. Two effects can be observed: a 20% decay in the inband signal after initial bias; and non-zero out of band signals. The cause of the inband decay is believed to be relaxation process in the LC material. The out of band signal is believed to be due to high-frequency noise in the frequency doubled Nd:Yag laser source and not a property of the HPDLC tunable filter stack.

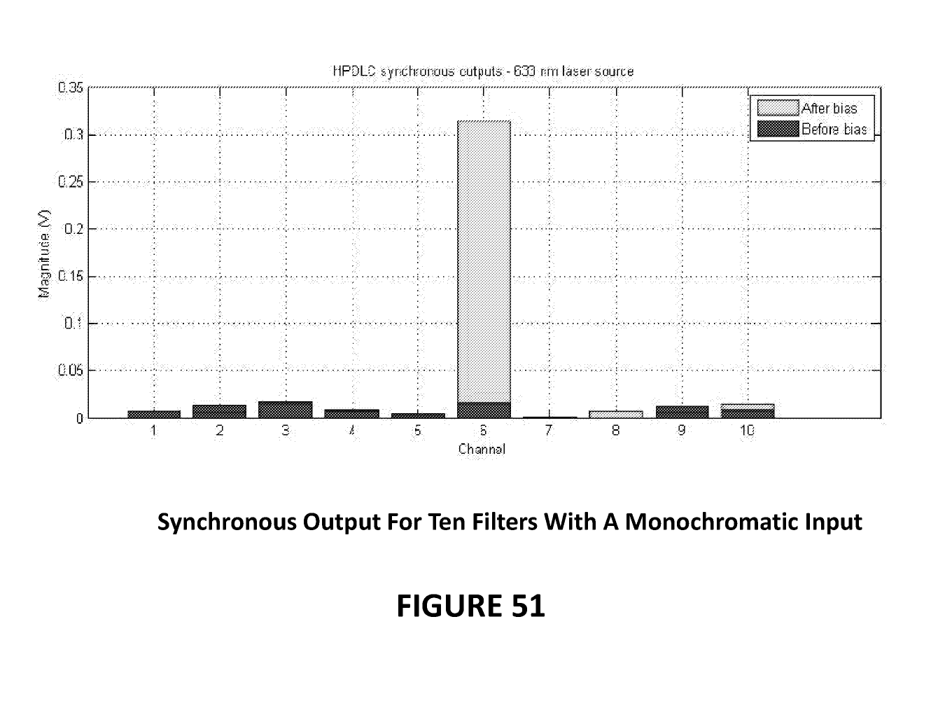

FIG. 51 shows the synchronous outputs for a He:Ne gas laser. Although the decay is still present as expected (not shown in the figure), the out of band signal is gone for the gas laser as FIG. 51 shows no increase in out of band signal after biasing the filter.

It should be appreciated that HPDLC filter elements can be constructed using various materials, for instance the above-described acrylate based and thiolene based HPDLC filter elements. Example HPDLC tunable filter stacks can exhibit differing electro-optic performance characteristics, for instance based upon the materials used to construct the respective HPDLC filter elements of the HPDLC tunable filter stacks. The electro-optic performance of HPDLC tunable filter stacks constructed using different materials can differ in terms of long term stability reflection efficiency, switching efficiency, switching voltages, polarization sensitivity, scattering and switching speed, primarily due to the difference in the morphology of the HPDLC elements as they are formed. For instance, thiolene based HPDLC elements can exhibit a lower switching voltage, narrower full width at half maximum (FWHM), and lower scattering relative to acrylate based HPDLC elements. Additionally, thiolene based HPDLC elements can exhibit a lack of polarization dependence, while acrylate based HPDLC elements can exhibit diffraction efficiency of P polarization that is higher than for S polarization.

Described below is an example HPDLC tunable filter stack that can be utilized for hyperspectral imaging (HSI). The example HPDLC tunable filter stack is capable of gathering hyperspectral imaging data within the visible wavelength range, more specifically in the visible wavelength range of 600-800 nm. Alternatively, the HPDLC tunable filter stack can be constructed to operate within any desired portion of the electromagnetic spectrum, for instance within any portion, such as the entire range, of the spectrum of visible light, the near infrared range, the thermal infrared range, the far infrared range, or any combination thereof. An HPDLC tunable filter stack utilized in an HSI system can comprise a plurality of HPDLC elements. For instance, the example HPDLC tunable filter stack comprises twenty HPDLC elements, each with a FWHM of approximately 10 nm.

The HPDLC elements of the example HPDLC tunable filter stack exhibit a number of properties useful for HSI applications, including uniform reflection efficiency of approximately 80% across a 35 mm optical aperture, polarization insensitivity for normal incidence, spectral resolution of 10 nm, and fast switching times on the order of microseconds. Moreover, the ability to modulate each HPDLC element in the HPDLC tunable filter stack at a different frequency allows for spectral multiplexing, thus enabling synchronous detection and demodulation of imaging data. The example HPDLC tunable filter stack can be integrated into the drive and detection system of a hyperspectral imaging system, for instance the above-described drive and detection system.

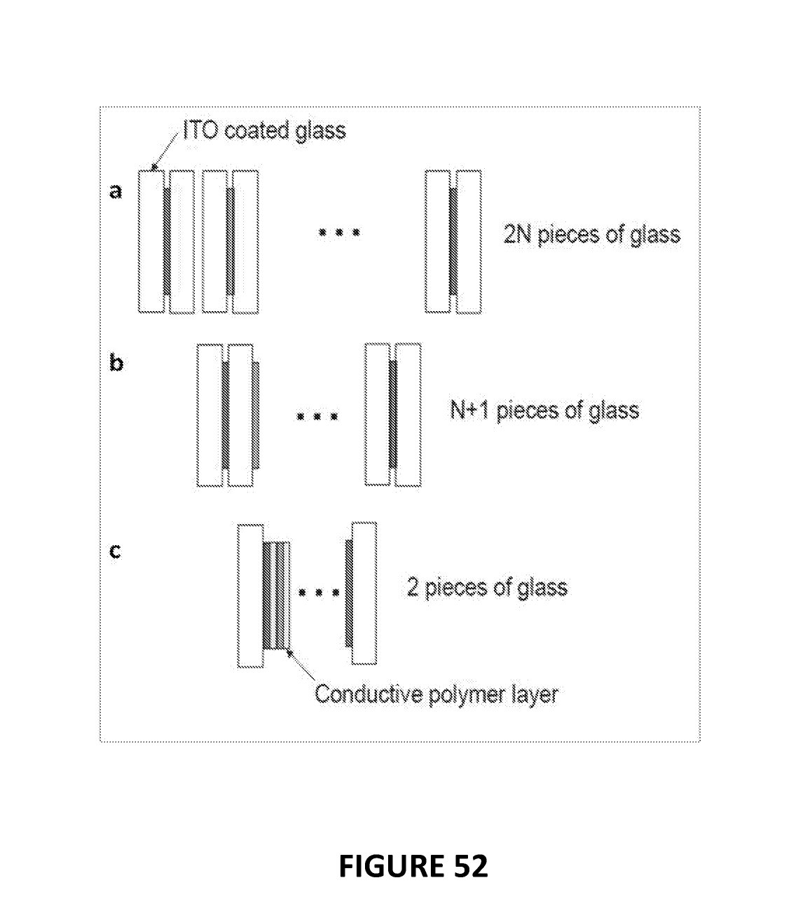

FIG. 52 depicts a number of example techniques that may be used to assemble the HPDLC elements of the example HPDLC tunable filter stack, wherein N equals the number of HPDLC elements in the stack. In accordance with technique a), each of the HPDLC elements can be individually fabricated, sandwiched between a respective pair of ITO coated glass substrates. Therefore, an HPDLC tunable filter stack fabricated in accordance with technique a) requires 2N substrates, for instance 2N pieces of ITO glass. The individual HPDLC elements can then be affixed to one another to comprise the HPDLC tunable filter stack.

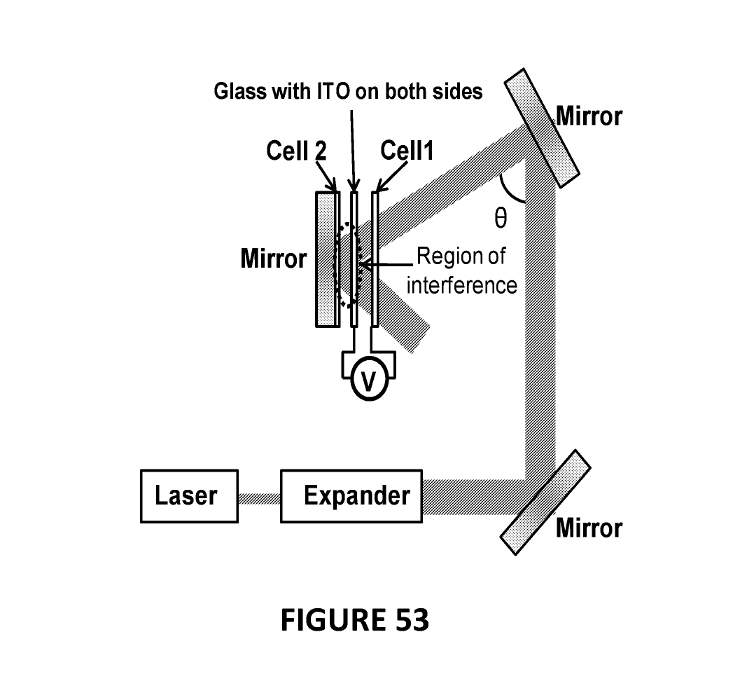

In accordance with technique b), individual HPDLC filter elements are formed on glass substrates coated with indium tin oxide (ITO) on both sides, allowing independent switching of each HPDLC element in the HPDLC tunable filter stack. Successive layers of the HPDLC tunable filter stack can be formed with the existing layers of the stack unbiased or biased, while exposing the subsequent layer to an interference pattern. For example, as illustrated in FIG. 53, the first HPDLC element of the stack is formed by the one beam method using a reflecting mirror behind the HPDLC element so that the incident and the reflected beams self-interfere to form an interference pattern within the HPDLC element. The first HPDLC element comprises a glass substrate which can be coated with ITO on both sides. The second HPDLC element layer of the stack can be formed directly behind the first HPDLC element, sandwiched between the ITO coated side of the first HPDLC element and another ITO coated glass slide as shown in FIG. 52. Therefore, an HPDLC tunable filter stack fabricated in accordance with technique b) requires N+1 substrates, for instance N+1 pieces of double-sided ITO glass.

Switching one or more of the existing HPDLC element layers of the stack during interference pattern exposure of subsequent layers can improve the reflection efficiency of HPDLC element layers in the stack. Additionally, the optical path length of the HPDLC tunable filter stack can be reduced due to elimination of substrate layers relative to an HPDLC tunable filter stack constructed in accordance with technique a). Moreover, stacking HPDLC elements in accordance with technique b) can eliminate the use of index matching materials between HPDLC elements, hence reducing parallax and wavefront errors.

Referring again to FIG. 52, in accordance with technique c), the first HPDLC filter element of the HPDLC tunable filter stack can be formed on a glass substrate, and subsequent HPDLC filter elements can be formed on top of the preceding HPDLC element in the stack, the HPDLC elements spaced by intervening conductive layers. Therefore, an HPDLC tunable filter stack fabricated in accordance with technique c) requires only two substrates, for instance two pieces of ITO glass. An HPDLC tunable filter stack in accordance with technique c) can be fabricated by utilizing the above-described spin coating apparatus and methods.

The example HPDLC tunable filter stack utilized for HSI was fabricated using technique a). The example HPDLC tunable filter stack comprises twenty individually formed HPDLC filter elements, each with a FWHM of approximately 10 nm, fabricated in the 600-800 nm range. The individual HPDLC filter elements were glued together one behind the other using the UV curable photopolymer NOA65 to provide index matching between the stacked filter elements and to minimize transmission loss due to any index mismatch. It should be appreciated that the example HPDLC tunable filter stack is not limited to fabrication using technique a), and that the example HPDLC tunable filter stack can be alternatively fabricated using any other suitable technique, for instance techniques b) or c), as desired.

As described above, a typical hyperspectral imaging system comprises fore optics, a wavelength dispersing element, and an array of detectors. However known wavelength filtering or dispersing elements typically do not offer the ability to simultaneously access and rapidly tune the wavelength to obtain a spectral multiplex, or support high speed hyperspectral imaging from a moving platform such as an aircraft. The example HPDLC tunable filter stack can be employed as a high speed wavelength filtering element in the optical front end of a hyperspectral imaging system. The ability to modulate each HPDLC filter element in the stack at a different frequency can allow spectral multiplexing of imaging data. Synchronous detection and demodulation can be performed on a monochromatic wavelength passing through the HPDLC tunable filter.

Example HPDLC filter elements of the HPDLC tunable filter stack can be holographically fabricated over a circular optical aperture of 35 mm in diameter having a narrow spectral bandwidth using techniques discussed herein. High speed electro-optic switching on the order of microseconds with polarization insensitivity can be achieved using the example HPDLC tunable filter stack.

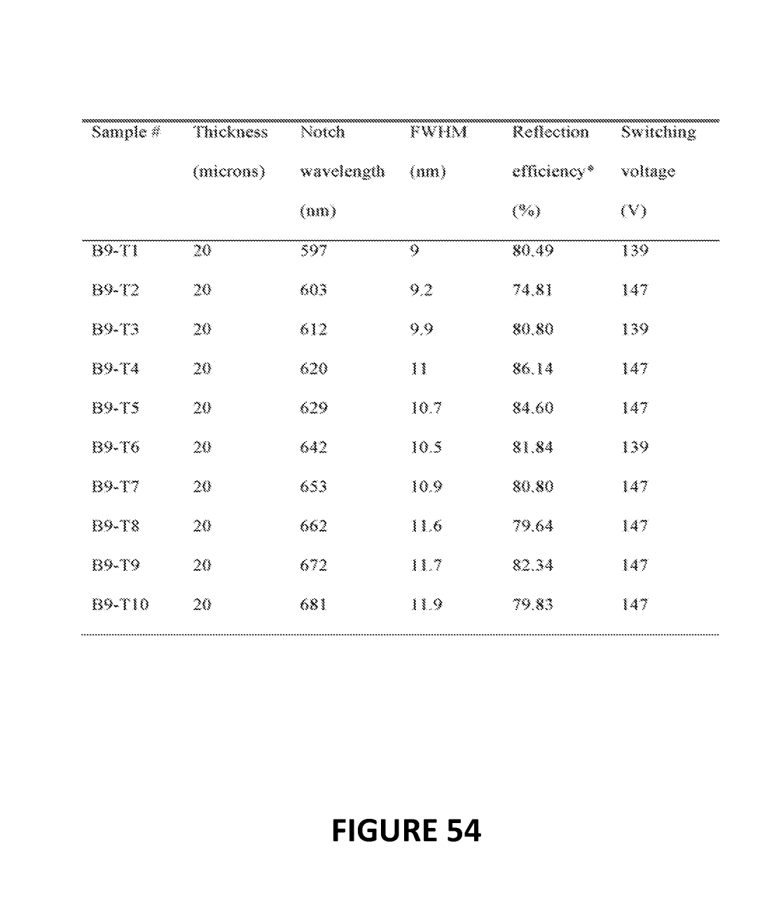

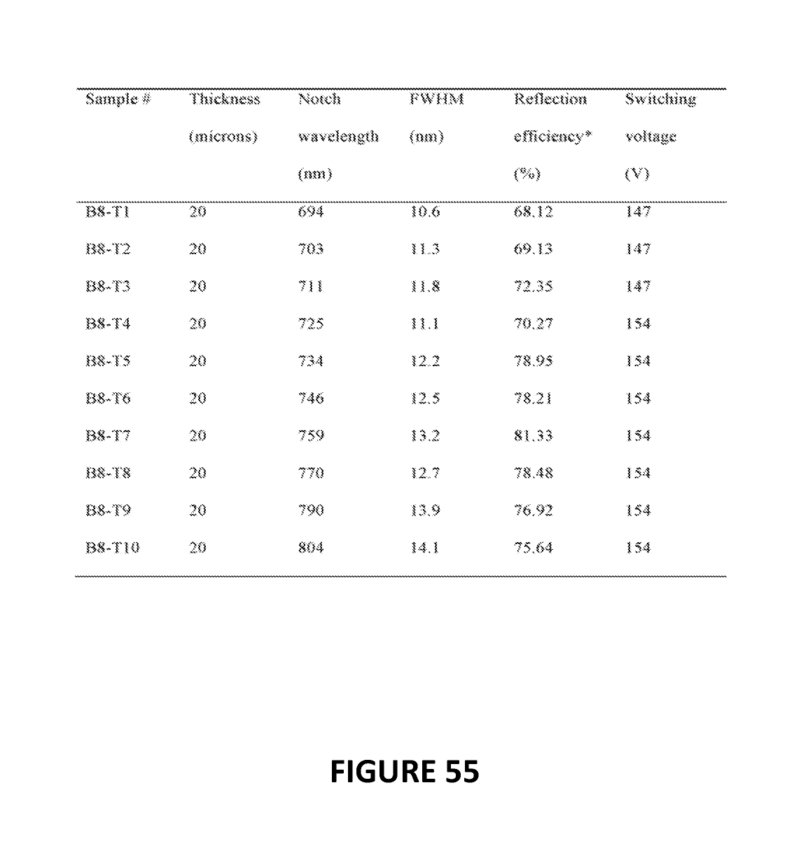

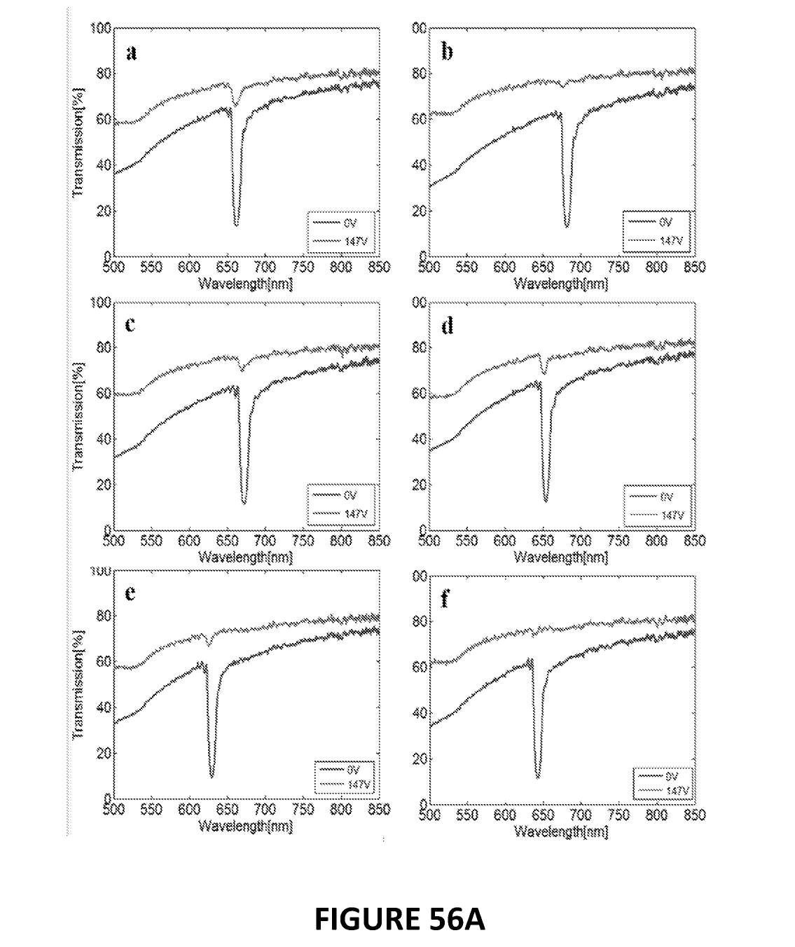

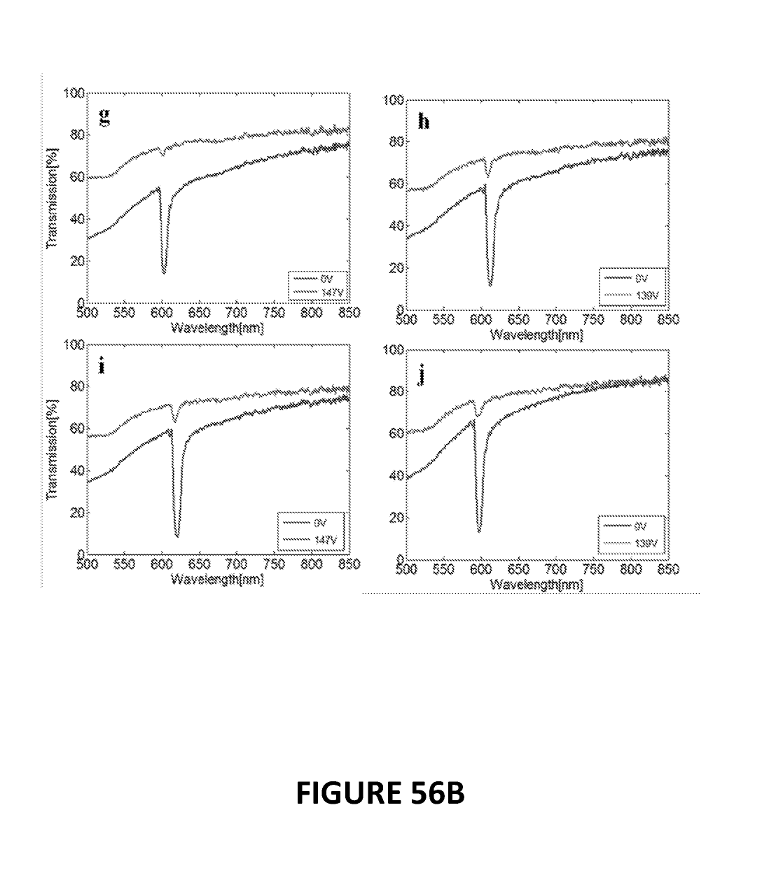

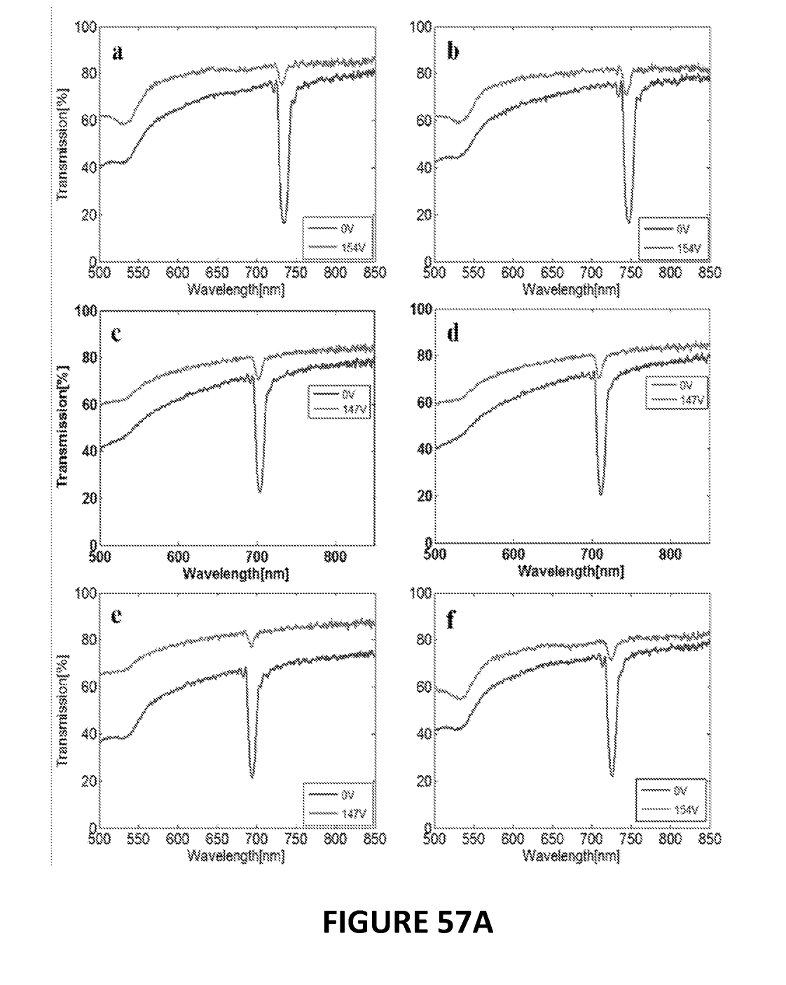

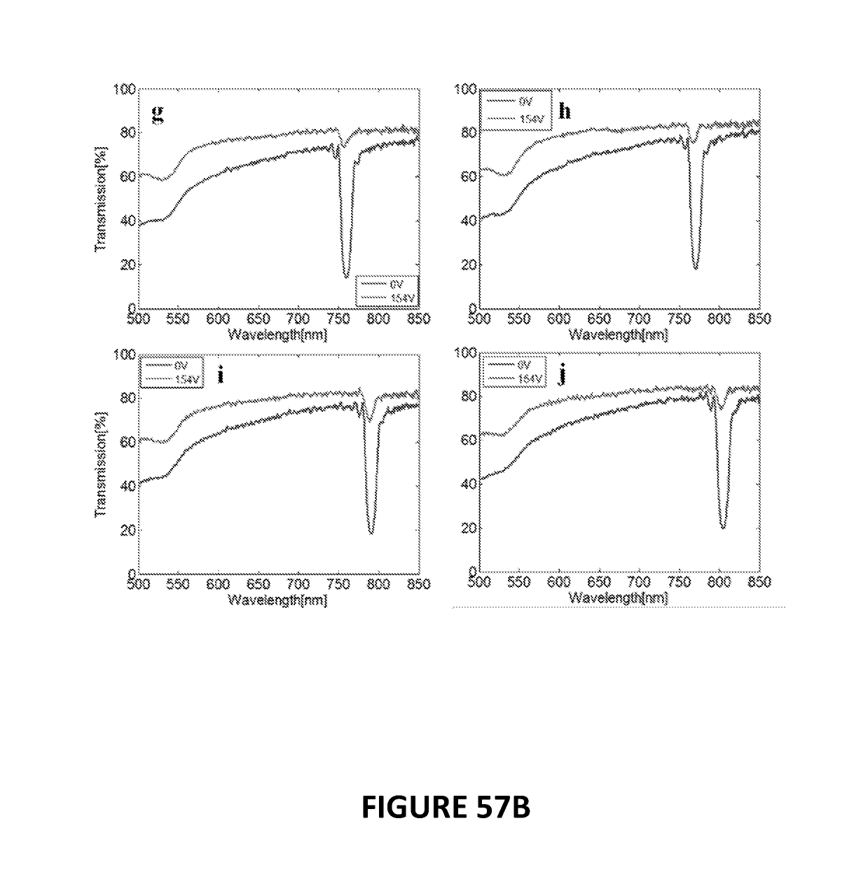

FIG. 54 and FIG. 55 depict example tables containing parameters and metrics associated with respective individual example thiolene based, 30 mm aperture HPDLC filter elements of the example HPDLC tunable filter stack in the 600-700 nm, and 700-800 nm wavelength ranges, respectively. FIG. 56A, plots a-f, FIG. 56B, plots g-j, FIG. 57A, plots a-f, and FIG. 57B, plots g-j illustrate individual transmission spectra of the individual example thiolene based, 30 mm aperture HPDLC filter elements of the example HPDLC tunable filter stack in the 600-700 nm, and 700-800 nm wavelength ranges, respectively. Slight differences in reflection efficiencies of the HPDLC filter elements can cause the HPDLC filter elements to exhibit differences in switching voltage.

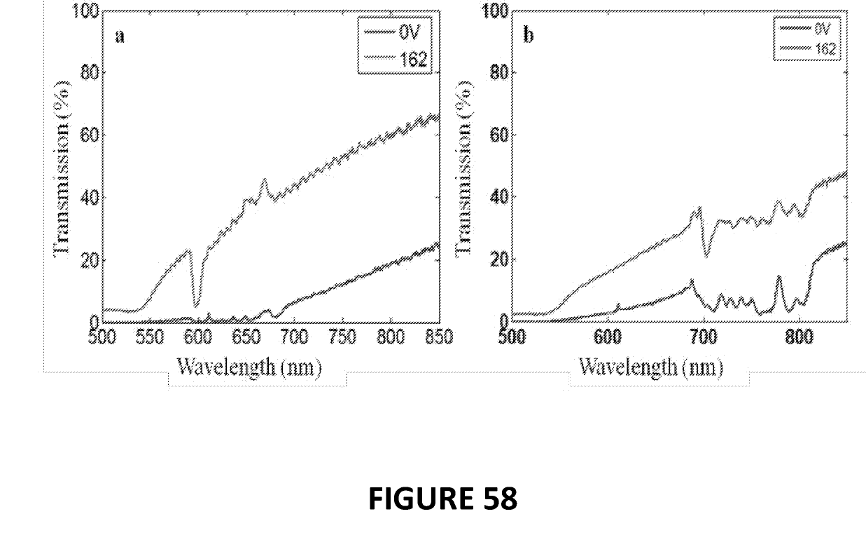

FIG. 58, plots a-b illustrate the spectra, both biased and unbiased (i.e., switched and unswitched), of a pair of thiolene based HPDLC tunable filter stacks in the 600-700 nm range and 700-800 nm range, respectively, each filter stack comprising ten HPDLC filter elements. Because scattering is more dominant at lower wavelengths, the transmission throughput in the unswitched state (0V) is higher in the 700-800 nm range than in the 600-700 nm range. The example HPDLC tunable filter stacks demonstrate the ability to access wavelengths with a resolution of 10 nm with polarization insensitivity and microsecond switching in a given optical band. Transmission throughput for the HPDLC tunable filter stacks can be diminished due to random wavelength dependent scattering losses arising from the size of the LC droplets trapped in the polymer matrix. Additionally, transmission throughput for the example HPDLC tunable filter stack can be attributed to the fact that the presence of index matched ITO glass substrates within the stack can reduce the overall transmission throughput, for instance by approximately 40%. Of course transmission throughput loss attributable to the presence of glass substrates can be mitigated by fabricating the example HPDLC tunable filter stack utilizing a reduced number of glass substrates, for instance by fabricating the example HPDLC tunable filter stack in accordance with techniques b) or c).

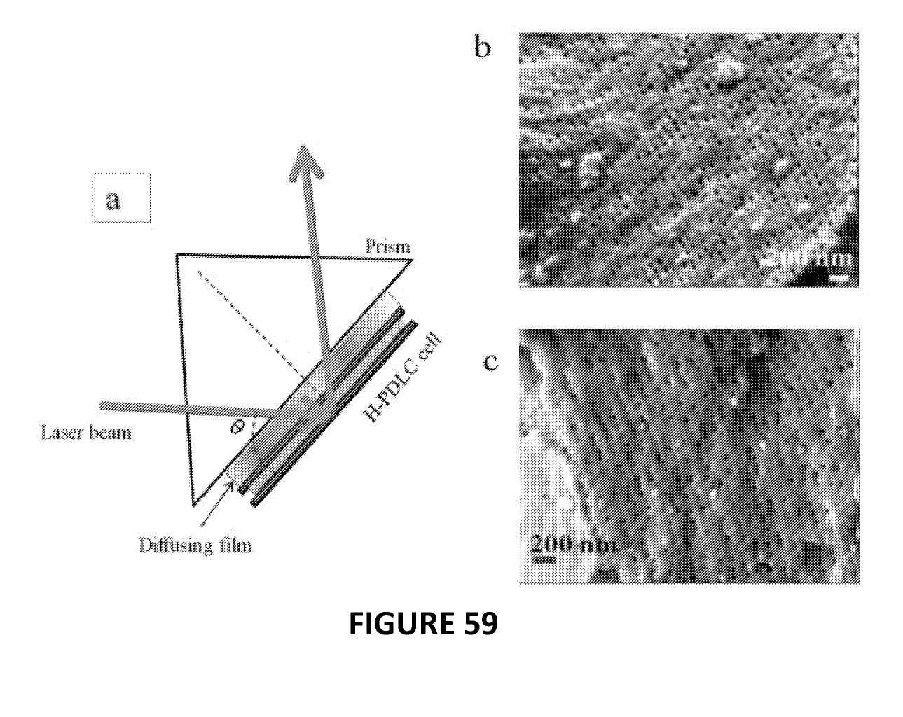

A filtering element comprising a wider view angle can enable a wider field of view within the hyperspectral imaging system, thus reducing the physical size of the wavelength filters and eliminating the need for a large area CCD. In order to improve the view angle of the example HPDLC filter elements, diffusing films, such as those with diffusing angles of 5° and 30°, can be introduced into the path of the recording beam, for instance between the prism and the thiolene based HPDLC filter element, as illustrated in FIG. 59, illustration a. The diffuser can act to diffuse the incoming beam. While introducing a diffuser can reduce the coherency of the recording beam, enough coherency can be maintained to record the respective Bragg structures. Additionally, introducing a diffuser can reduce the reflection efficiency and/or increase the FWHM of the HPDLC filter elements, as is evident from the morphology of the non-diffuse and diffuse HPDLC filter elements illustrated in FIG. 59, illustrations b and c, respectively.

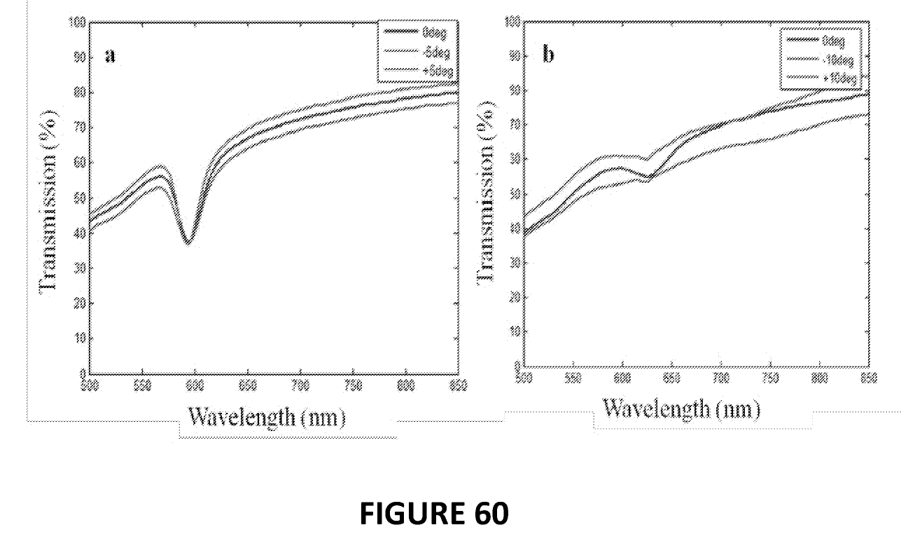

FIG. 60, plot a illustrates the expansion of the view angle of an example HPDLC filter element by 10° using a 5° diffusing film. The example HPDLC filter element was rotated +/−5° with respect to the normal incident white light source and no blue shift was observed in the transmission spectra, suggesting a widening of the view angle. A similar result can be seen in FIG. 60, plot b for an example HPDLC filter element with a 20° view angle, but in this case the reflection efficiency is dramatically decreased and a widening of the FWHM is exhibited.

The example HPDLC tunable filter stack may be utilized in an example hyperspectral imaging system, with the above-described drive and detection electronics, to spectrally multiplex acquired hyperspectral imaging data. The electro-optic performance of the example HPDLC tunable filter stack in this application can be and be tested and analyzed using the above-described equipment and techniques. In an example testing scenario, a 633 nm He—Ne laser was transmitted through an example thiolene based HPDLC tunable filter stack operating in the 600-700 nm wavelength range and comprising ten HPDLC filter elements. The HPDLC filter elements were modulated at different respective frequencies. One of the HPDLC filter elements comprises a notch at 633 nm wavelength. The multiplexed output of the each HPDLC element of the example HPDLC tunable filter stack was collected on the photodiode and was made available on a respective one of ten different channels for synchronous detection and demodulation.

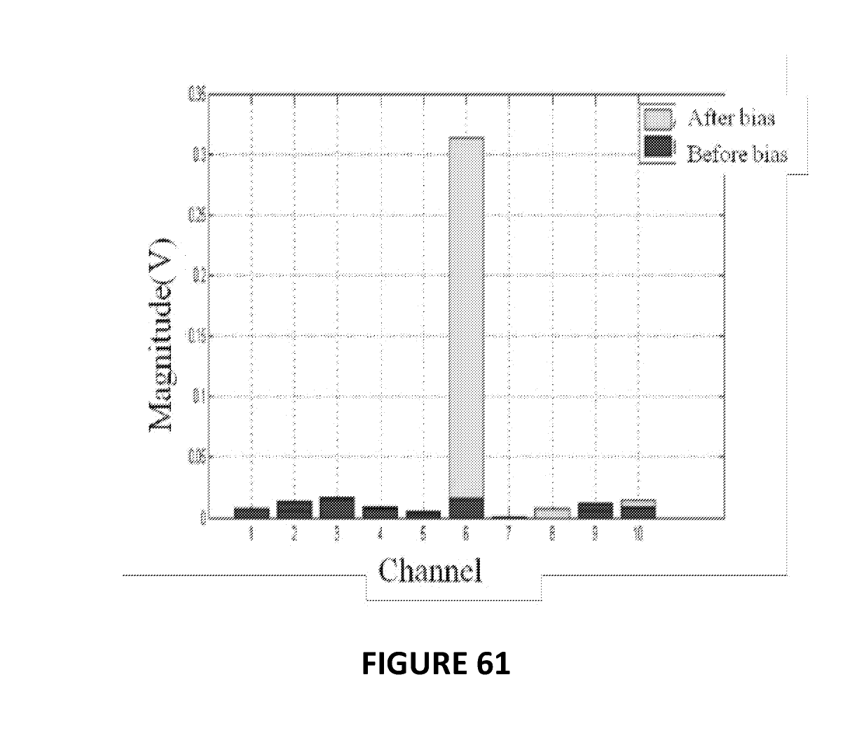

FIG. 61 illustrates the demodulated signal for all ten HPDLC element filters when subjected to the monochromatic light source resonant with the HPDLC tunable filter operating at channel 6. A distinct rise in the channel 6 signal is exhibited, suggesting detection of the transmitted 633 nm He—Ne wavelength, while little signal is seen on the non-resonant channels. This demonstrates the ability of the example HPDLC tunable filter stack to detect the incoming wavelength signal while remaining unaffected by the other modulating filters. The hyperspectral cube can be extracted from the modulated image.

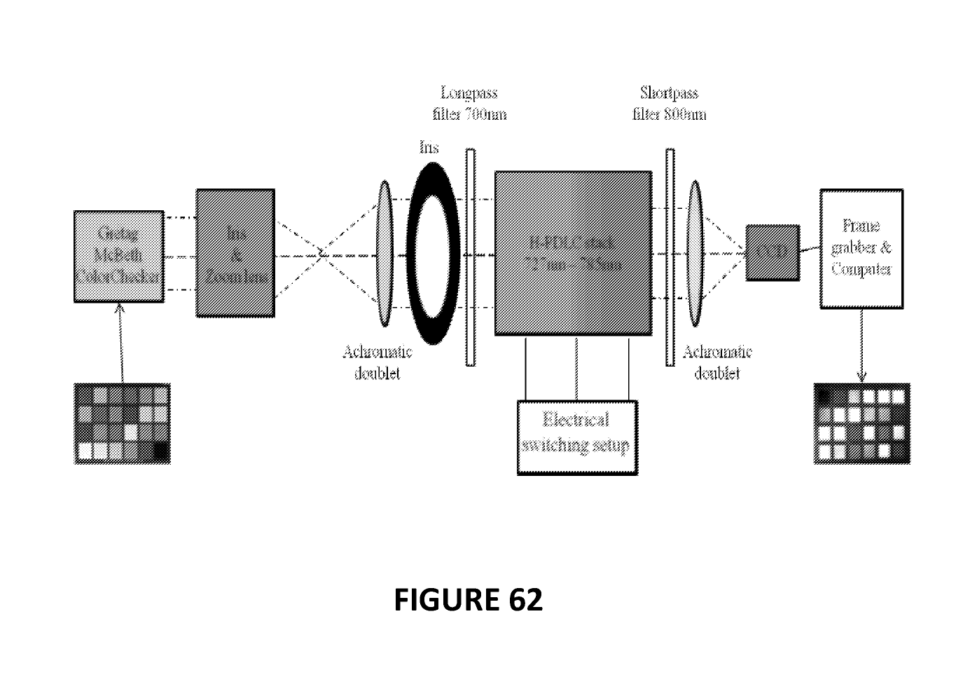

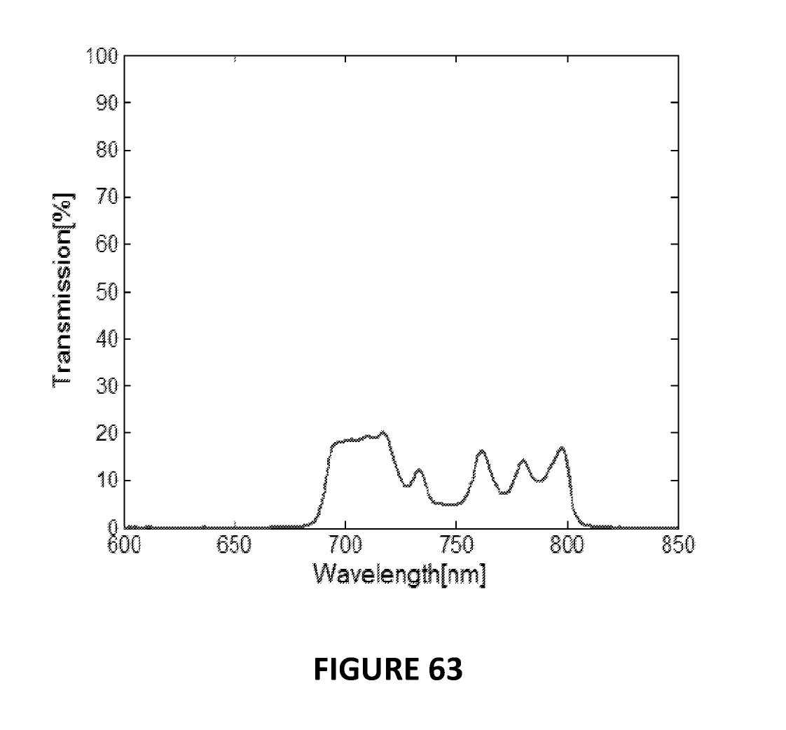

In another example testing scenario, the HPDLC filter elements of the example HPDLC tunable filter stack can be sequentially switched during acquisition of hyperspectral imaging data. To facilitate sequential switching and acquisition of hyperspectral imaging data, the hyperspectral imaging system can be modified to incorporate the McBeth color chart and short pass and long pass filters with cut offs at 800 nm and 700 nm, respectively. A schematic of this system is depicted in FIG. 62. FIG. 63 illustrates a composite transmission spectra of an example HPDLC tunable filter stack comprising five HPDLC filter elements, along with the short and long pass filters.

The McBeth color checker chart is an industry standard that provides a non-subjective comparison with a test pattern of 24 scientifically prepared colored squares. Each color square represents a natural object, such as human skin, foliage, blue sky, etc., thereby providing a qualitative reference to quantifiable values. Each color will reflect light in the same way in all parts of the visible spectrum, thus maintaining color consistency over different illumination options.

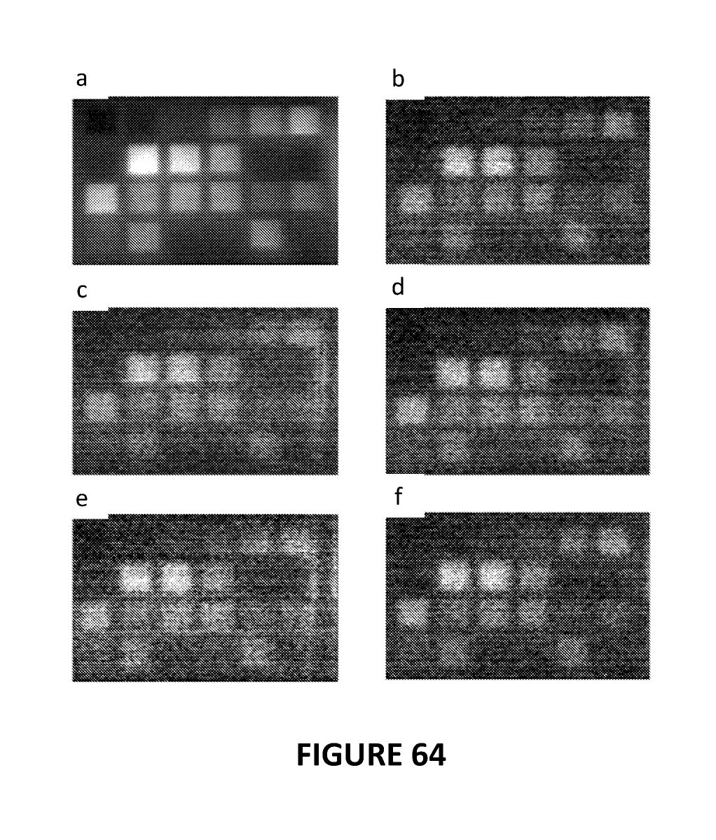

During testing, each HPDLC filter element in the stack was sequentially switched in order to acquire an image of the color checker chart at that respective wavelength. FIG. 64, plots a-f illustrate images of the McBeth chart acquired at different wavelengths. More specifically, FIG. 64, plot a depicts an image of the color checker in the 700 nm-800 nm visible range, FIG. 64, plot b depicts an image of the color checker at 727 nm, FIG. 64, plot c depicts an image of the color checker at 741 nm, FIG. 64, plot d depicts an image of the color checker at 751 nm, FIG. 64, plot e depicts an image of the color checker at 769 nm, and FIG. 64, plot f depicts an image of the color checker at 785 nm. These images form the basis of a hyper spectral cube which allows plotting of the spectra of a particular entity in the images at various wavelengths.

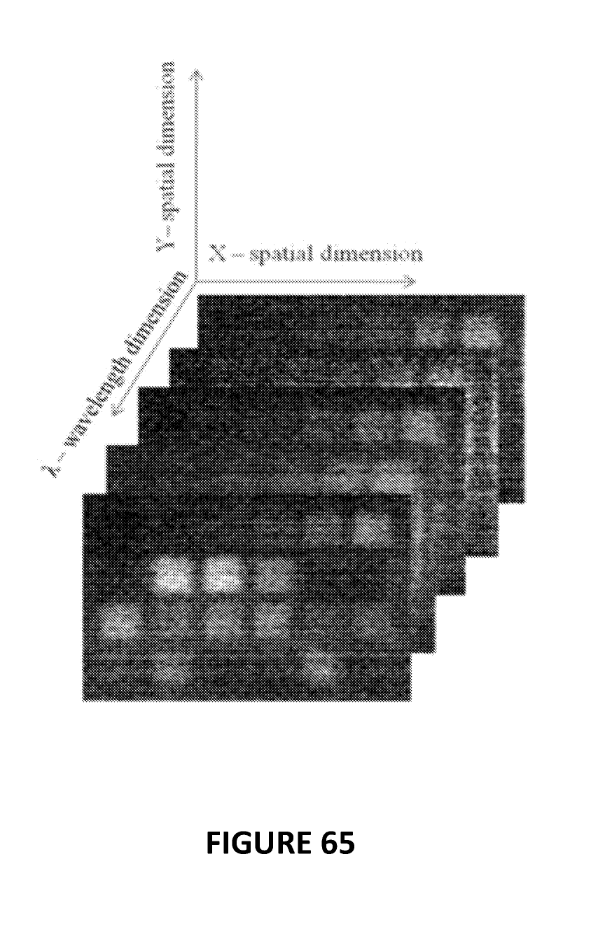

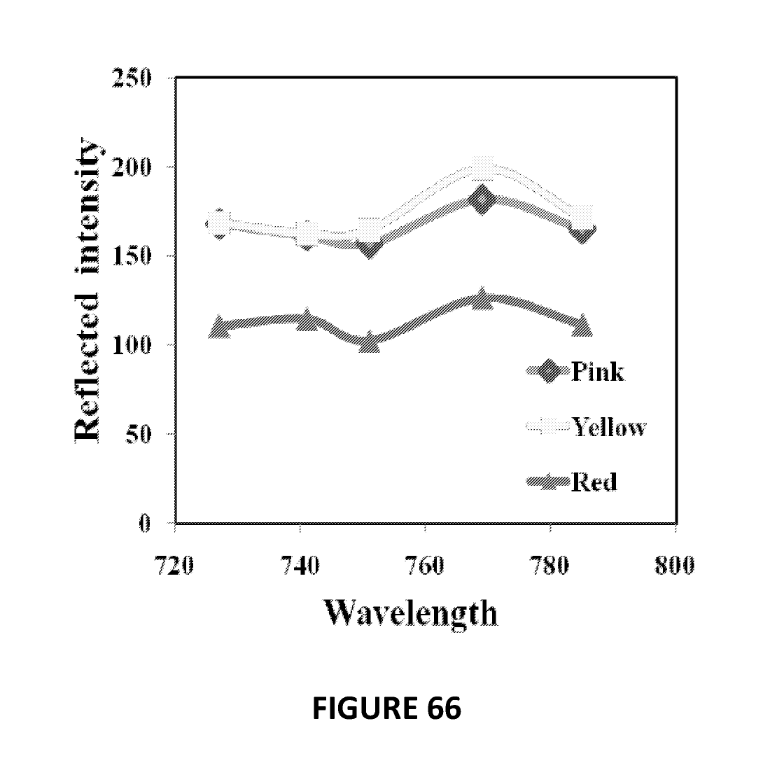

FIG. 65 illustrates a hyperspectral cube formed from hyperspectral imaging data acquired through the example HPDLC tunable filter stack via sequential switching. This figure illustrates three dimensions where x and y are the spatial dimensions and λ is the wavelength dimension. FIG. 66 depicts reflectance extracted from the hyperspectral cube for three different colors pink, red and yellow at 727 nm, 741 nm, 751 nm, 769 nm, and 785 nm. This kind of reflectance spectra enables identification of specific materials in the image. Of course in a real world application, reflectance due to atmosphere has to be accounted for while plotting the actual reflectance spectra of the desired object in the image.

Undesirable characteristics exhibited by an HPDLC tunable filter stack, for instance wavelength dependent scattering, especially at lower wavelengths, and/or out of band increase in transmission after switching needs, may be mitigated by fabricating HPDLC filter elements with close to 100% reflection efficiencies, in which case the LC droplet size in the polymer matrix can be well below the critical limit for scattering. HPDLC filter elements with close to 100% reflection efficiencies may exhibit increased switching voltage and/or faster switching times, while maintaining polarization insensitivity.

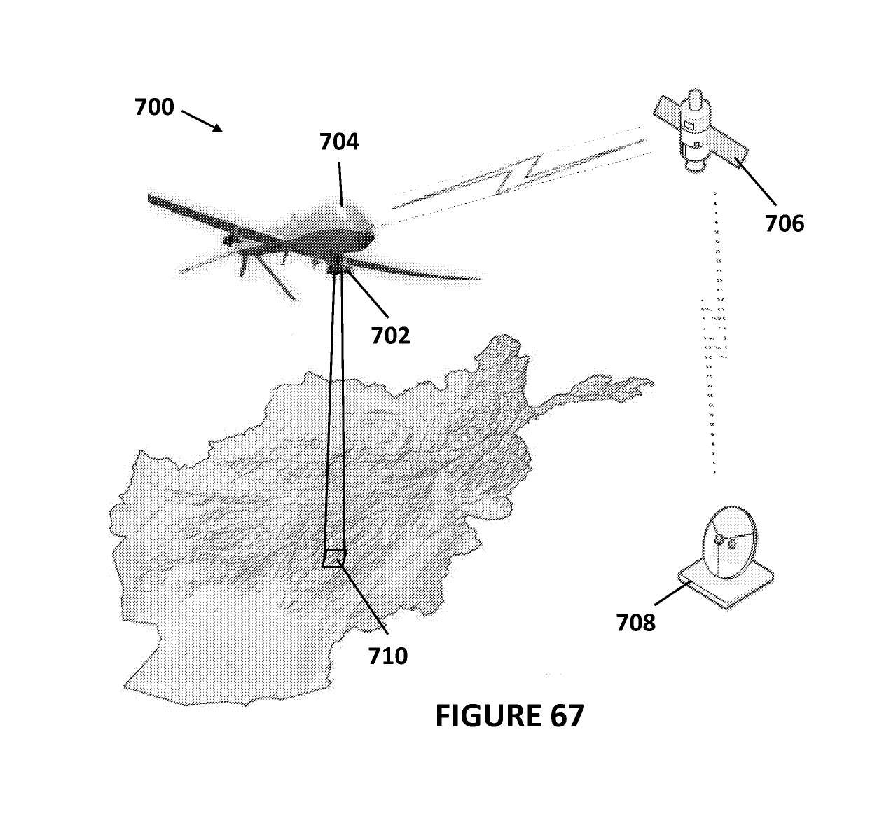

In an example application of the HPDLC tunable filter stack utilized for hyperspectral imaging (HSI), a hyperspectral imager comprising an HPDLC tunable filter stack can be mounted to a moving platform. FIG. 67 depicts a hyperspectral imaging system 700 that includes a hyper spectral imager 702 mounted to a moving platform 704. The hyperspectral imager 702 can be configured to be carried by the platform 704, for instance to facilitate remote acquisition of hyperspectral imaging data. For example, in accordance with the illustrated embodiment, the hyper spectral imager 702 can be mounted to a moving platform 304 configured to facilitate airborne acquisition of hyperspectral imaging data, such as the depicted moving platform 704 in the form of unmanned aerial vehicle (UAV). The hyper spectral imager 702 can comprise at least one HPDLC tunable filter stack. That is, the hyper spectral imager 702 can comprise a single HPDLC tunable filter stack. Alternatively, the hyper spectral imager 702 can comprise an HPDLC tunable filter comprising a plurality of HPDLC tunable filter stacks, such as discrete HPDLC tunable filter stacks, each stack configured to facilitate acquisition of hyperspectral imaging data throughout a discrete spectrum of wavelengths.

The example HPDLC tunable filter stack of the hyperspectral imager 702 can be fabricated to facilitate the acquisition of hyperspectral imaging data, for instance pertaining to a scene of interest 710, throughout the near infrared wavelength range (e.g., approximately 780 nm to approximately 3 μm), but the HPDLC tunable filter stack can alternatively be fabricated to facilitate the acquisition of hyperspectral imaging data pertaining to a scene of interest 310 in and/or throughout frequency bands in the visible wavelength range (e.g., approximately 390 nm to approximately 780 nm), the near infrared range (e.g., approximately 780 nm to approximately 3 μm), and at least a portion of the mid infrared wavelength range (e.g., approximately 3 μm to approximately 12 μm) in any combination. It should be appreciated that the HPDLC tunable filter stack can be fabricated to facilitate the acquisition of hyperspectral imaging data pertaining to a scene of interest 710 within the mid infrared range (e.g., approximately 12 μm to approximately 50 μm), and/or the far infrared range (e.g., approximately 50 μm to approximately 1000 μm), however absorption characteristics attributable to the chemical composition of the polymer layers may at least partially hinder performance of the HPDLC tunable filter stack.

The hyperspectral imaging system 700 can further comprise one or more communication relay devices, for instance the satellite 706 and/or the ground based antenna 708. In accordance with the illustrated embodiment, the hyperspectral imager 702 can be mounted to the moving platform 704 such that the hyperspectral imager 702 can acquire imaging data from a scene of interest 710, such as a portion of terrain over which the UAV is flying. The hyperspectral imager 702 can be attached to the moving platform 704 such that the hyperspectral imager 302 can maintain focus on a particular scene of interest 710, for instance by enabling rotation along multiple axes of the hyperspectral imager 702 relative to the moving platform 704.

Hyperspectral imaging data acquired by the hyperspectral imager 702 can be analyzed and transmitted to interested parties via communication relay devices such as the satellite 306 and/or the ground based antenna 708. For instance, hyperspectral imaging data can be acquired by the hyperspectral imager 702 and transmitted directly by the moving platform 304 to the ground based antenna 708 for subsequent analysis. Alternatively, the hyperspectral imaging data can be acquired by the hyperspectral imager 702 and transmitted to the ground based antenna 708 via the satellite 706. It should be appreciated that the hyperspectral imaging system 700 is not limited to the illustrated configuration, and that the hyperspectral imaging system 700 can be differently configured as desired. For instance, the acquired hyperspectral imaging data can be analyzed by the moving platform 704, and can be transmitted using different communication relay devices, etc. It should further be appreciated that the hyperspectral imaging system 700 is not limited to the illustrated moving platform 704, and that the hyperspectral imaging system 700 can alternatively be configured with any other suitable moving platform 704, or any suitable stationary platform, as desired.

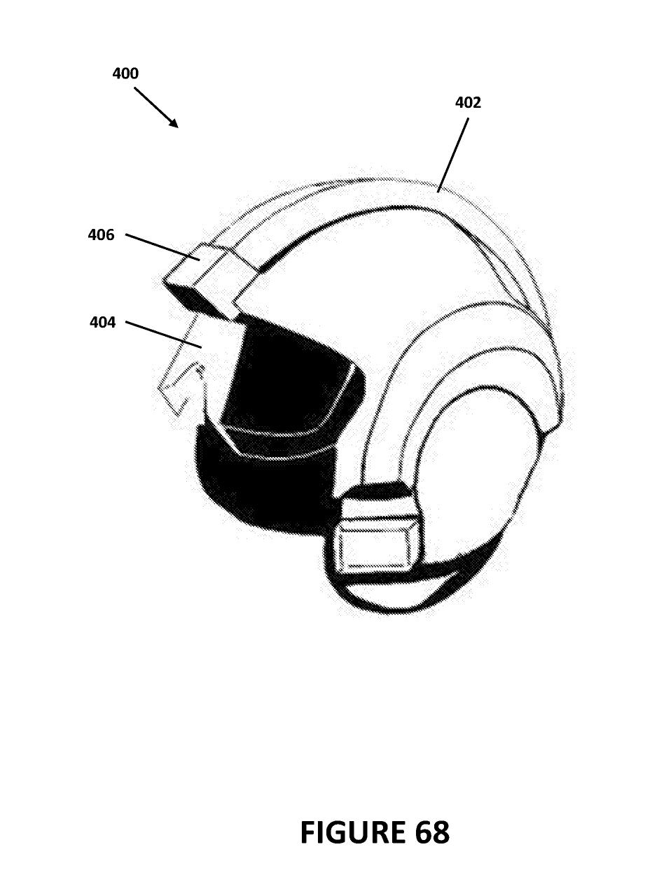

In another example application, an HPDLC tunable filter stack may be fabricated as a high-speed switchable optical shield. For example, FIG. 68 depicts a switchable optical shielding system 400 comprising an aviator helmet 402 and a visor 404 that utilizes an HPDLC tunable filter stack. In an alternative embodiment, the aviator helmet 402 can be omitted from the switchable optical shielding system 400. The visor 404 can comprise at least one, such as a plurality of HPDLC tunable filter stacks integrated with the visor 404. For instance, the at least one HPDLC tunable filter stack can be applied (e.g., adhered) to a portion, such as an entirety of a surface of the visor 404, for instance a portion, such as the entirety of the inner surface of the visor 404, a portion, such as the entirety of the outer surface of the visor 404, or any combination thereof. The at least one HPDLC tunable filter stack can be adhered to a respective surface of the visor 404 as a coating. The at least one HPDLC tunable filter stack can comprise a single HPDLC tunable filter stack sized and shaped to coat a respective surface of the visor 404. Alternatively, the at least one HPDLC tunable filter stack can comprise a plurality of HPDLC tunable filter stacks adhered to respective portions of a surface of the visor 404, thereby covering discrete portions of, or the entirety of, the respective surface of the visor 404. For example the at least one HPDLC tunable filter stack can comprise a plurality of HPDLC tunable filter stacks disposed adjacent to one another along a surface of the visor 404. The at least one HPDLC tunable filter stack can be fabricated to conform to the respective surface geometries of the visor 404. For instance, the HPDLC filter elements of the stack can be fabricated with curved Bragg gratings, as described herein elsewhere.

In accordance with the illustrated embodiment, the at least one HPDLC tunable filter stack of the switchable optical shielding system 400 is switchable between transparent and reflective states, as described in more detail below. When the at least one HPDLC tunable filter stack is switched into the reflective state, the HPDLC tunable filter stack can reflect light incident on the visor 404 throughout the visible wavelength range (e.g., approximately 390 nm to approximately 780 nm) and the near infrared wavelength range (e.g., approximately 780 nm to approximately 1.2 μm), that is through an effective wavelength range of approximately 390 nm to approximately 1.2 μm, but the at least one HPDLC tunable filter stack can alternatively be fabricated to reflect incident light in and/or throughout the visible wavelength range (e.g., approximately 390 nm to approximately 780 nm), the near infrared range (e.g., approximately 780 nm to approximately 3 μm), and at least a portion of the mid infrared wavelength range (e.g., approximately 3 μm to approximately 12 μm) in any combination. It should be appreciated that the at least one HPDLC tunable filter stack can be fabricated to reflect incident light within the mid infrared range (e.g., approximately 12 μm to approximately 50 μm) and/or the far infrared range (e.g., approximately 50 μm to approximately 1000 μm), however absorption characteristics attributable to the chemical composition of the polymer layers may at least partially hinder performance of the at least one HPDLC tunable filter stack.

The at least one HPDLC tunable filter stack exhibits switching response times of approximately 20 μs. In other words, the at least one HPDLC tunable filter stack can be switched from the transparent state to the reflective state in approximately 20 μs, and from the reflective state to the transparent state in approximately 20 μs. It should be appreciated that the switchable optical shielding system 400 is not limited to switching response times of approximately 20 μs, and that the at least one HPDLC tunable filter stack can alternatively be fabricated to exhibit faster switching times. For example, switching times of approximately 1 μs to 2 μs can be achieved by doping the prepolymer mixture of the HPDLC filter elements with carbon based nanoparticles during fabrication.

The at least one HPDLC tunable filter stack may be placed in electrical communication with a power source, for instance a power source provided to the helmet 402. The power source can be configured to simultaneously apply respective switching voltages to each of the respective HPDLC filter elements comprising the HPDLC tunable filter stack, such that the at least one HPDLC tunable filter stack can be maintained in the transparent, completely biased state, so as to allow light incident on the visor 404 to pass through to a wearer of the helmet 402. The switchable optical shielding system 400 can be configured to receive a switching signal, for example a switching signal generated by a sensor 406 communicatively coupled to the visor 404, and in particular to the at least one HPDLC tunable filter stack. In accordance with the illustrated embodiment, the sensor 406 can be attached to or integral to the helmet 402. Upon receiving the switching signal, the switchable optical shielding system 400 can at least temporarily interrupt the delivery of power to one or more HPDLC filter elements of the at least one HPDLC tunable filter stack, thereby causing the at least one, such as all of the HPDLC filter elements of the HPDLC tunable filter stack to switch from the transparent state to the reflective state and to reflect respective wavelengths of light incident upon the visor 404.

The power to the HPDLC tunable filter stack may be interrupted for a predetermined amount of time, for instance an interval of time adequate to allow a sudden high intensity flash of light to mitigate, thereby causing the at least one HPDLC tunable filter stack to switch from the transparent state to the reflective state and to act as an optical shield relative to the wearer of the helmet 402. It should be appreciated that the sensor 406 need not be attached to or integral to the helmet 402, and that the sensor 406 can alternatively be attached to or integral to an aircraft associated with the helmet 402, can be attached to or integral to the visor 404, or can be located remotely and can transmit the switching signal to the switchable optical shielding system 400. It should further be appreciated that the switchable optical shielding system 400 is not limited to a single sensor 406. For instance, the switchable optical shielding system 400 can comprise a plurality of sensors 406, such as an array of redundant sensors, wherein sensors of the array can be attached to or integral to the helmet 402, attached to or integral to an aircraft associated with the helmet 402, attached to or integral to the visor 404, located remotely, or any combination thereof

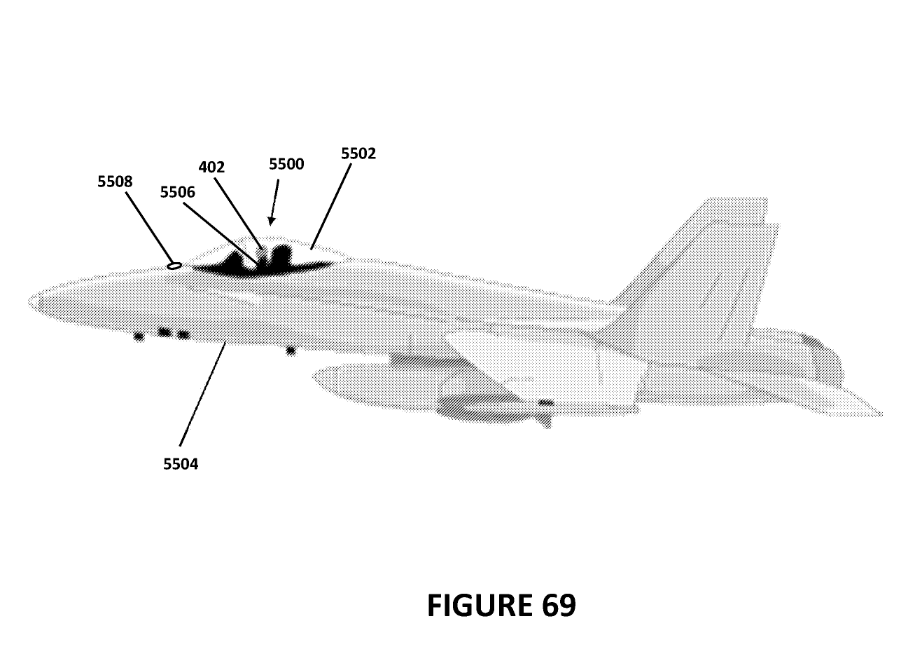

FIG. 69 illustrates another example embodiment of a high-speed switchable optical shielding system 5500 comprising an aircraft canopy 5502 that utilizes at least one HPDLC tunable filter stack. The aircraft canopy 5502 can be mounted to an aircraft 5504 and operate as a transparent enclosure over the cockpit of the aircraft 5504. Typically, the function of an aircraft canopy is to provide a weatherproof and reasonably quiet environment for the aircraft's occupants, such as the pilot, co-pilot, and the like. FIG. 69 depicts an example canopy 5502 shaped for use with the military aircraft 5504, but it should be appreciated that the canopy 5502 can be alternatively sized and/or shaped for use with any other type of aircraft as desired. The illustrated canopy 502 can comprise at least one, such as a plurality of HPDLC tunable filter stacks integrated with the canopy 502. For instance, the at least one HPDLC tunable filter stack can be applied (e.g., adhered) to a portion, such as an entirety of a surface of the canopy 5502, for instance a portion, such as the entirety of the inner surface of the canopy 5502, a portion, such as the entirety of the outer surface of the canopy 5502, or any combination thereof. The at least one HPDLC tunable filter stack can be adhered to a respective surface of the canopy 5502 as a coating. The at least one HPDLC tunable filter stack can comprise a single HPDLC tunable filter stack sized and shaped to coat a respective surface of the canopy 5502. Alternatively, the at least one HPDLC tunable filter stack can comprise a plurality of HPDLC tunable filter stacks adhered to respective portions of a surface of the canopy 5502, thereby covering discrete portions of, or the entirety of, the respective surface of the canopy 5502. For example the at least one HPDLC tunable filter stack can comprise a plurality of HPDLC tunable filter stacks disposed adjacent to one another along a surface of the canopy 5502. The at least one HPDLC tunable filter stack can be fabricated to conform to the respective surface geometries of the canopy 5502. For instance, the HPDLC filter elements of the stack can be fabricated with curved Bragg gratings, as described herein elsewhere.

In accordance with the illustrated embodiment, the at least one HPDLC tunable filter stack of the switchable optical shielding system 5500 is switchable between transparent and reflective states, as described in more detail below. When the at least one HPDLC tunable filter stack is switched into the reflective state, the HPDLC tunable filter stack may reflect light incident on the canopy 5502 throughout the visible wavelength range (e.g., approximately 390 nm to approximately 780 nm), the near infrared wavelength range (e.g., approximately 780 nm to approximately 3 μm), and the infrared wavelength range (e.g., approximately 3 μm to approximately 12 μm), that is through an effective wavelength range of approximately 390 nm to approximately 12 μm, but the at least one HPDLC tunable filter stack may alternatively be fabricated to reflect incident light in and/or throughout the visible wavelength range (e.g., approximately 390 nm to approximately 780 nm), the near infrared range (e.g., approximately 780 nm to 3 μm), and at least a portion of the mid infrared wavelength range (e.g., approximately 3 μm to approximately 12 μm) in any combination. It should be appreciated that the at least one HPDLC tunable filter stack can be fabricated to reflect incident light within the mid infrared range (e.g., approximately 12 μm to approximately 50 μm), and/or the far infrared range (e.g., approximately 50 μm to approximately 1000 μm).

The at least one HPDLC tunable filter stack exhibits switching response times of approximately 20 μs. In other words, the at least one HPDLC tunable filter stack can be switched from the transparent state to the reflective state in approximately 20 μs, and from the reflective state to the transparent state in approximately 20 μs. It should be appreciated that the switchable optical shielding system 5500 is not limited to switching response times of approximately 20 μs, and that the at least one HPDLC tunable filter stack can alternatively be fabricated to exhibit faster switching times. For example, switching times of approximately 1 μs to 2 μs can be achieved by doping the prepolymer mixture of the HPDLC filter elements with carbon based nanoparticles during fabrication.

The at least one HPDLC tunable filter stack can be placed in electrical communication with a power source, for instance a power source provided to the canopy 5502 by the aircraft 5504. The power source can be configured to simultaneously apply respective switching voltages to each of the respective HPDLC filter elements comprising the HPDLC tunable filter stack, such that the at least one HPDLC tunable filter stack can be maintained in the transparent, completely biased state, so as to allow light incident on the canopy 5502 to pass through to occupants, such as a pilot 5506 of the aircraft 5504. The switchable optical shielding system 5500 can be configured to receive a switching signal, for example a switching signal generated by a sensor 5508, for instance a sensor communicatively coupled to the canopy 5502, and in particular to the at least one HPDLC tunable filter stack. In accordance with the illustrated embodiment, the sensor 5508 can be attached to or integral to the aircraft 5504. The sensor 5508 can be configured to transmit a switching signal to the at least one HPDLC tunable filter stack in response to a trigger. For example, the sensor 5508 can be triggered to transmit a switching signal to the at least one HPDLC tunable filter stack when light of a particular wavelength is sensed by the sensor 5508. Upon receiving the switching signal, the switchable optical shielding system 5500 can at least temporarily interrupt the delivery of power to one or more HPDLC filter elements of the at least one HPDLC tunable filter stack, thereby causing the at least one, such as all of the HPDLC filter elements of the HPDLC tunable filter stack to switch from the transparent state to the reflective state and to reflect respective wavelengths of light incident upon the canopy 5502.

The power to the HPDLC tunable filter stack can be interrupted for a predetermined amount of time, for instance an interval of time adequate to allow a sudden high intensity flash of light to mitigate, thereby causing the at least one HPDLC tunable filter stack to switch from the transparent state to the reflective state and to act as an optical shield relative to occupants of the aircraft 5504, such as the pilot 5506. It should be appreciated that the sensor 508 need not be attached to or integral with the aircraft 5504, and that the sensor 5508 can alternatively be attached to or integral to an article supported by an occupant of the aircraft, such as a helmet 402 worn by the pilot 5506, or can be located remotely and can transmit the switching signal to the switchable optical shielding system 500. It should further be appreciated that the switchable optical shielding system 5500 is not limited to a single sensor 5508. For instance, the switchable optical shielding system 5500 can comprise a plurality of sensors, such as an array of redundant sensors, wherein sensors of the array can be attached to or integral with the aircraft 504, attached to or integral with an article supported by an occupant, located remotely, or any combination thereof. It should further still be appreciated that one or more components of the switchable optical shielding systems 400, 5500 can be configured to operate in concert with one another. For instance, HPDLC tunable filter stacks attached to the visor 404 and the canopy 5502 can be switched simultaneously, for instance in response to a common switching signal, thereby providing redundant optical shielding to occupants in the aircraft wearing the helmet 402 and at least partially surrounded by the canopy 5502.

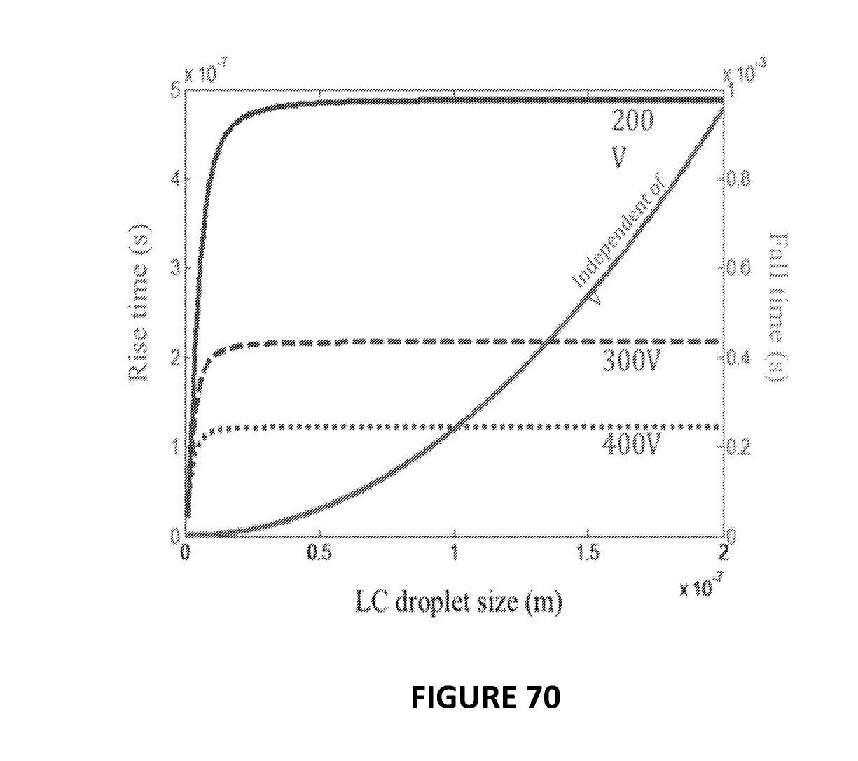

FIG. 70 is a graph of example estimated rise and fall times of a HPDLC at different applied voltages and for various droplet sizes. To reduce the size of the LC droplet to reach nanosecond switching time, the rate of polymerization of HPDLC may be increased, thus reducing the amount of polymerization time. Short phase separation time may lead to smaller droplets. Short phase separation time may lead to reduced scattering. In an example embodiment, a thiolene-based material set may be used. Various example additives may be included for rapid polymerization during exposure. Depending upon the amount of phase separation and droplet coalescence, the reflection efficiency and the switching speed may be experimentally determined. From FIG. 70 it is evident that a diameter of an LC droplet size of about 25 nanometers (nm) may yield around 100 ns on time and 15 μs off time at 400 V. In addition, doping of the liquid crystal with a compatible high dielectric anisotropy compound may further enhance the switching speed and also help lowering the switching voltages.

In an example embodiment, a HPDLC may be doped with medium oxidized multiwalled carbon nanotubes (MWNT). The MWNT dopants may have two primary effects on the HPDLC: a reduction in liquid crystal droplet size and a change in the dielectric properties of the medium.

The MWNT doped HPDLCs may be formed from a thiolene based homogeneous blend of materials. For example, a blend of Norland Optical Adhesive 65, liquid crystal BL038, and a photoinitiator to sensitize the optical adhesive to visible wavelengths may be used. The MWNT may be added to the liquid crystal and thoroughly dispersed before the other ingredients are added to the blend. The MWNT used may be, for example, between about 5 μm and about 10 μm in length and may have an outer diameter of about 20 nm. The choice of size of MWNT may ensure that the diffusion constant of the MWNT is below that of the polymer and LC components. The conductivity of the MWNT may be about 10³ siemens per centimeter (S/cm), for example. The blend may then be sandwiched between two ITO coated glass slides spaced about 20 μm apart, for example.

The blend may then be exposed to an interference pattern generated by two laser beams. This interference pattern may be recorded in the sample to form a Bragg grating. The sample may then be cured under a UV lamp for about five minutes, for example, to polymerize any remnant monomers. The reflection efficiency as well as the capacitance and resistivity of the cells may vary depending on the concentration of MWNT used. High amounts of randomly aligned MWNTs may increase the probability of forming an electrical short between the ITO coated electrodes. A continuous drop in resistivity of the cells may be observed with increasing amounts of MWNTs. A change in the capacitance and resistivity may be indicative of a change in the dielectric properties of the HPDLC medium and hence for a given applied voltage a stronger electric field may be experienced by the LC droplets in the HPDLC cell.

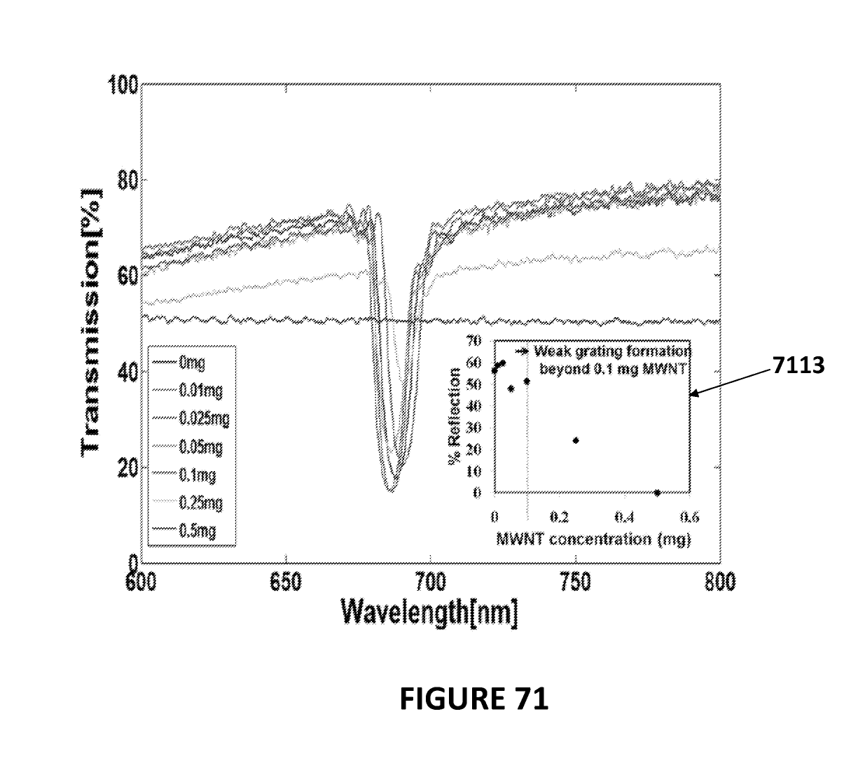

FIG. 71 illustrates an example transmission spectra of HPDLC reflection gratings with various concentrations of MWNT. The inset plot 7113 illustrates a decrease in reflection efficiency with increasing MWNT amount.

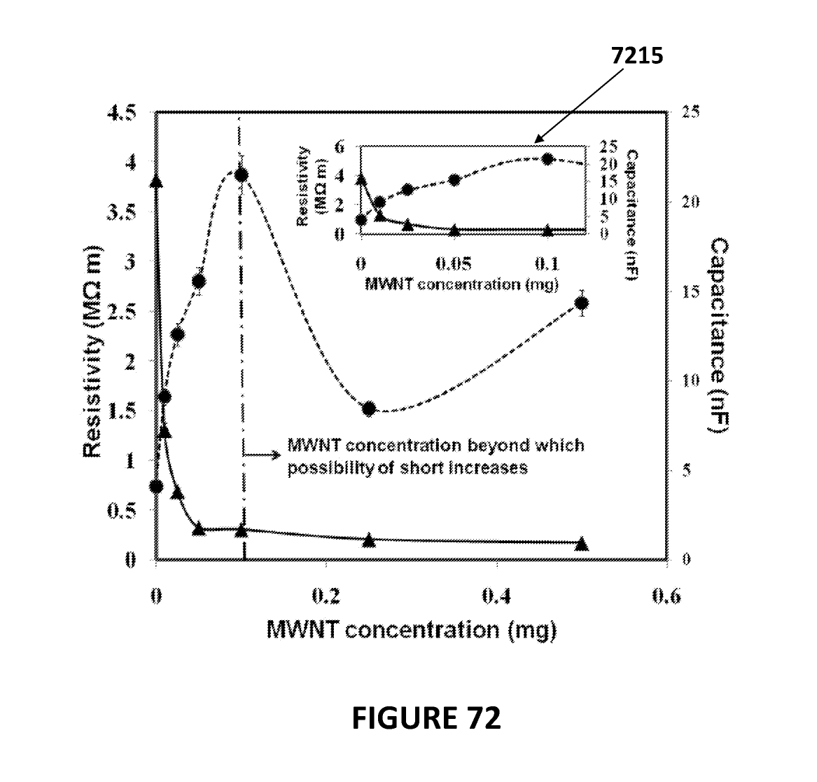

FIG. 72 illustrates plots depicting example changes in capacitance and resistivity of the HPDLC reflection gratings with MWNT at a driving frequency of 1 kHz. The inset plot 7215 shows the range of MWNT concentration in which no shorting of the ITO electrodes is observed. The circles represent capacitance and the triangles represent resistivity.

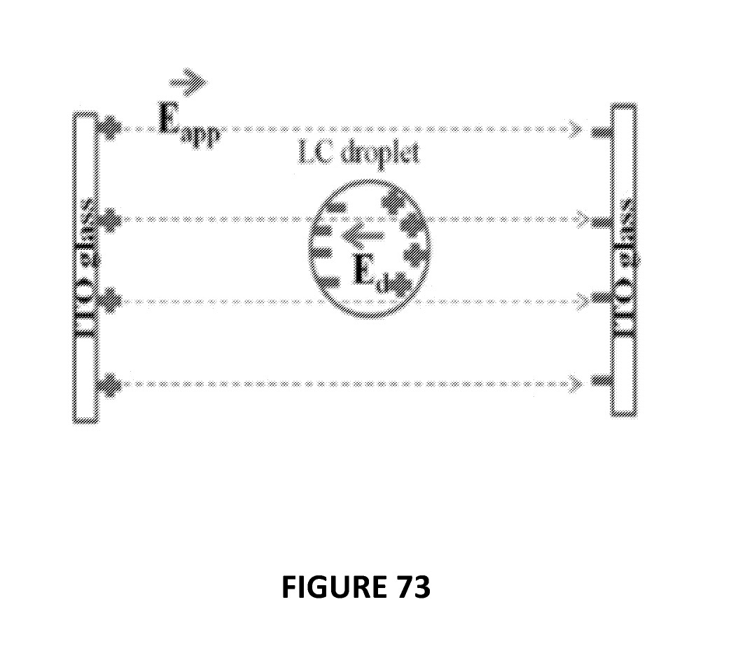

FIG. 73 is a schematic depicting an example applied electric field across an isolated LC droplet in a polymer matrix. E_{d} is the depolarizing field generated by the LC droplet.

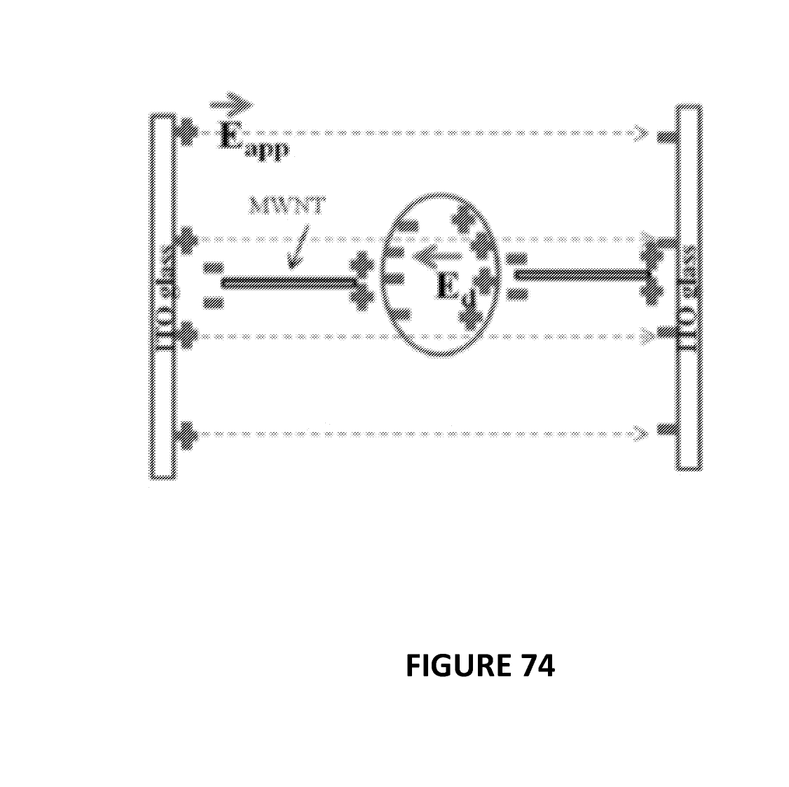

FIG. 74 is a schematic depicting an example applied electric field across an isolated LC droplet in a polymer matrix in the presence of MWNT enhancing the local electric field across the LC droplet. E_{d} is the depolarizing field generated by the LC droplet. As depicted in this scenario, the MWNT is aligned on either side of the LC droplet. In the presence of a MWNT in the vicinity of the LC droplet, the local electric field across the LC droplet may be enhanced, virtually bringing the electrodes close to the LC droplet as shown in FIG. 74. This local enhancement of the electric field across the droplet may cause a reduction in switching voltage. The concentration of MWNT may be below the percolation level such that shorting between the glass electrodes does not occur.

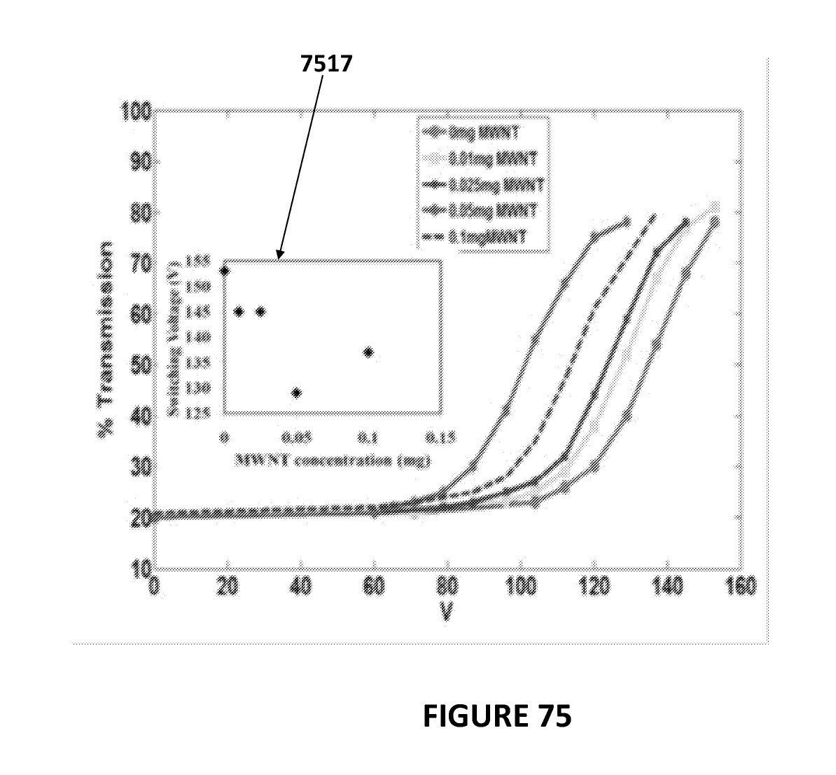

FIG. 75 illustrates example transmission as a function of applied voltage plots for various concentrations of MWNT. The inset plot 7517 shows a reduction in switching voltage with increasing amount of MWNT.

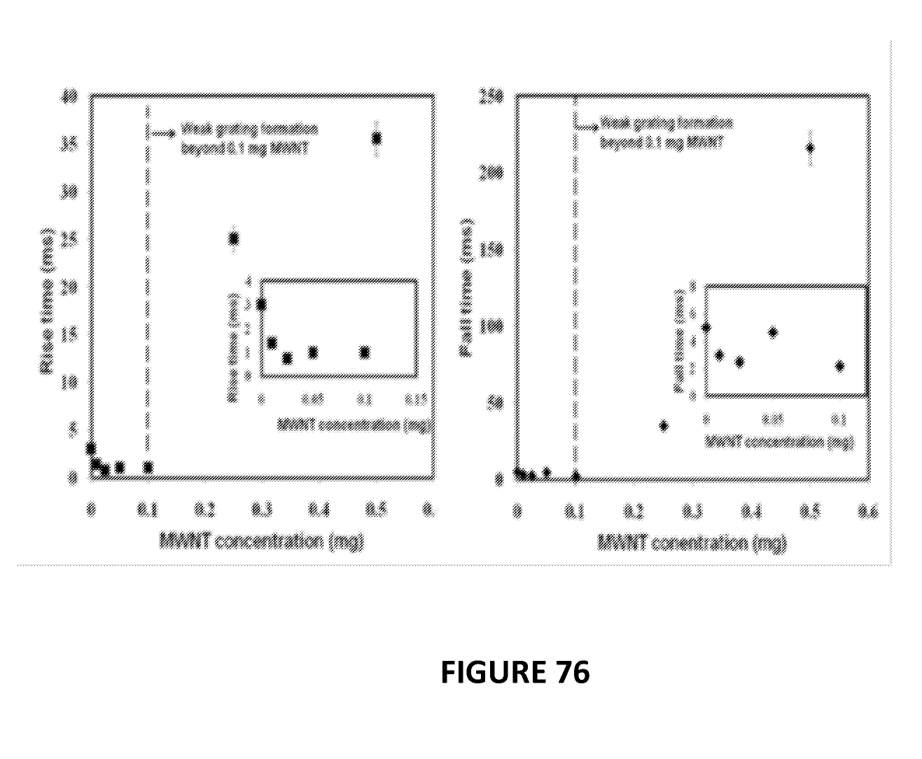

FIG. 76 illustrates example rise and fall time measurements of HPDLC reflection gratings with various concentrations of MWNT. The inset plots show the rise and fall time readings up to 0.1 mg MWNT. A reduction in switching time is also observed, as shown in FIG. 76. In HPDLC systems the rise time may be dependent upon the applied electric field and LC droplet size. All samples were switched at 137 V. The fall time is dependent on the droplet size and the viscoelastic coefficient of the LC. A reduction of both rise and fall time is indicative of the formation of smaller LC droplets. A decrease in both these parameters occurs up to a doping level of 0.1 mg but beyond this the rise and fall time dramatically increases at concentrations of 0.25 mg and 0.5 mg. The error bars in FIG. 76 indicate 5% error in each data point.

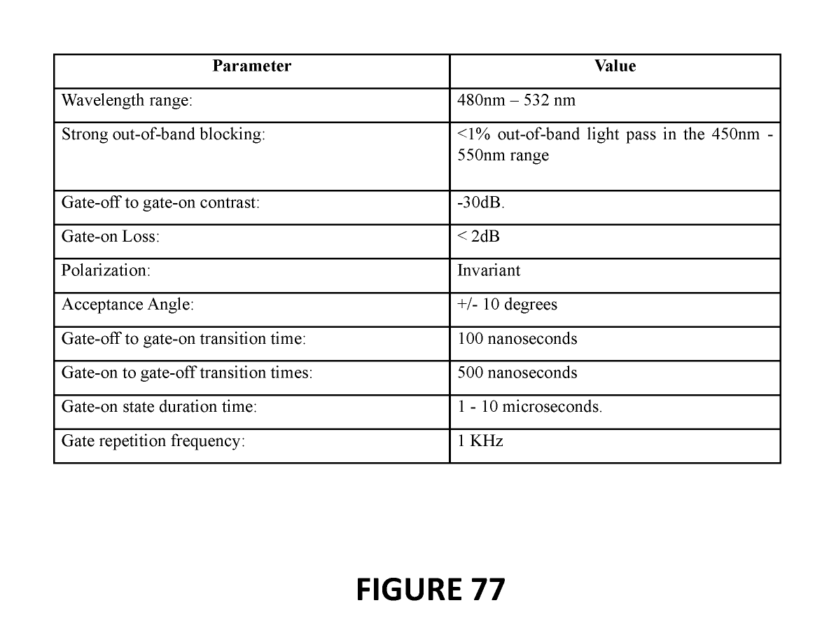

FIG. 77 is a chart depicting various example characteristics of a Holographic Optical Element (HOE) comprising a high switching speed HPDLC as described herein. In various example embodiments, a large-area switchable Holographic Optical Element (HOE) may be formed from stacked HPDLC gratings. A specific focus may be built into each grating layer. By overlaying several of these films with different focal points, a single collection mirror may be constructed that can electrically switch between focal points, thereby enabling beam collection to be steered between multiple instruments without incorporating moving parts. In addition, a ‘chopper’ function may be employed to allow multiple simultaneous measurements. An application for such a HOE may include light detection and ranging (LIDAR).

Although the tunable electro-optic filter stack has been described herein with reference to preferred embodiments and/or preferred methods, it should be understood that the words which have been used herein are words of description and illustration, rather than words of limitation, and that the scope of the instant disclosure is not intended to be limited to those particulars, but rather is meant to extend to all structures, methods, and/or uses of the herein described tunable electro-optic filter stack. Those skilled in the relevant art, having the benefit of the teachings of this specification, may effect numerous modifications to the tunable electro-optic filter stack as described herein, and changes may be made without departing from the scope and spirit of the instant disclosure, for instance as recited in the appended claims.

What is claimed is:

1. A hyperspectral holographic polymer dispersed liquid crystal medium comprising:
a liquid crystal phase comprising stratified layers of dispersed droplets within a continuous polymer phase; and
a dopant comprising piezoelectric nanoparticles or semiconductor nanoparticles, wherein the dopant has been dispersed within the polymer phase;
the holographic polymer dispersed liquid crystal medium exhibiting:
a hyperspectral continuum of peak reflective wavelengths exhibiting a uniform reflectance and ranging from a first peak reflective wavelength indicative of a first end of the spectrum to a second peak reflective wavelength indicative of a second end of the spectrum, inclusively, wherein:
each and every point of the hyperspectral continuum of peak reflective wavelengths is indicative of a peak of a respective wavelength of a respective reflection grating; and
the hyperspectral continuum of peak reflective wavelengths is electrically controllable; and wherein
(a) the hyperspectral holographic polymer dispersed liquid crystal medium exhibits a switching speed from a transparent state to a reflective state on an order of nanoseconds; or
(b) the hyperspectral holographic polymer dispersed liquid crystal medium exhibits a switching speed from a reflective state to a transparent state on an order of microseconds; or
(c) both (a) and (b).

2. The hyperspectral holographic polymer dispersed liquid crystal medium of claim 1, wherein the dopant further comprises a dielectric dopant.

3. The hyperspectral holographic polymer dispersed liquid crystal medium of claim 1, wherein the dopant comprises piezoelectric nanoparticles.

4. The hyperspectral holographic polymer dispersed liquid crystal medium of claim 1, wherein the dopant comprises semiconductor nanoparticles.

5. The hyperspectral holographic polymer dispersed liquid crystal medium of claim 1, wherein the dopant further comprises electrically conductive nanoparticles.

6. The hyperspectral holographic polymer dispersed liquid crystal medium of claim 1, wherein the dopant further comprises metallic nanoparticles.

7. The hyperspectral holographic polymer dispersed liquid crystal medium of claim 1, wherein the dopant further comprises alliform carbon particles.

8. The hyperspectral holographic polymer dispersed liquid crystal medium of claim 1, wherein the dopant further comprises carbon onions.

9. The hyperspectral holographic polymer dispersed liquid crystal medium of claim 1, wherein a diameter of a droplet size of the liquid crystal is in a range of about 300 nanometers to 5 micrometers.

10. The hyperspectral holographic polymer dispersed liquid crystal medium of claim 1, wherein the liquid crystal phase comprises a second, high dielectric anisotropy compound.

11. The hyperspectral holographic polymer dispersed liquid crystal medium of claim 1, wherein the continuous polymer phase comprises thiolene-based material.

12. The hyperspectral holographic polymer dispersed liquid crystal medium of claim 1, wherein the dopant further comprises multiwalled carbon nanotubes.

13. The hyperspectral holographic polymer dispersed liquid crystal medium of claim 12, wherein the multiwalled carbon nanotubes each have an outer diameter of about 20 nanometers.

14. The hyperspectral holographic polymer dispersed liquid crystal medium of claim 12, wherein the multiwalled carbon nanotubes each have a length between about 5 μm and about 10 μm.

15. The hyperspectral holographic polymer dispersed liquid crystal medium of claim 12, wherein a conductivity of the multiwalled carbon nanotubes is about 10³ S/cm.

16. The hyperspectral holographic polymer dispersed liquid crystal medium of claim 1, wherein the hyperspectral holographic polymer dispersed liquid crystal medium exhibits a switching speed from a transparent state to a reflective state on an order of nanoseconds.

17. The hyperspectral holographic polymer dispersed liquid crystal medium of claim 1, wherein the hyperspectral holographic polymer dispersed liquid crystal medium exhibits a switching speed from a reflective state to a transparent state on an order of microseconds.

18. The hyperspectral holographic polymer dispersed liquid crystal medium of claim 1, wherein, with an applied voltage of about 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

19. The hyperspectral holographic polymer dispersed liquid crystal medium of claim 1, wherein, with an applied voltage of less than or equal to 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

20. The hyperspectral holographic polymer dispersed liquid crystal medium of claim 1, wherein the hyperspectral holographic polymer dispersed liquid crystal medium comprises a plurality of reflective gratings formed within the medium, wherein each peak reflective wavelength of the hyperspectral continuum of peak reflective wavelengths is exhibited in accordance with a respective reflective grating of the plurality of reflective gratings.

21. The hyperspectral holographic polymer dispersed liquid crystal medium of claim 20, wherein at least one of the plurality of reflective gratings is curved.

22. The hyperspectral holographic polymer dispersed liquid crystal medium of claim 21, wherein the plurality of reflective gratings reflect the hyperspectral continuum of optical energy towards a focal point, the focal point being electrically controllable.

23. The hyperspectral holographic polymer dispersed liquid crystal medium of claim 21, wherein the medium comprises a plurality of holographic polymer dispersed liquid crystal films arranged to form a polymeric mirror stack.

24. The hyperspectral holographic polymer dispersed liquid crystal medium of claim 23, wherein:
each of the plurality of holographic polymer dispersed liquid crystal films reflect the hyperspectral continuum of optical energy towards a respective one of a plurality of focal points, and
the holographic polymer dispersed liquid crystal medium is further electrically controllable to switch reflection of the continuum of optical energy among the plurality of focal points.

25. A method comprising:
applying a layer of a conductive material to a surface of a substrate and dispersing the conductive material along the surface of the substrate by applying a first rotational force to the substrate;
applying a mixture comprising a liquid crystal and a photopolymerizable pre-polymer to the dispersed first layer of conductive material, the photopolymerizable pre-polymer having dispersed within it at least one dopant comprising piezoelectric nanoparticles or semiconductor nanoparticles; and
dispersing the mixture along the first layer of conductive material by applying a second rotational force to the substrate; and
exposing the mixture to a plurality of counter propagating light sources to generate a one dimensional reflective volume hologram.

26. The method of claim 25, wherein:
the plurality of counter propagating light sources comprises a respective plurality of counter propagating laser beams.

27. A method of producing the hyperspectral holographic polymer dispersed liquid crystal medium of claim 1, comprising:
exposing a pre-polymerized film to an energy beam by dynamically varying an angle of incidence between an energy beam and the pre-polymerized film throughout a range of angles between a first angle and a second angle, the pre-polymerized film comprising a homogeneous mixture of a liquid crystal phase and a photo-polymerizable monomer phase comprising at least one dopant which has been dispersed into the photo-polymerizable monomer phase, the dopant comprising a piezoelectric nanoparticle or a semiconductor nanoparticle;
creating a plurality of interference patterns within the film, each of the plurality of interference patterns corresponding to a respective angle of the range of angles by photo-polymerizing the photo-polymerizable monomer with the plurality of interference patterns to form a resultant plurality of reflection gratings in the film, the resultant plurality of reflection gratings forming a hyperspectral holographic polymer dispersed liquid crystal medium that reflects a hyperspectral continuum of peak reflective wavelengths;
wherein the at least one dopant remains distributed within the photopolymerized polymer phase of the hyperspectral holographic polymer dispersed liquid crystal medium; and
wherein the resulting hyperspectral holographic polymer dispersed liquid crystal medium exhibits
(a) a switching speed from a transparent state to a reflective state on an order of nanoseconds; or
(b) a switching speed from a reflective state to a transparent state on an order of microseconds; or
(c) a switching speed of both (a) and (b).

28. The method of claim 27, wherein the dopant further comprises a dielectric dopant.

29. The method of claim 27, wherein the dopant further comprises carbon nanoparticles.

30. The method of claim 27, wherein the dopant comprises piezoelectric nanoparticles.

31. The method of claim 27, wherein the dopant comprises semiconductor nanoparticles.

32. The method of claim 27, wherein the dopant further comprises electrically conductive nanoparticles.

33. The method of claim 27, wherein the dopant further comprises metallic nanoparticles.

34. The method of claim 27, wherein a diameter of a droplet size of the liquid crystal is in a range of about 300 nanometers to 5 micrometers.

35. The method of claim 27, wherein the liquid crystal phase comprises a second, high dielectric anisotropy compound.

36. The method of claim 27, wherein the continuous polymer phase comprises thiolene-based material.

37. The method of claim 27, wherein the dopant further comprises multiwalled carbon nanotubes.

38. The method of claim 37, wherein the multiwalled carbon nanotubes each have an outer diameter of about 20 nanometers.

39. The method of claim 37, wherein the multiwalled carbon nanotubes each have has a length between about 5 μm and about 10 μm.

40. The method of claim 37, wherein a conductivity of the multiwalled carbon nanotubes is about 10³ S/cm.

41. The method of claim 27, wherein the hyperspectral holographic polymer dispersed liquid crystal medium exhibits a switching speed from a transparent state to a reflective state on an order of nanoseconds.

42. The method of claim 27, wherein the hyperspectral holographic polymer dispersed liquid crystal medium exhibits a switching speed from a reflective state to a transparent state on an order of microseconds.

43. The method of claim 27, wherein, with an applied voltage of about 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

44. The method of claim 27, wherein, with an applied voltage of less than or equal to 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

45. The method of claim 27, wherein the angle of incidence between the energy beam and the film is dynamically varied via at least one of rotation or translation.

46. The method of claim 45, wherein the rotation or the translation is with respect to one or more elements of a holography apparatus.

47. The method of claim 46, wherein the one or more elements of the holography apparatus comprise at least one of a mirror, a beam splitter, or a sample stage.

48. The method of claim 27, further comprising:
splitting the energy beam into a plurality of energy beams;
causing the plurality of energy beams to be simultaneously incident on the film; and
dynamically varying an angle of incidence between at least one of the plurality of energy beams and the film throughout the range of angles between the first angle and the second angle, inclusively.

49. The method of claim 48, wherein at least two of the plurality of beams are counter propagating.

50. The method of claim 27, wherein the angle of incidence between the energy beam and the film is varied at least one of continuously or incrementally during a photo-polymerization interval.

51. The method of claim 27, wherein the plurality of interference patterns is created using a prism.

52. The method of claim 27, wherein the plurality of interference patterns is created using a mirror.

53. The method of claim 27, wherein the plurality of interference patterns is created using a filter.
